(19) United States
(12) Patent Application Publication
(10) Pub. No.: US 2026/0278107 A1
(43) Pub. Date: Sep. 17, 2026

(54) DATA CENTER COMPUTING SYSTEM WITH SECURE BOOT FUNCTIONS

(71) Applicant: Apple Inc., Cupertino, CA (US)

(72) Inventors: Joseph J. CASTRO, Poway, CA (US); Supradeep KOGANTI, Cupertino, CA (US)

(73) Assignee: Apple Inc., Cupertino, CA (US)

(21) Appl. No.: 19/555,534

(22) Filed: Mar. 3, 2026

Related U.S. Application Data
(60) Provisional application No. 63/771,424, filed on Mar. 13, 2025.

(51) Int. Cl. G06F 21/57; G06F 9/4401

(52) U.S. Cl. CPC G06F 21/575; G06F 9/4401; G06F 2221/034

(57) ABSTRACT

Embodiments relate to supporting a bootloader for a controller, where the bootloader includes a first partial bootloader stored in a first bootloader storage area at a manufacturing time before the controller is deployed and a second partial bootloader with a first copy stored in a second bootloader storage area and a second copy stored in a third bootloader storage area. The first partial bootloader can boot a selected copy of the second partial bootloader being selected from the first copy and the second copy of the second partial bootloader. The selected copy of the second partial bootloader can boot a firmware for an application operated by the controller.

### CROSS-REFERENCE TO RELATED APPLICATIONS

This application claims the benefit of U.S. Provisional Patent Application No. 63/771,424, filed Mar. 13, 2025, the contents of which is incorporated herein by reference in its entirety.

### FIELD

The present disclosure relates to a data center computing system, including hardware architecture and software systems with secure boot functions.

### BACKGROUND

A data center can be a physical facility to house computing resources, including computing hardware, applications, and data. A data center computing system can be designed based on a network of computing and storage resources that enable the delivery of shared applications and data. Components of the data center computing system can include routers, switches, firewalls, storage systems, servers, controllers, and other components. The efficient organization of components of the data center computing system to deliver applications and data to users can be challenging.

### SUMMARY

Embodiments of the present disclosure include a data center computing system with an instruction processing device configured to manage operations of a set of computing devices of a chassis including one or more boards. At least one board of the one or more boards can include a set of cards, and at least one card of the set of cards can include a controller and a processing device. A first communication network can be configured to couple the instruction processing device to the controller of the at least one card configured to receive an instruction from the instruction processing device through the first communication network having a first communication protocol. The processing device of the at least one card can be configured to generate an operation result based on the instruction and to provide the operation result to another device of the at least one board through a second communication network having a second communication protocol different from the first communication protocol.

Embodiments of the present disclosure include a computing device with a controller, a processing device, and an input/output (I/O) circuit. In some embodiments, the computing device can be located on a card placed in a board that is further placed in a chassis. The controller can be configured to receive an instruction through a first communication network. The processing device can be configured to generate an operation result based on the instruction. The I/O circuit can be configured to receive the operation result from the processing device, and provide the operation result to another device on the same board through a second communication network different from the first communication network. In some embodiments, the operation result is provided to another device located at a different card on the same board. In some embodiments, the first communication network has a first communication protocol, and the second communication network has a second communication protocol different from the first communication protocol. In some embodiments, the processing device and the I/O circuit can be integrated into a computing node.

Embodiments of the present disclosure include a method performed by a combination of an instruction processing device, a controller, and a computing node including a processing device and one or more I/O circuits. A hierarchical manager can be operated by the instruction processing device and configured to receive at least one of first data from a first system operated by the processing device of a first computing node and second data from a second system operated by the controller coupled to the first computing node. The controller and the first computing node are located in a first card managed by the instruction processing device. The controller and the instruction processing device are coupled by a first communication network. The processing device of the first computing node is configured to generate an operation result for the first computing node to be provided to a second computing node located on a second card through a second communication network having a network topology that includes the first computing node and the second computing node. Based on the at least one of the first data and the second data, the hierarchical manager can further create a network manager operated by the instruction processing device for the second communication network. In addition, the network manager can be configured to manage operations of one or more processing devices of computing nodes of the second communication network.

Embodiments of the present disclosure include a computing system with a board having a first card and a second card, where a first controller and a first processing device are located on the first card and a second controller and a second processing device are located on the second card. The first controller is configured to receive a first instruction through a first communication network. The first processing device can be configured to generate an operation result based on the first instruction and provide the operation result to the second processing device of the second card through a second communication network different from the first communication network. The second controller is configured to receive a second instruction through the first communication network shared with the first controller, and the second processing device is configured to receive the operation result from the first processing device of the first card through the second communication network.

Embodiments of the present disclosure include a board including a set of cards having a first card, a second card, and one or more additional cards. In some embodiments, the first card can include a first controller and a first processing device, while the second card can include a second processing device and a second controller. The first controller can receive a first instruction through a first communication network having a first communication protocol. The first processing device can generate an operation result based on the first instruction. The first card can be configured to provide one or more data packets generated based on the operation result to the second card through a second communication network formed by the set of cards having a second communication protocol. In some embodiments, the second communication network has a ring topology.

Embodiments of the present disclosure include a card having a power management device coupled to a computing node and a controller. The controller is configured to receive an instruction through a first communication network, and the computing node is configured to generate an operation result based on the instruction and provide the operation result to another computing node through a second communication network. The power management device is also coupled to the computing node by a third communication network independent from the first communication network and the second communication network. In some embodiments, the power management device is configured to receive a power consumption indicator at a first time instance based on a power consumption of the computing node at the first time instance. In response to the power consumption indicator at the first time instance exceeding a power budget for the computing node at the first time instance, the power management device is configured to adjust a performance mechanism for the computing node from a first performance indicator at the first time instance to a second performance indicator at a second time instance to reduce the power consumption by the computing node. The power budget for the computing node at the first time instance is associated with performing a workload task by the computing node at the first time instance. In addition, the computing node is configured to perform the workload task at the second time instance with the second performance indicator.

Embodiments of the present disclosure include a controller having a bootloader and a storage device. The bootloader can include a first partial bootloader and a second partial bootloader. The storage device can include a first bootloader storage area, a second bootloader storage area, a third bootloader storage area, and a data storage area. In some embodiments, the first bootloader storage area can store the first partial bootloader at a manufacturing time before the controller is deployed, and the data storage area can store security data provided at the manufacturing time, where the security data is provided for security operations performed by the first partial bootloader. In some embodiments, the second bootloader storage area can store a first copy of the second partial bootloader, and the third bootloader storage area can store a second copy of the second partial bootloader. In some embodiments, the first partial bootloader can boot a selected copy of the second partial bootloader, where the selected copy of the second partial bootloader is selected from the first copy of the second partial bootloader and the second copy of the second partial bootloader. In some embodiments, the selected copy of the second partial bootloader can boot a firmware for an application operated by the controller in response to the selected copy of the second partial bootloader being in operation. In some embodiments, the controller can be an example of a controller of a card of a board of a chassis managed or controlled by an instruction processing device.

This Summary is provided merely for purposes of illustrating some embodiments to provide an understanding of the subject matter described herein. Accordingly, the above-described features are merely examples and should not be construed to narrow the scope or spirit of the subject matter in this disclosure. Other features, embodiments, and advantages of this disclosure will become apparent from the following Detailed Description, Figures, and Claims.

### BRIEF DESCRIPTION OF THE DRAWINGS

Embodiments of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIGS. 1A-1B illustrate a data center computing system, including computing nodes in a number of chassis in a number of racks managed by a fleet management server and a host processor, according to some embodiments.

FIG. 2 illustrates a chassis including multiple boards, according to some embodiments.

FIG. 3 illustrates a board including multiple of cards, according to some embodiments.

FIG. 4 illustrates a card of a data center computing system, according to some embodiments.

FIG. 5 illustrates a chassis including an instruction processing device coupled to multiple boards via a communication network, according to some embodiments.

FIG. 6 illustrates a chassis including an instruction processing device coupled to multiple boards via a communication network, according to some embodiments.

FIG. 7 illustrates a chassis including an instruction processing device managing operations of multiple boards, according to some embodiments.

FIG. 8 illustrates states for an instruction processing device of a chassis, according to some embodiments.

FIG. 9A illustrates a data center computing system including an instruction processing device of a chassis for managing operations of multiple cards of a board, according to some embodiments.

FIGS. 9B-9C illustrate a card including a computing node, according to some embodiments.

FIG. 9D illustrates a software structure of a computing node of a card, according to some embodiments.

FIGS. 9E-9G illustrate the operations and interactions one card can perform related to one or more other cards of a board, according to some embodiments.

FIG. 10A illustrates a data center computing system including an instruction processing device of a chassis for managing operations of multiple cards of a board using a hierarchical manager and one or more network managers, according to some embodiments.

FIG. 10B illustrates a method performed by a hierarchical manager and one or more network managers operated by an instruction processing device of a chassis of a data center computing system, according to some embodiments.

FIGS. 11A-11C illustrate operations of a ring communication network on a board of a chassis of a data center computing system, according to some embodiments.

FIGS. 12A-12L illustrate further operations of a ring communication network on a board of a chassis of a data center computing system, according to some embodiments.

FIGS. 13A-13C illustrate operations performed by a computing node of a ring communication network on a board of a chassis of a data center computing system, according to some embodiments.

FIG. 14 illustrates a flowchart for operations performed by an instruction processing device of a chassis, according to some embodiments.

FIG. 15 illustrates a flowchart for operations performed by a card of a board managed by an instruction processing device of a chassis, according to some embodiments.

FIG. 16 illustrates a flowchart for operations performed by a board managed by an instruction processing device of a chassis, according to some embodiments.

FIG. 17A illustrates a data center computing system, including chassis and racks having power management devices, according to some embodiments.

FIGS. 17B-17D illustrate the operations of various power management devices of a data center computing system including chassis and racks, according to some embodiments.

FIG. 18 illustrates details of a controller within a chassis having a bootloader with multiple partial bootloaders, according to some embodiments.

FIG. 19 illustrates a factory program flow for programming a bootloader with multiple partial bootloaders into a controller of a chassis, according to some embodiments.

FIGS. 20A-20D illustrate processes for booting a firmware for an application by a controller having a bootloader with multiple partial bootloaders, according to some embodiments.

FIGS. 21A-21B illustrate processes for updating a partial bootloader of a bootloader with multiple partial bootloaders operated by a controller, according to some embodiments.

FIG. 22 illustrates various phases of operations for a data center computing system, according to some embodiments.

FIG. 23 is an illustration of an example computer system for implementing some embodiments or portion(s) thereof of the disclosure provided herein, according to some embodiments.

### DETAILED DESCRIPTION

The following disclosure provides many different embodiments, or examples, for implementing different features of the provided subject matter. Specific examples of components and arrangements are described below to simplify the present disclosure. These are merely examples and are not intended to be limiting. In addition, the present disclosure repeats reference numerals and/or letters in the various examples. This repetition is for the purpose of simplicity and clarity and, unless indicated otherwise, does not in itself dictate a relationship between the various embodiments and/or configurations discussed.

In some embodiments, a computing system can include various devices, such as a memory device connected to one or more processors, which can be assembled on a printed circuit board (PCB) such as a motherboard. A system-on-chip (SoC) can be an integrated circuit that integrates multiple components of a computing system, such as an on-chip central processing unit (CPU), memory interfaces, memory controller circuits, input/output devices, input/output interfaces, secondary storage interfaces, radio modems, a graphics processing unit (GPU), or other components. A CPU, GPU, or other processing component can be referred to as “a processor core,” “a computing device,” “a computing node,” “a node,” “a processor,” “a controller,” “a processing device,” “an instruction processing device,” “a processor circuit,” or other terms known to one having ordinary skill in the art. With the advances in technology, an increasing number of computing devices can be assembled to form a system that is bigger than any individual component to perform computations with increased computer power. An example of such computer system is a data center computing system, which can include many computing devices, controllers, memory, network devices, assembled in different ways. Embodiments of the present disclosure include a data center computing system that includes a fleet with various computing devices assembled on a chassis. In some embodiments, a fleet can include a hierarchical structure formed by multiple racks, where a rack can include multiple chassis, a chassis can include multiple boards, a board can include multiple, separate discrete computing units, such as cards. A card can include multiple computing devices, such as a controller and a computing node. In some embodiments, a board and a card can be a separate discrete computing unit. In some embodiments, a card can be at a different hierarchical level from a board. In some embodiments, a card can include a computing device, a networking device, or a computing/networking device that could be a microcontroller, one or more processors, a networking processor, a system on chip (SoC), or other similar circuitry.

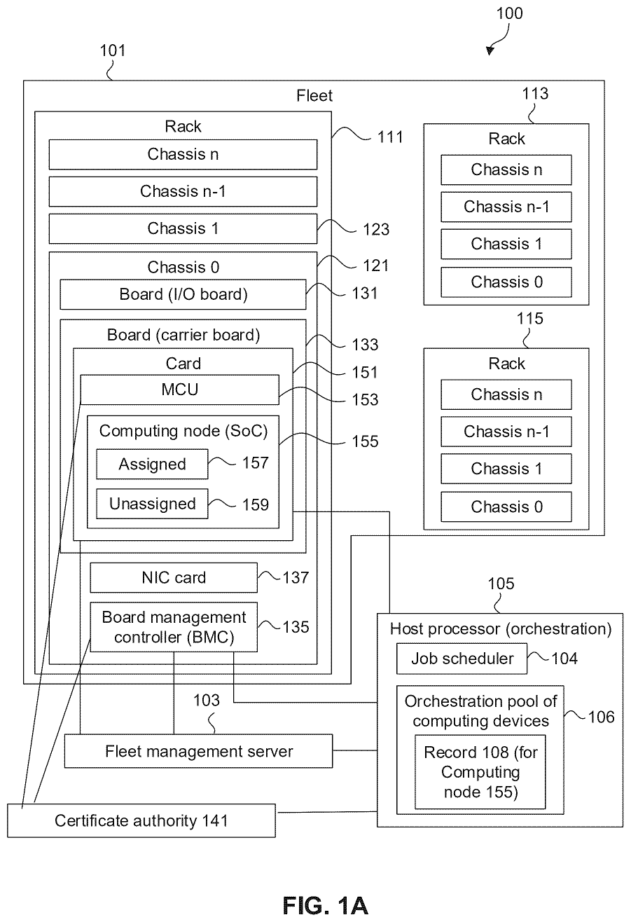

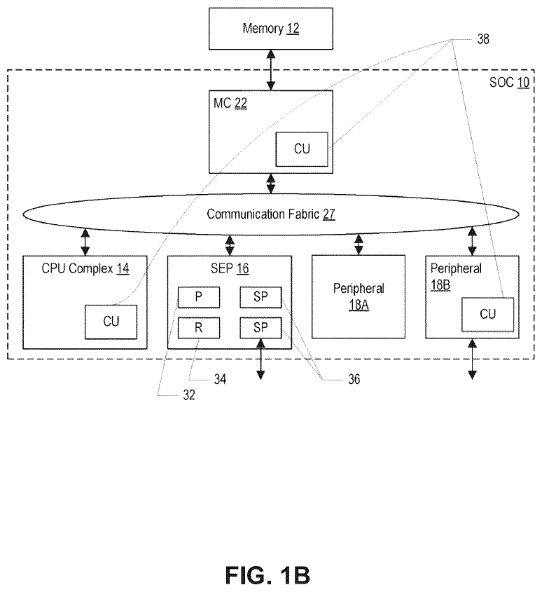

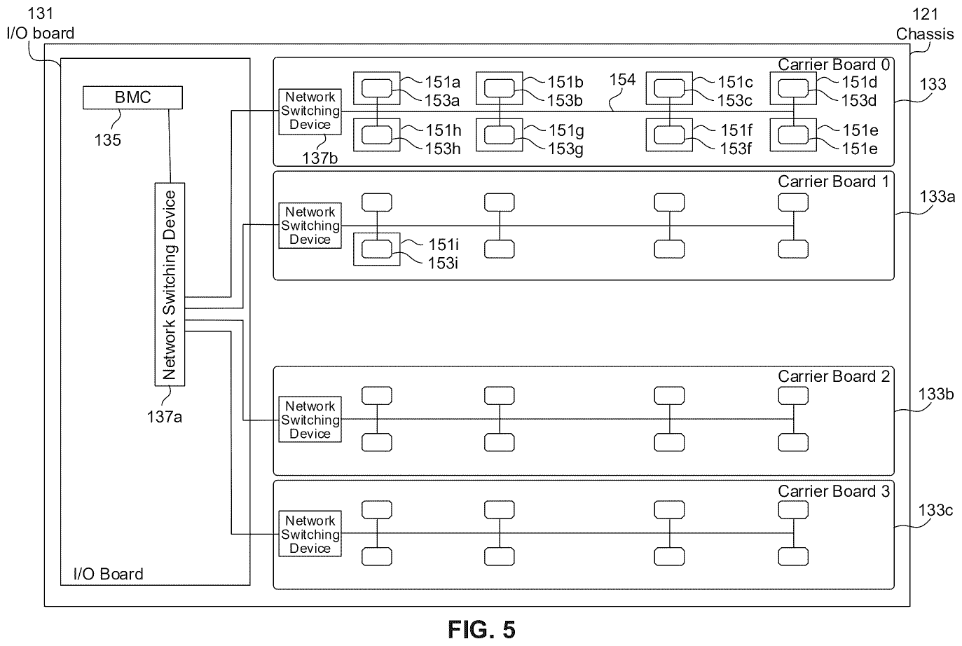

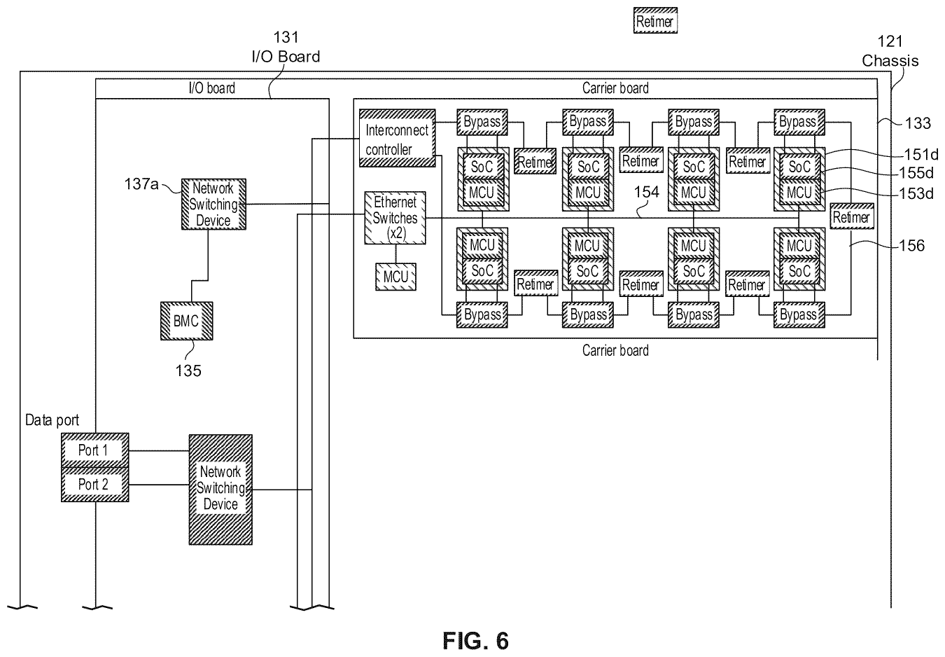

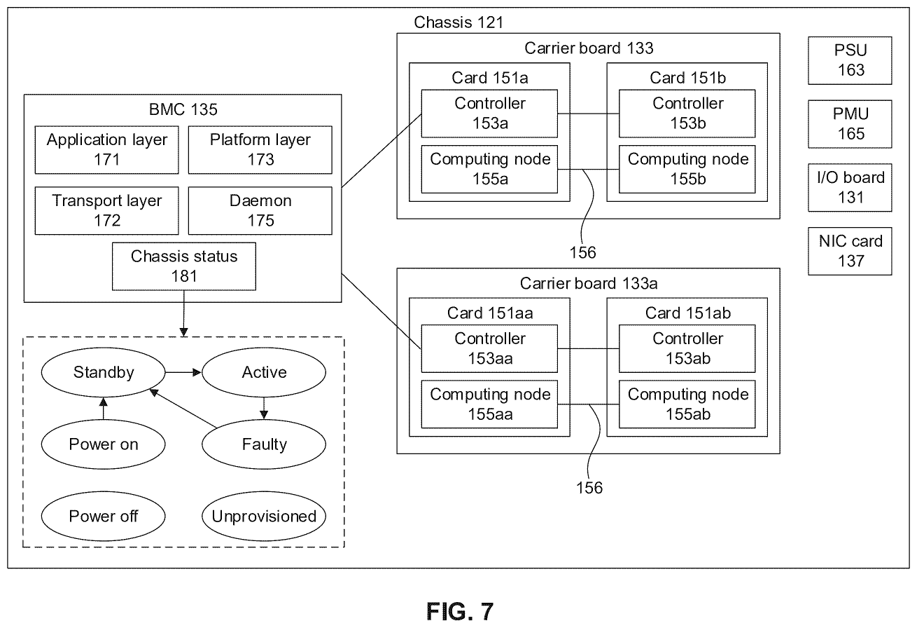

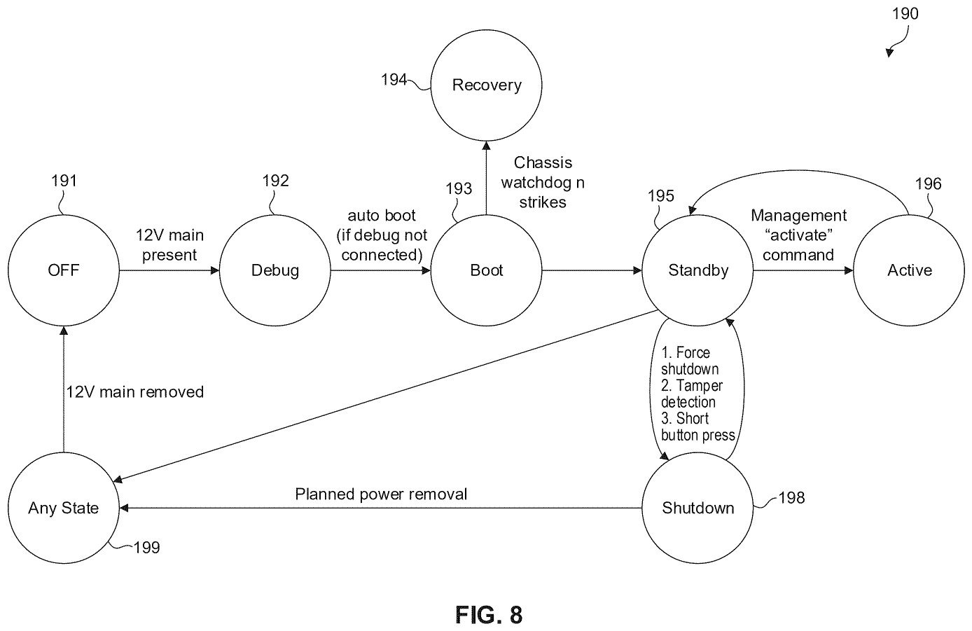

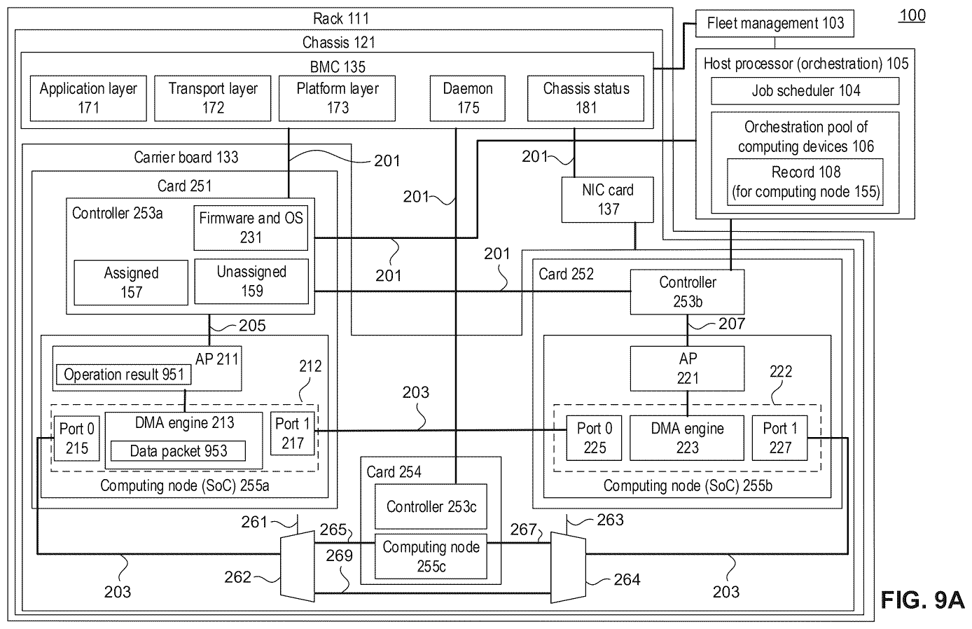

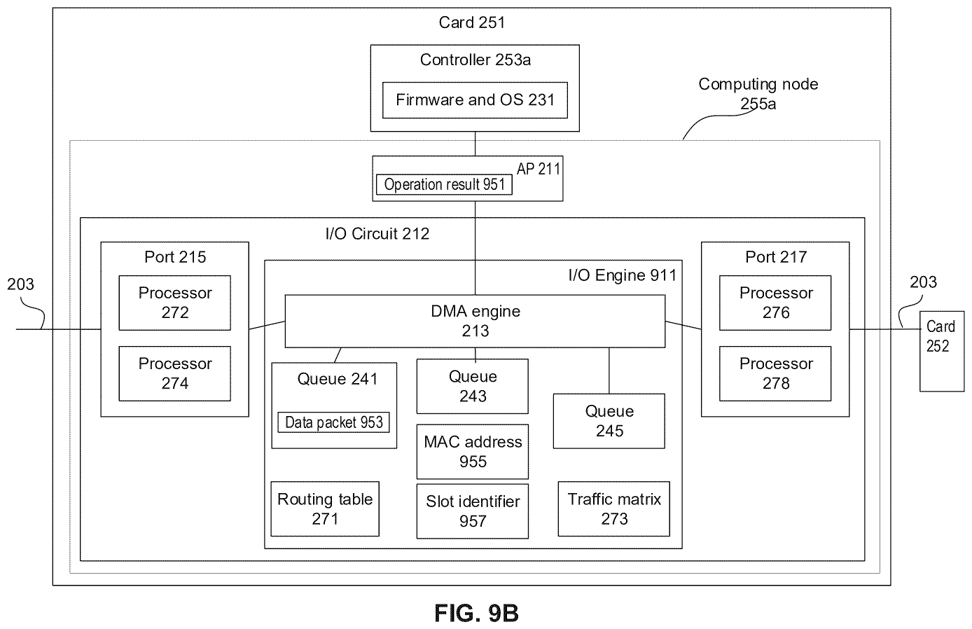

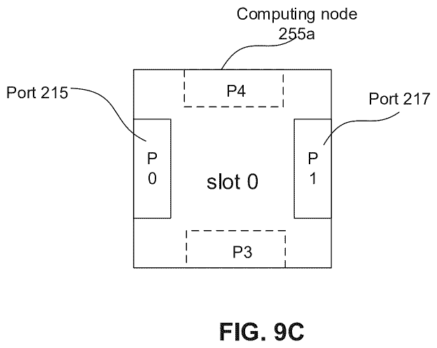

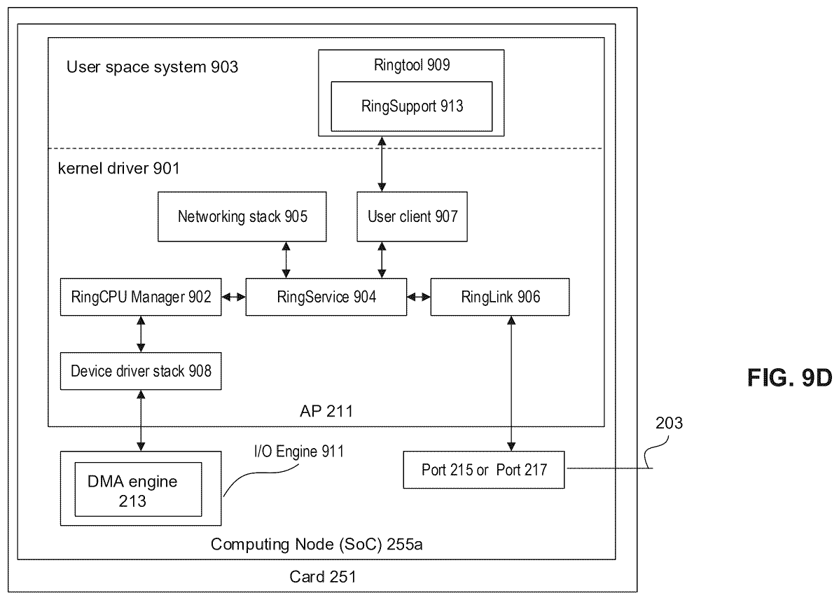

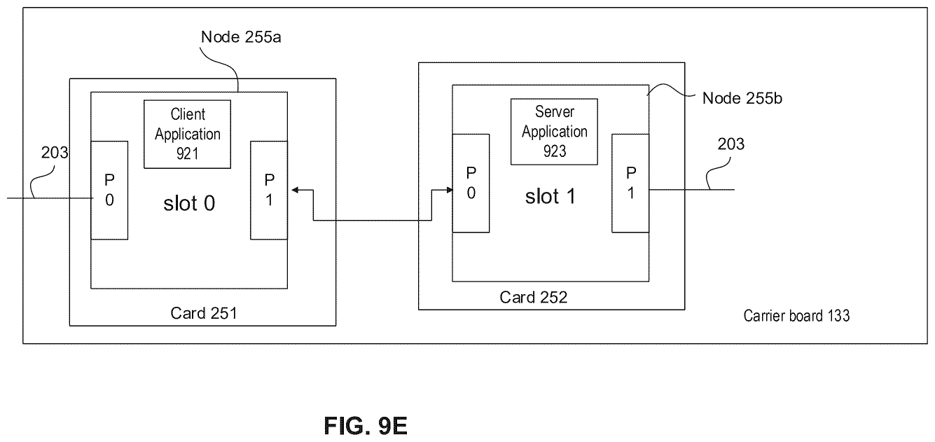

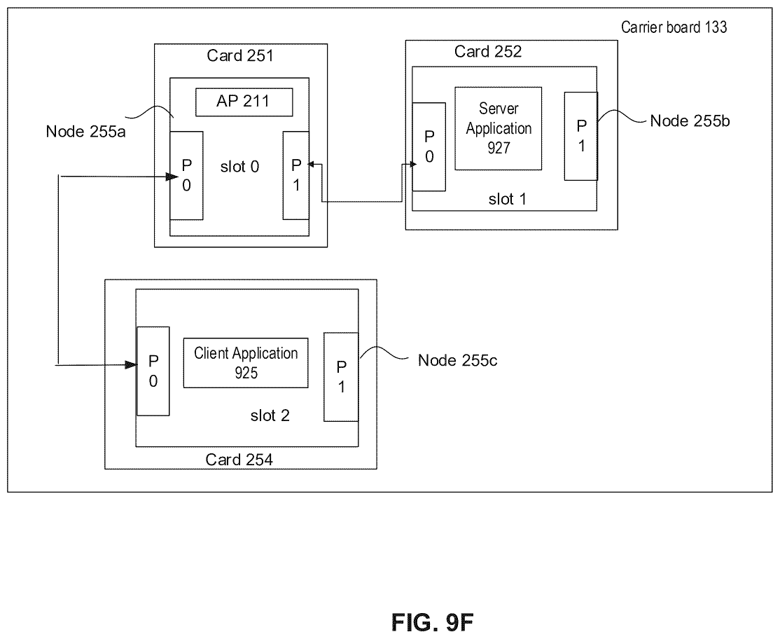

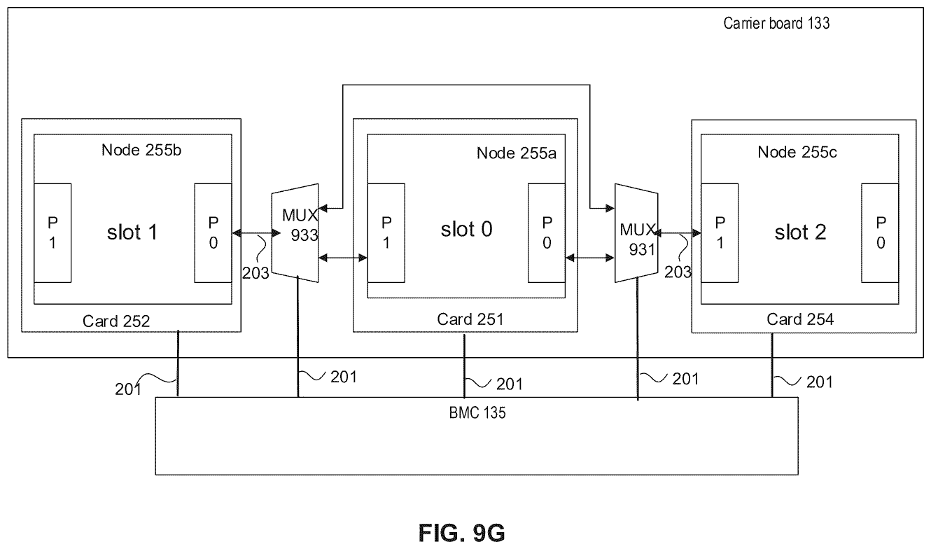

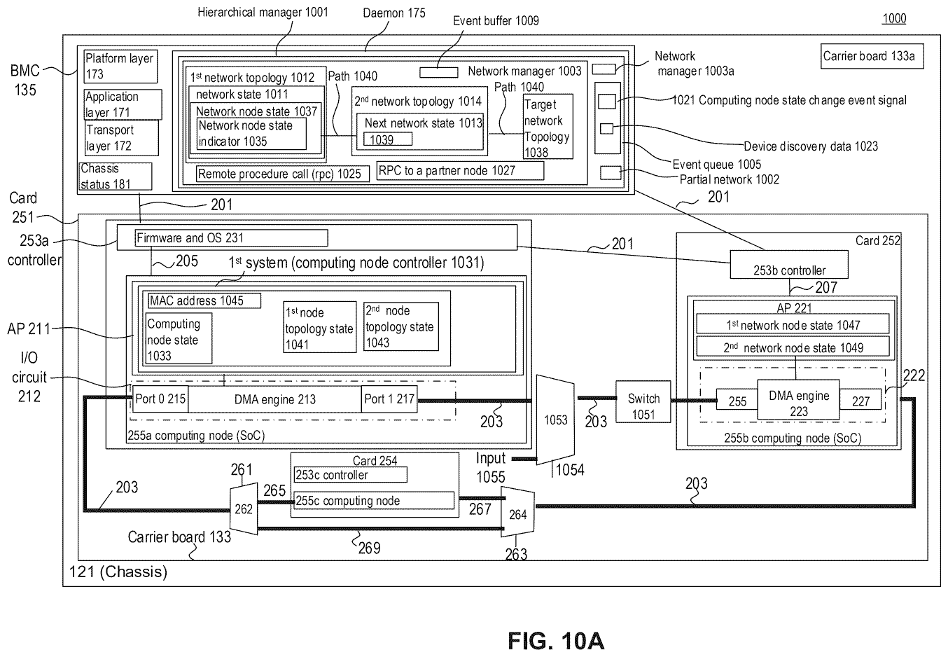

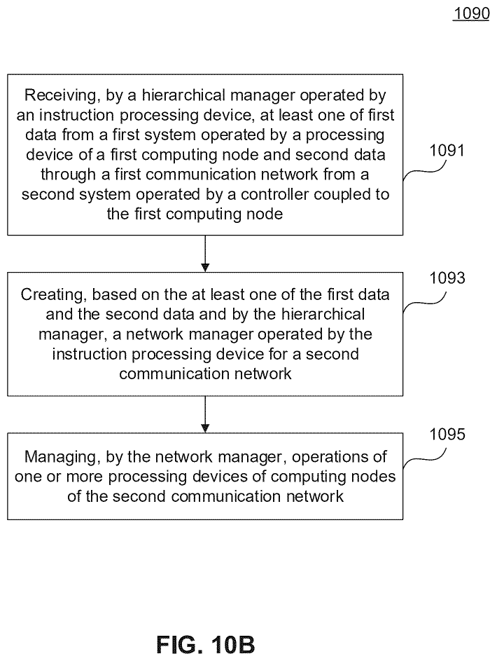

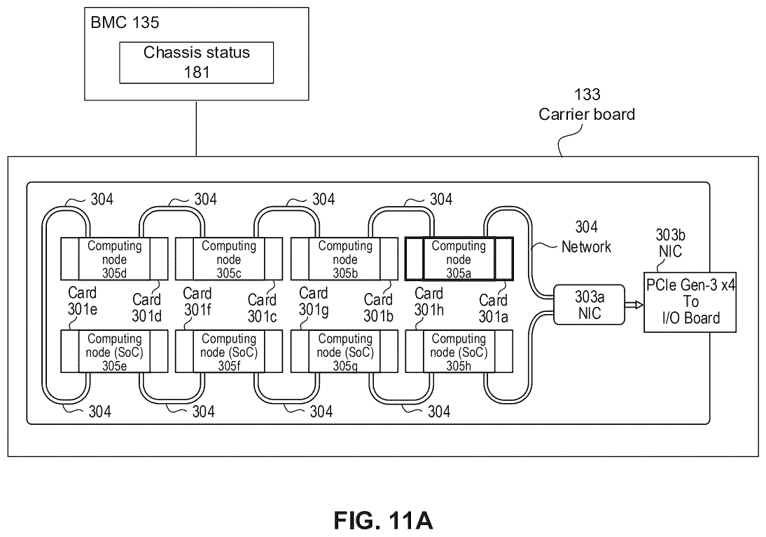

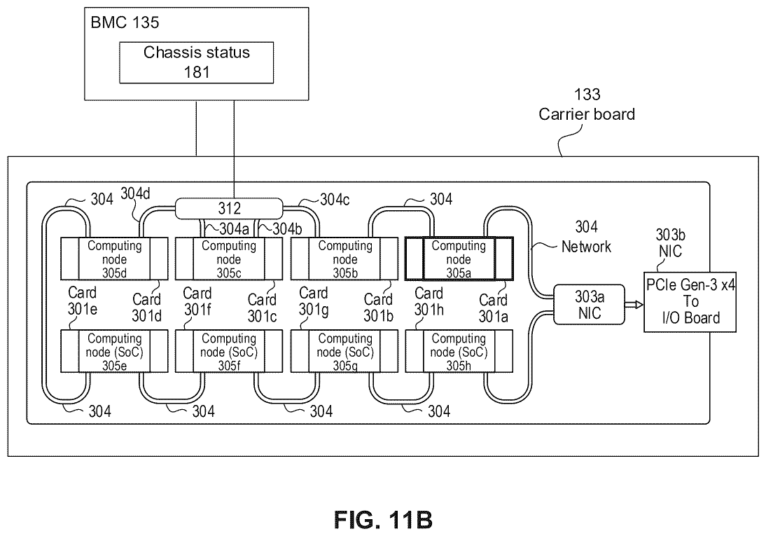

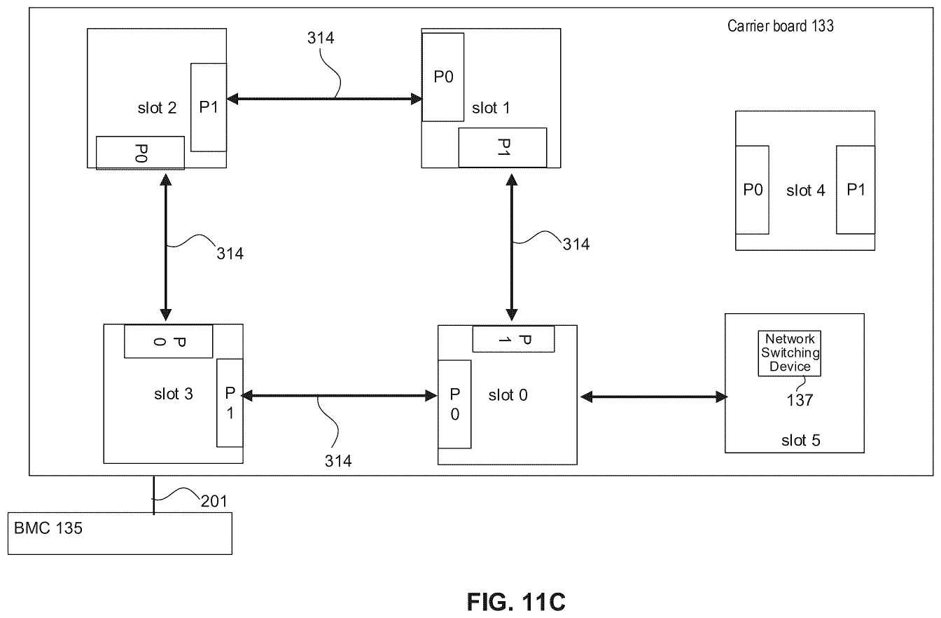

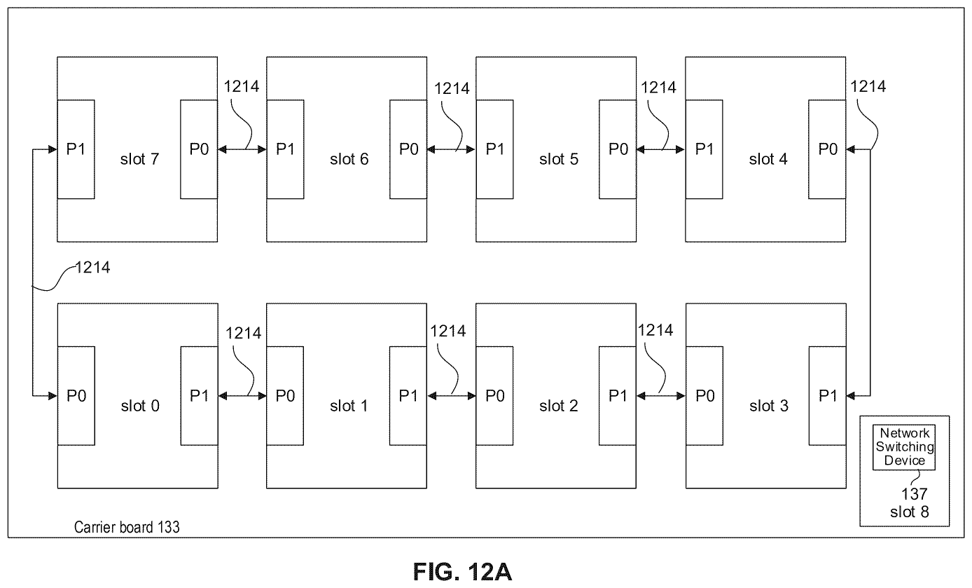

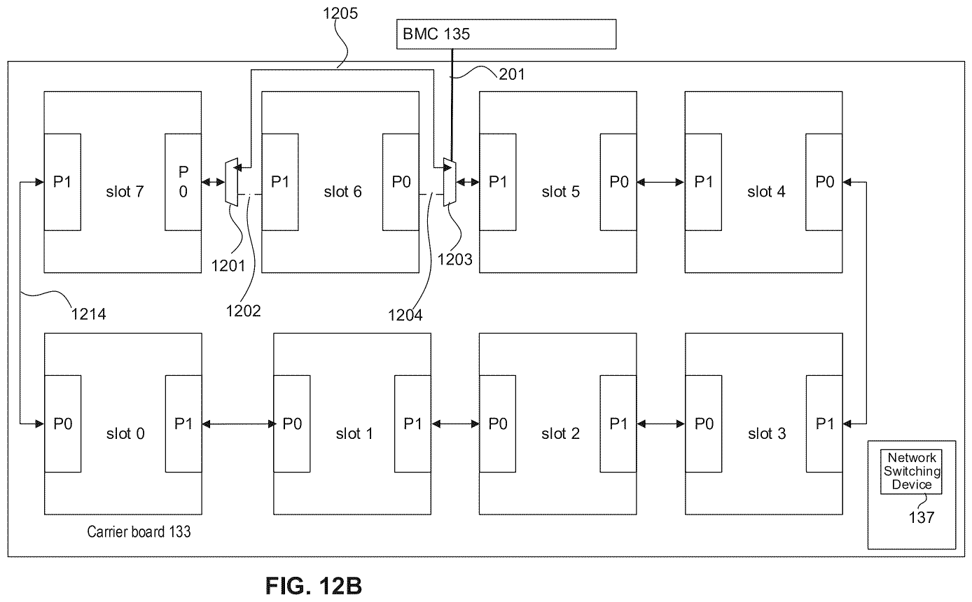

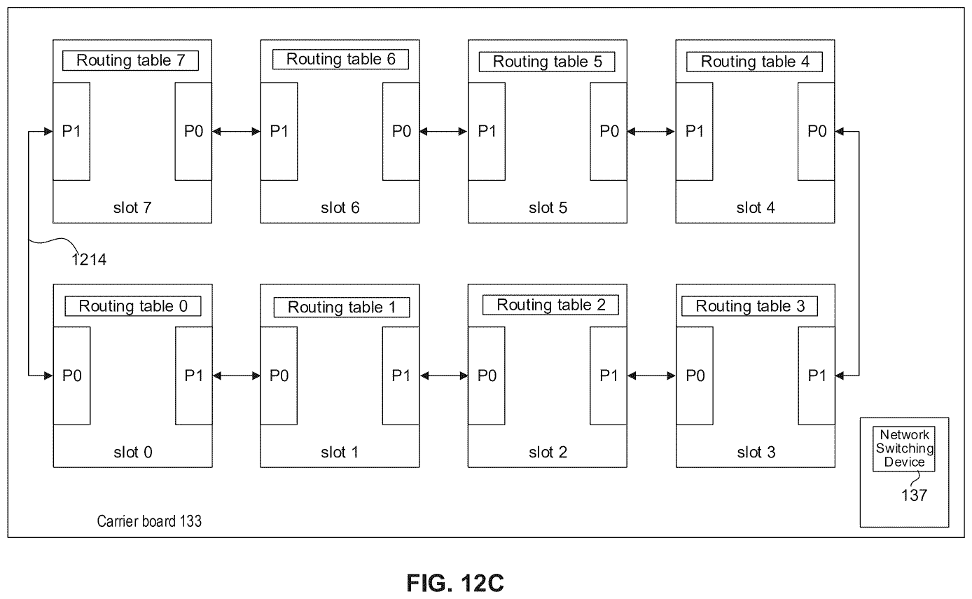

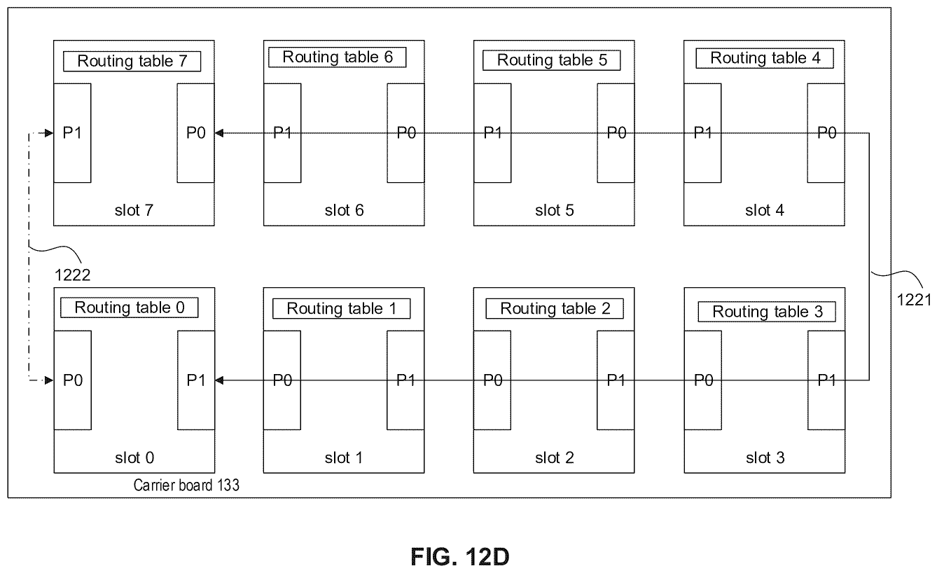

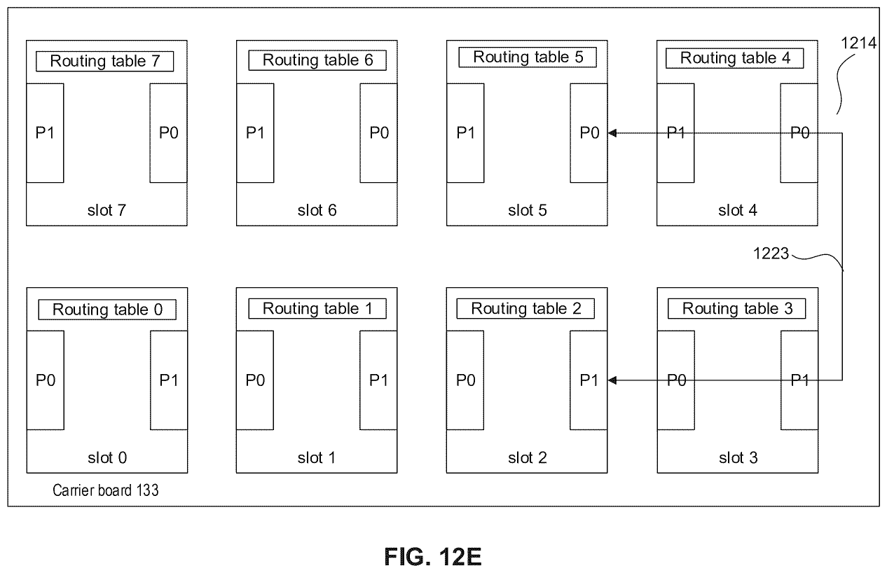

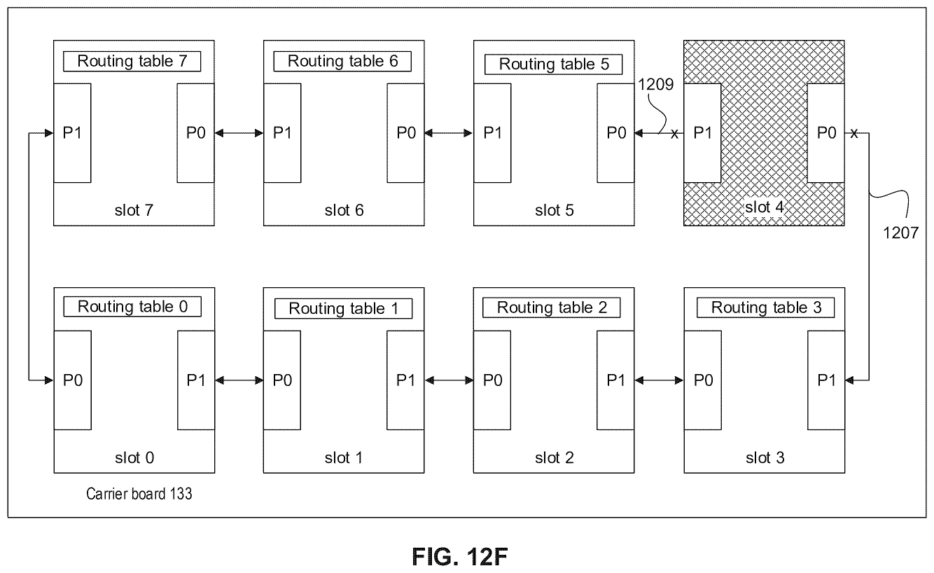

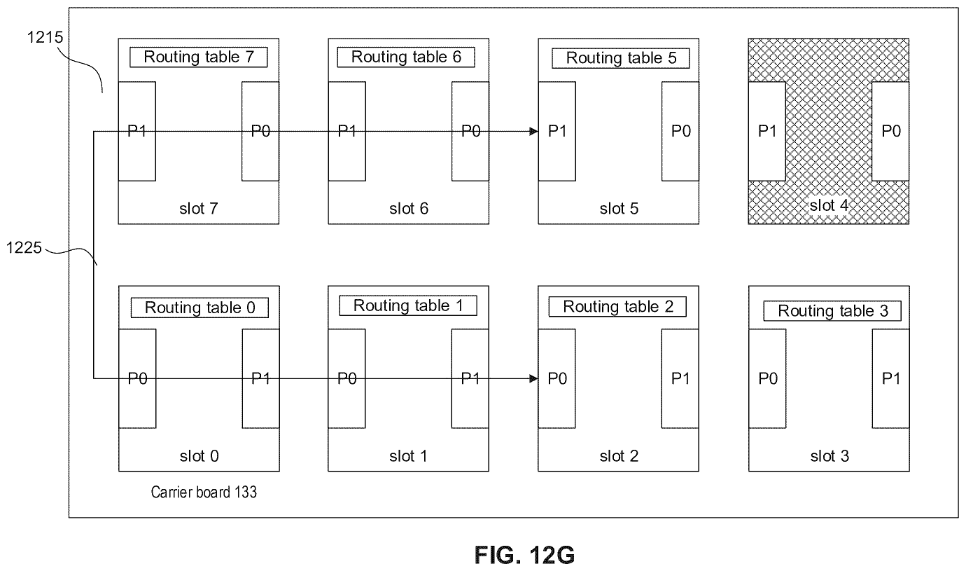

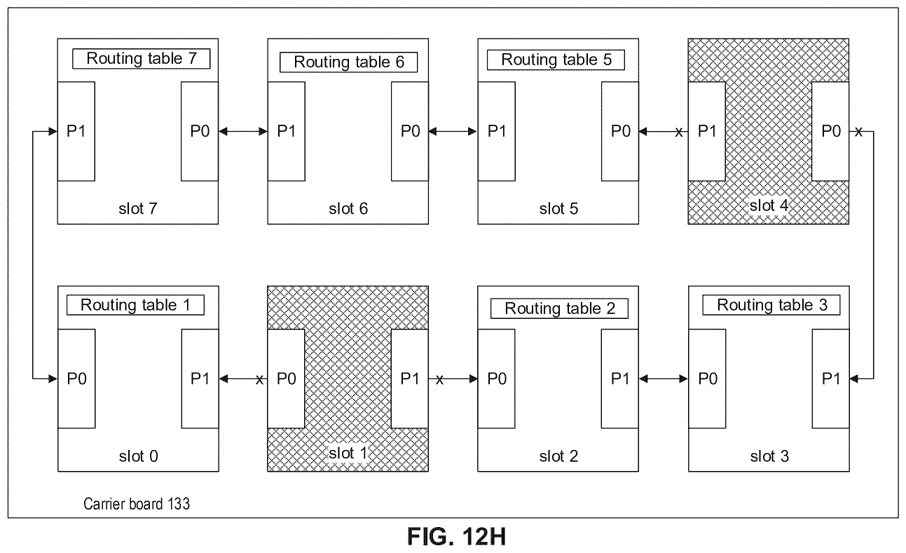

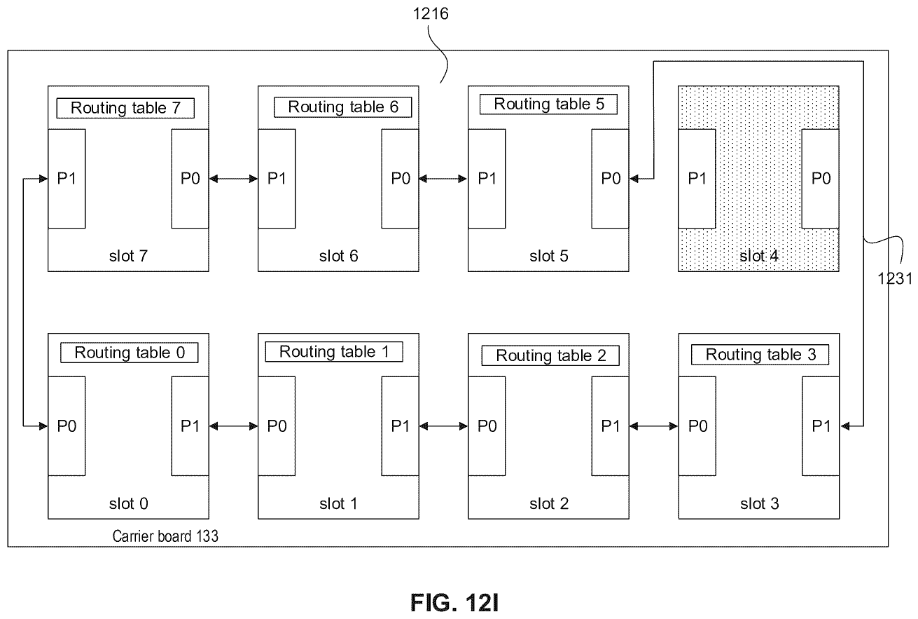

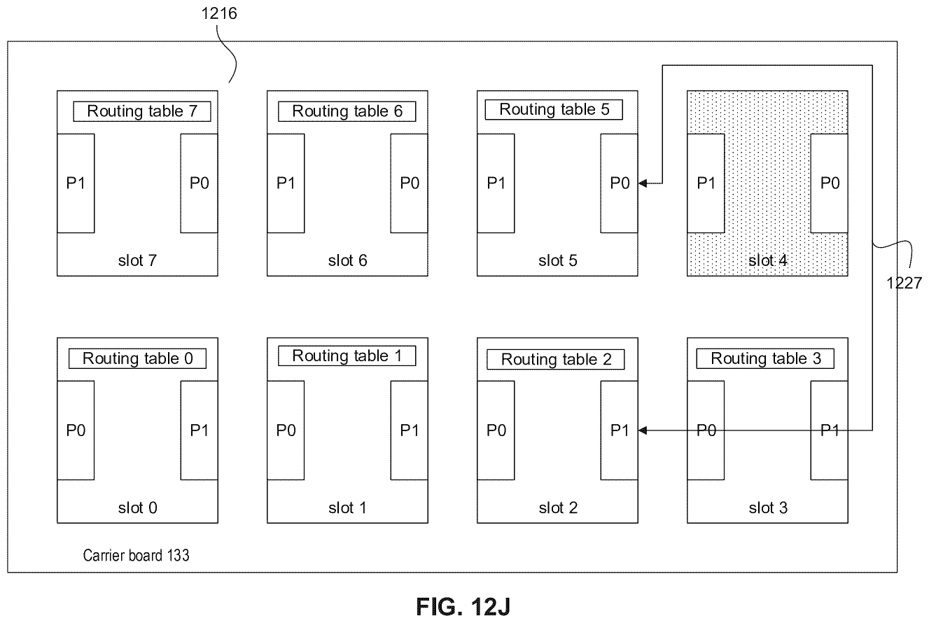

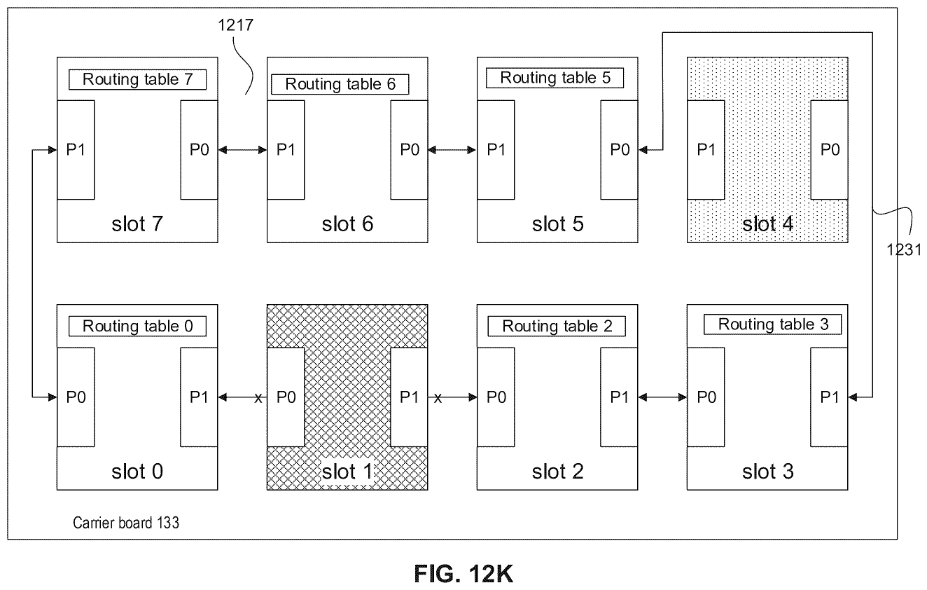

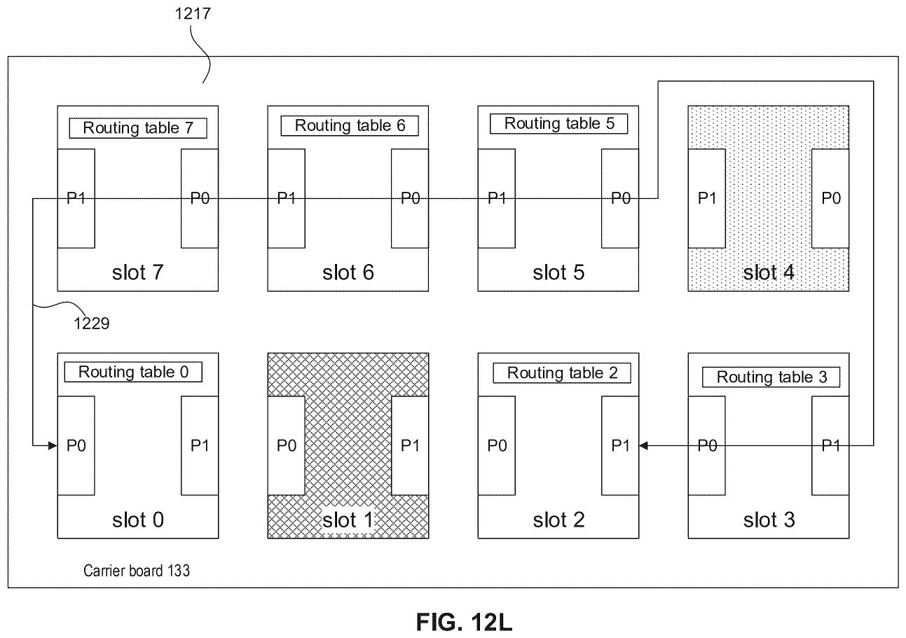

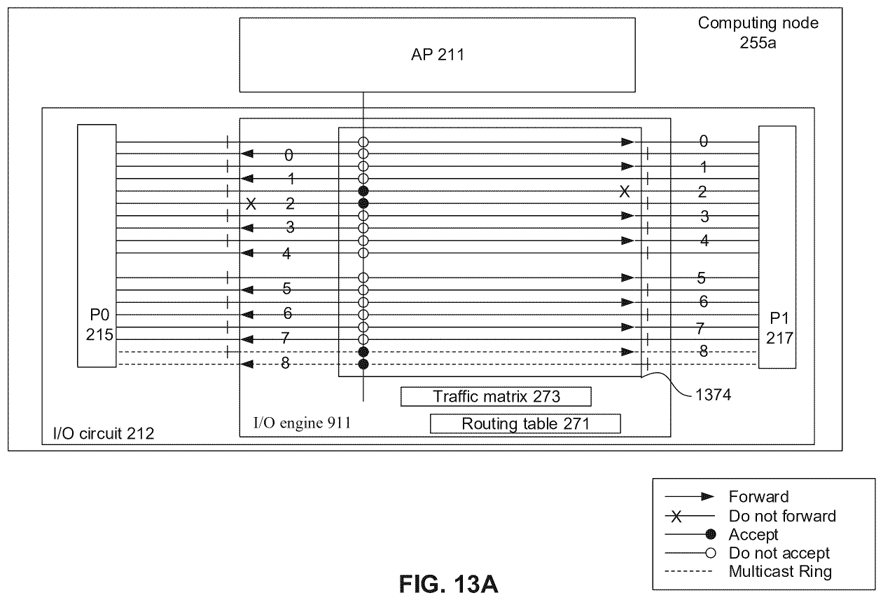

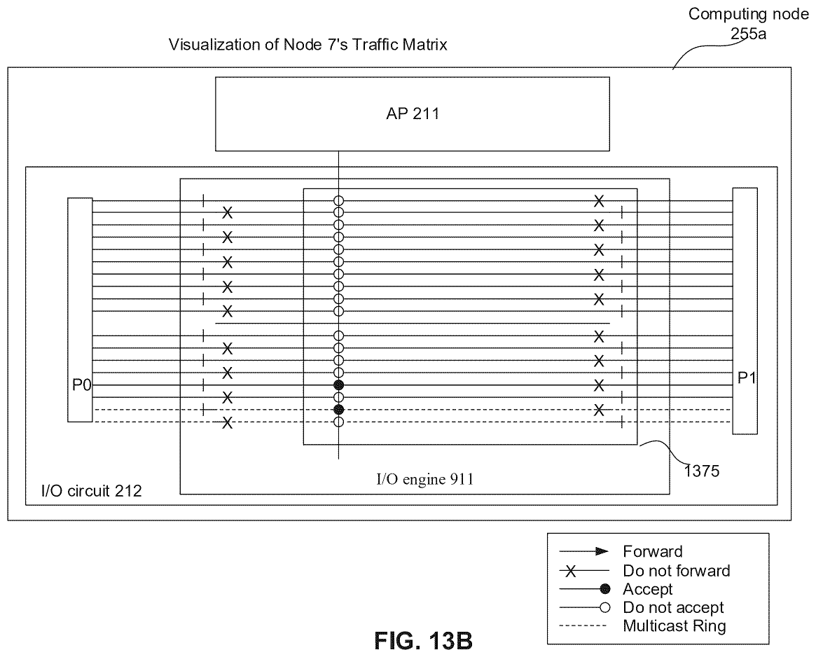

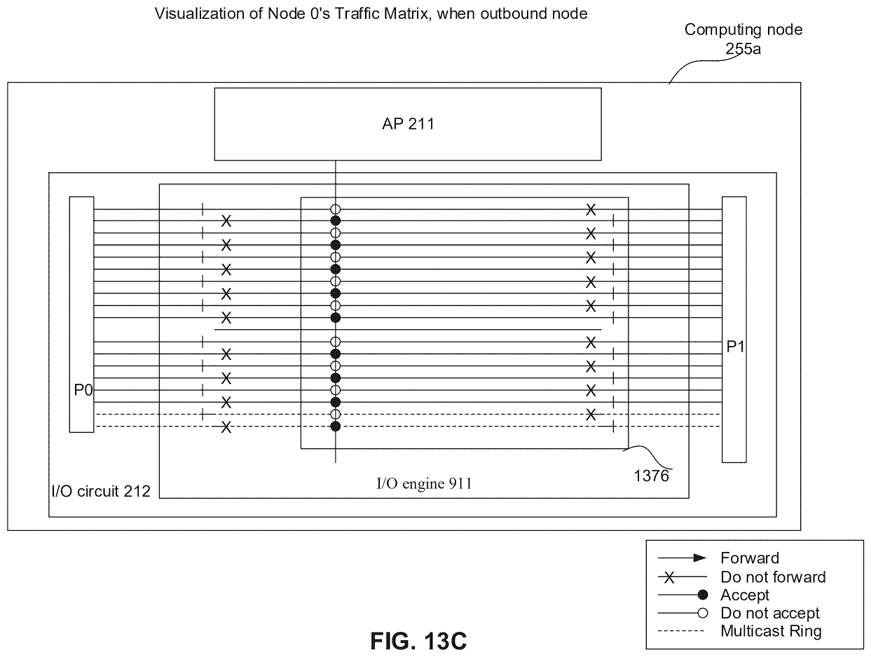

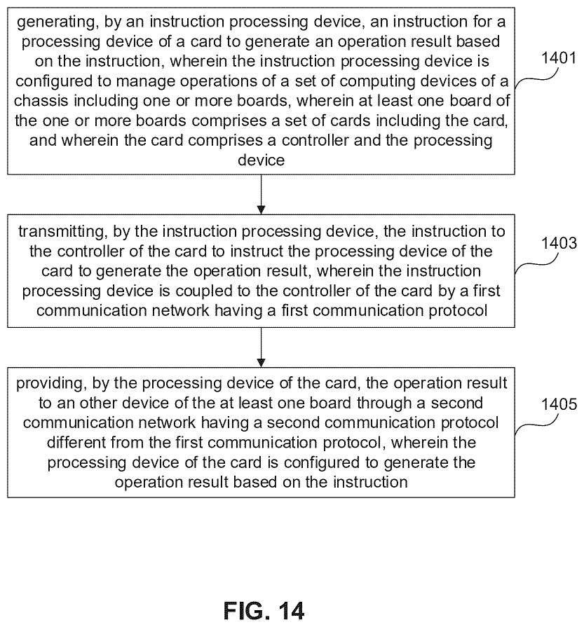

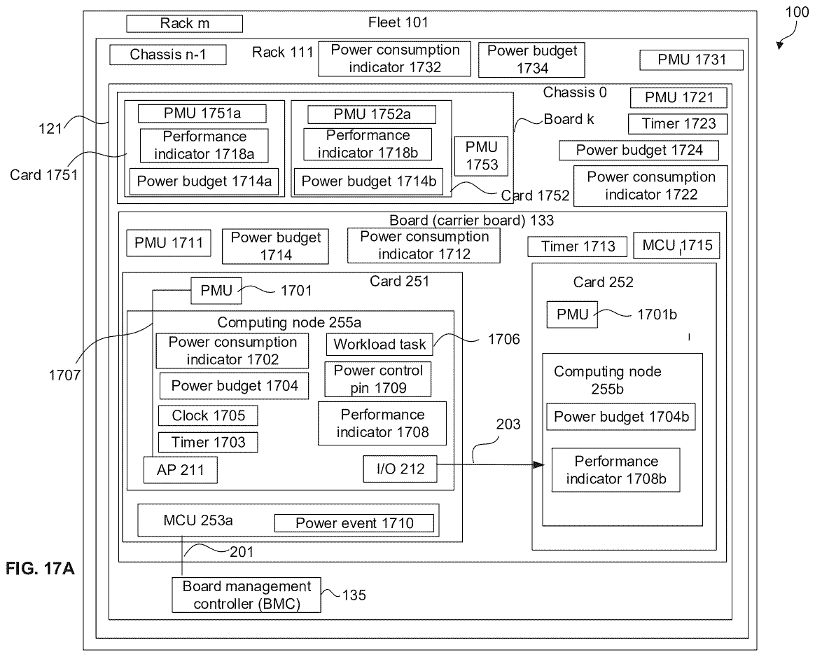

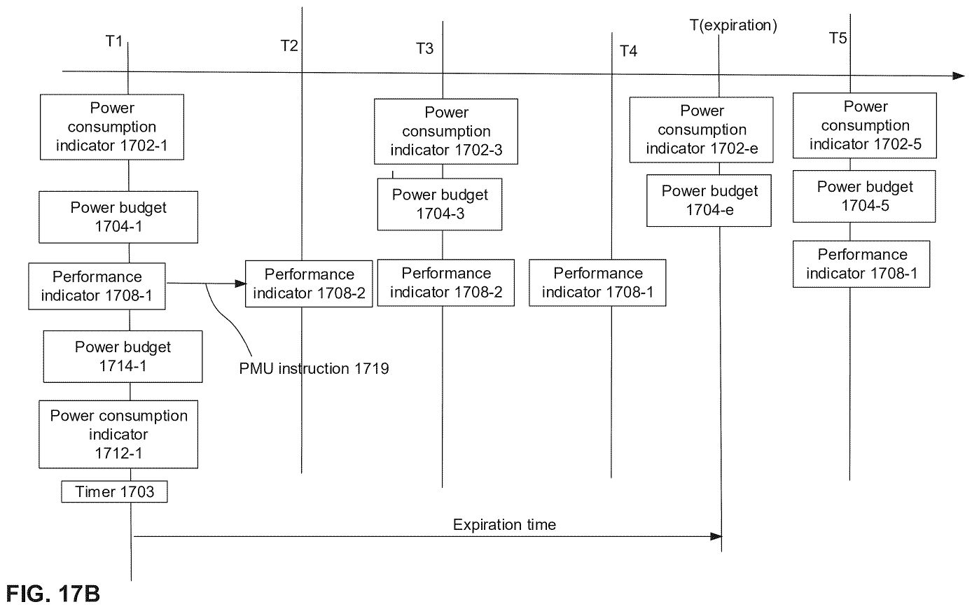

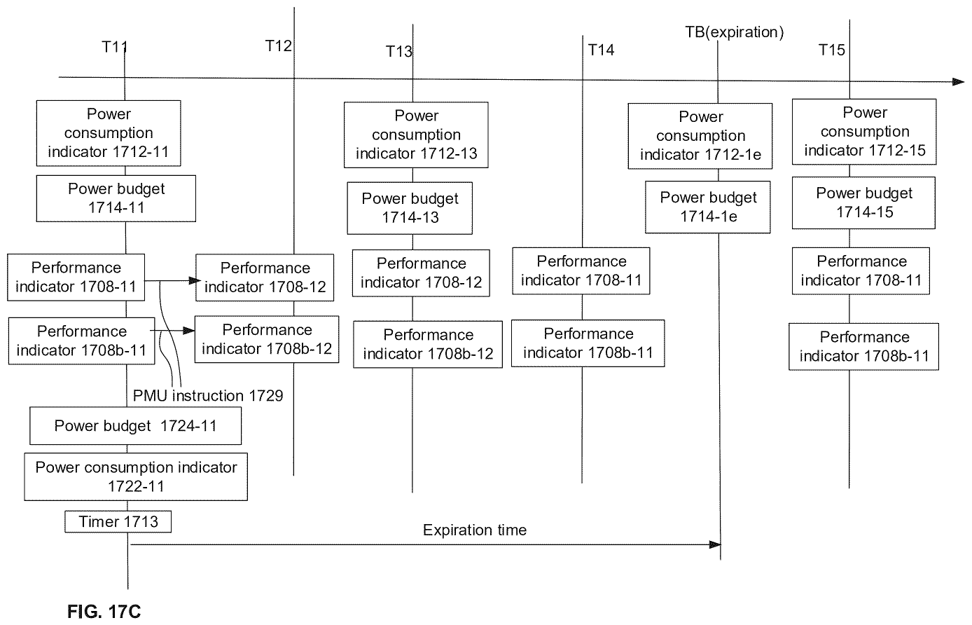

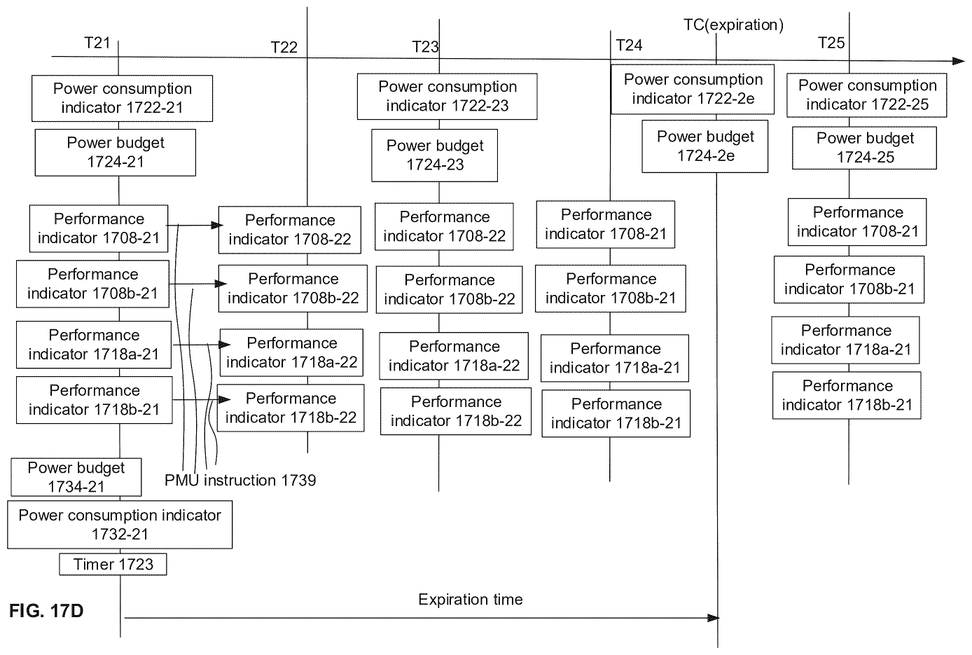

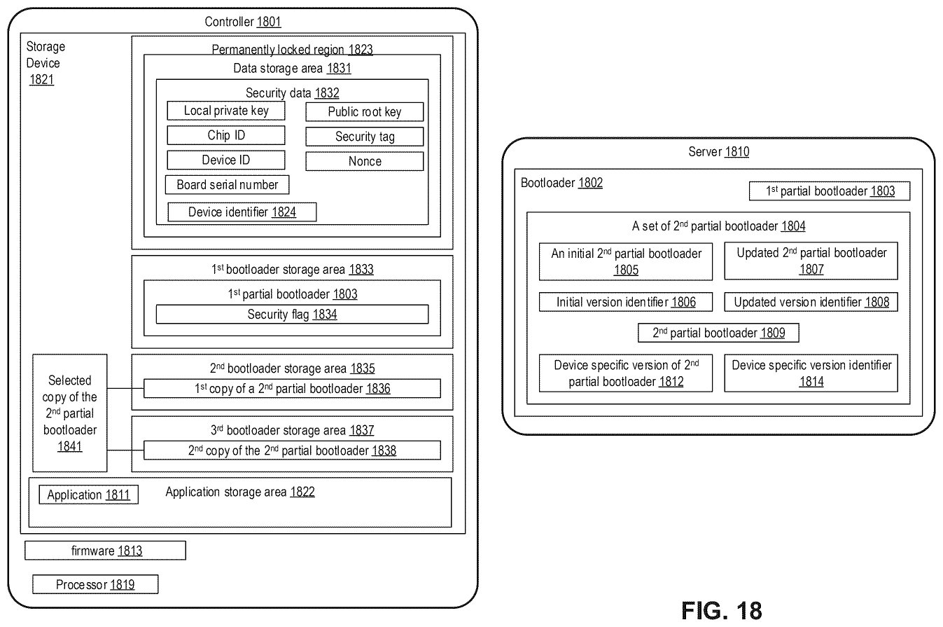

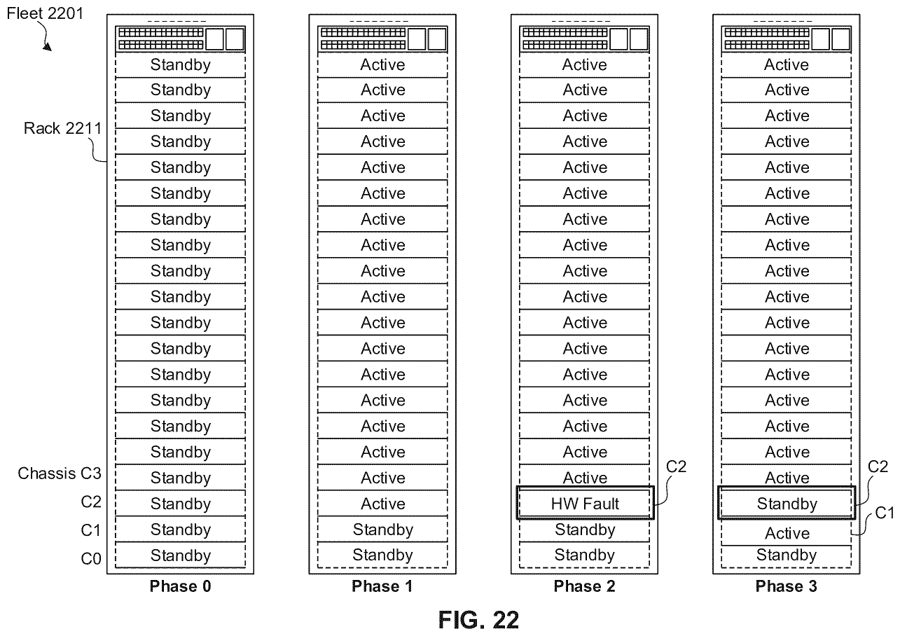

Descriptions below present details on various aspects of a data center computing system. FIGS. 1-4 discuss various components of a data center computing system. For example, a chassis can be managed by a fleet management server or a host processor. A chassis can include an instruction processing device, which can be referred to as “a board management controller (BMC).” The BMC can be configured to manage operations of a set of computing devices of a chassis including one or more boards, where a board can include a set of cards, and a card can include a controller and a processing device. FIGS. 5 and 6 present details on how the components of the data center computing system are coupled together by two different communication networks. For example, the BMC of a chassis can be coupled to the controllers of cards of multiple boards in a first communication network, while the processing devices of cards of a board are coupled to each other in a second communication network. FIGS. 7 and 8 present details on operations performed by the BMC related to the boards and the cards based on the communication networks coupling the BMC, the boards, and the cards. FIGS. 9A-9G present additional details on operations performed by the BMC, the cards, and the boards. FIGS. 10A-10B present operations performed by a hierarchical manager of the BMC to manage the operations of multiple boards. The above structures and operations can be applicable to any communication network. FIGS. 11A-11C illustrate operations of a ring communication network on a board of a chassis of a data center computing system. FIGS. 12A-12L illustrate further operations of a ring communication network on a board of a chassis. FIGS. 13A-13C illustrate operations performed by a computing node of a card placed in a ring communication network on a board of a chassis. Moreover, FIGS. 14-16 present flowcharts of operations performed by a BMC, a controller of a card, and a board. FIG. 17A illustrates the power management aspect of a data center computing system, including chassis and racks having power management devices. FIGS. 17B-17D illustrate the operations of various power management devices of a data center computing system including chassis and racks. FIGS. 18, 19, 20A-20D, and 21A-21B illustrate various aspects of a controller within a chassis having a bootloader with multiple partial bootloaders. FIG. 22 presents operations of multiple chassis of a fleet.

FIGS. 1A-1B illustrate a data center computing system, including computing nodes in a number of chassis in a number of racks managed by a fleet management server and a host processor, according to some embodiments.

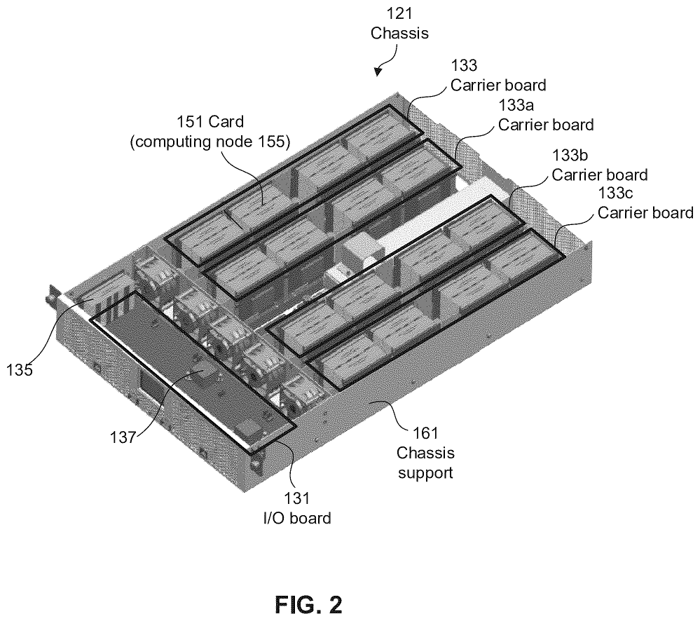

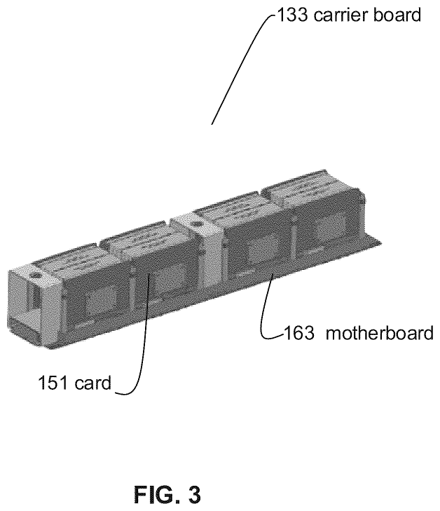

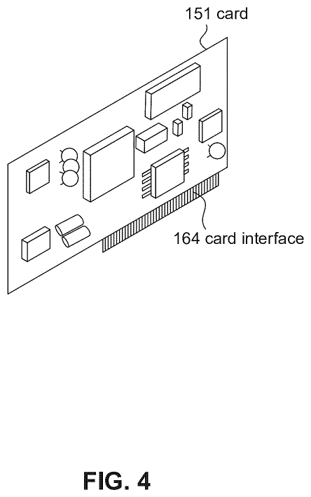

FIG. 1A illustrates a data center computing system 100 including a fleet 101 with a number of chassis placed on a number of racks, a fleet management server 103, and a host processor 105 to perform functions of a data center, according to some embodiments. Fleet 101 includes a hierarchical structure formed by multiple racks, where a rack can include multiple chassis, a chassis can include multiple boards, a board can include multiple cards, and a card can include multiple computing devices, such as a controller and a computing node. The fleet, rack, chassis, board, card, controller and/or computing node form different layers of the hierarchical structure of fleet 101. FIG. 2 illustrates an exemplary chassis including multiple boards. FIG. 3 illustrates an exemplary board including multiple cards. FIG. 4 illustrates an exemplary card of a data center computing system.

In some embodiments, fleet 101 can include multiple racks, such as a rack 111, a rack 113, and a rack 115. A rack can include multiple chassis. For example, rack 111 can include a chassis 121 and a chassis 123. In some embodiments, there can be n chassis in a rack, where n can be an integer. Similarly, rack 113 and rack 115 can also include chassis 0, chassis 1, and chassis n of total n chassis in each rack. In some embodiments, the number of chassis included in rack 111, rack 113, and rack 115 can be different.

A chassis can include multiple boards performing various functions. For example, chassis 121 can include a board 131 and a board 133, where board 131 can be an I/O board and board 133 can be a carrier board. In some embodiments, board 133 can include multiple cards, such as a card 151. In some embodiments, a number of computing devices can be placed on a card. For example, a microcontroller unit (MCU) or controller 153 and computing node 155 can be placed on card 151. In addition, chassis 121 can further include a controller—which may be referred to as “a board management controller (BMC) 135”—and a network interface card (NIC) 137. In some embodiments, BMC 135 may be used to control or coordinate operations performed by computing devices in multiple boards of chassis 121. NIC 137 can route traffic in or out of computing devices of the boards in chassis 121, according to some embodiments. A board and a carrier board can be used interchangeably.

Furthermore, fleet management server 103 can communicate with BMC 135. Similarly, fleet management server 103 can directly communicate with a computing node or a controller of a card, such as computing node 155 of card 151 of chassis 121. In addition, host processor 105 can include a job scheduler 104 that can communicate with BMC 135, controller 153, and computing node 155 to perform functions for workload orchestration. In some embodiments, job scheduler 104 can be responsible for managing the life cycle of applications on a computing node, such as computing node 155.

In some embodiments, BMC 135 of a chassis, controller 153 of a card, a controller of a board, fleet management server 103, or host processor 105 can be coupled to a security server, such as a certificate authority 141. In some embodiments, certificate authority 141 can implement various security-related operations and provide information related to various security operations. In some embodiments, certificate authority 141 can receive various requests from other controllers or devices to verify a collection of information attesting to the validity of a public key pair. In some embodiments, certificate authority 141 can issue certificates that certify the ownership of public keys and are usable to verify that owners are in possession of the corresponding private keys. As used herein, the term “certificate” may refer generally to a collection of information (e.g., a token) that can be presented to establish that a trusted authority has verified information attesting to the validity of a public-key pair.

In some embodiments, host processor 105 can maintain an orchestration pool 106 of computing devices, which can keep a record for all computing nodes in communication with job scheduler 104 and are available for receiving workload tasks or have been assigned a workload task. For example, orchestration pool 106 can include a record 108 for computing node 155. In some embodiments, functions of fleet management server 103 and host processor 105 can be implemented in separate machines in different containers, such as different machine cases. In some embodiments, functions of fleet management server 103 and host processor 105 can be implemented in an integrated machine in the same machine case or on a single integrated chip. In some embodiments, for a data center deployment, a fully-populated rack may be limited by rack constraints to deploy workloads on fewer chassis than are physically installed on the rack. For example, for rack 111, there can be some chassis with an actively-provisioned workload and other chassis that are not provisioned with a workload.

In some embodiments, there can be various controllers or processors used at different layers of the hierarchical structure of fleet 101. For example, BMC 135 is used for a chassis to manage operations by computing devices of chassis 121, and controller 153 is used to manage operations for card 151. In addition, fleet management server 103 and host processor 105 can be a general processor to manage the operations of one or more devices in fleet 101. Even though a general processor can implement BMC 135, controller 153, fleet management server 103, and/or host processor 105, different functions can be implemented by the general processor depending where the processor is used at different layers of the hierarchical structure of fleet 101. Accordingly, a processor or a controller is defined by the functions performed, in addition to how the processor or the controller is implemented.

In some embodiments, computing node 155 can include a system on a chip or system-on-chip (SoC), which integrates multiple components of a computer or other electronic system, such as a CPU or an application processor (AP), memory interfaces, I/O devices and interfaces, secondary storage interfaces, and other components. In the description below, since computing node 155 can be implemented as a SoC, the term “SoC” may be used interchangeably with “computing node.” In some embodiments, computing node 155 can be in various states, such as a state 157 and a state 159, where state 157 indicates computing node 155 has been assigned a workload task by job scheduler 104 and state 159 indicates there is no workload task assigned to computing node 155 by job scheduler 104.

In some embodiments, computing node 155 can include a processor, a controller, a peripheral component, a storage component, a network component, a multimedia processing component, a security function component, an error correction or encoding component, a timer, an analog circuit component, a Field Programmable Gate Array (FPGA) component, other suitable types of functional components, or combinations thereof, where any of the components can include a digital circuit, an analog circuit, or a mixed signal circuit.

In some embodiments, an example of computing node 155 can be illustrated as a SoC 10 shown in FIG. 1B.

In some embodiments, SoC 10 can be coupled to a memory 12. In some embodiments, the components of SoC 10 include a central processing unit (CPU) complex 14, a secure enclave processor (SEP) 16, peripheral components 18A-18B (more briefly, “peripherals”), a memory controller 22, and a communication fabric 27. The components 14, 16, 18A-18B, and 22 are coupled to the communication fabric 27. Memory controller 22 may be coupled to memory 12 during use and may include one or more configuration registers. In some embodiments, CPU complex 14 may include one or more processors and one or more cache memories (both not shown). The CPU complex may also include a cryptographic unit (CU) 38. As shown in FIG. 1B, peripheral component 18B and memory controller 22 may also include a respective cryptographic unit 38. In some embodiments, SEP 16 includes one or more processors 32, a secure boot ROM 34, and one or more security peripherals 36. Although not shown in FIG. 1B, in some embodiments, SEP 16 may also have a separate cryptographic unit in the one or more processors 32. Processor(s) 32 may be referred to herein as SEP processor(s) 32. It is noted that in one embodiment, SoC 10 may be integrated onto a single semiconductor substrate as an integrated circuit “chip.” In some embodiments, the components may be implemented on two or more discrete chips in a system.

SEP 16 is an example of a security circuit. A security circuit may be any circuitry that is configured to perform one or more secure services for the rest of SoC 10 (e.g., the other components in SoC 10). That is, a component may transmit a request for a secure service to the security circuit, which may perform the secure service and return a result to the requestor. The result may be an indication of success/failure of the request and/or may include data generated by performing the service. For example, secure services may include various cryptographic operations, such as authentication, encryption, decryption, etc. The result of an authentication operation may be a pass/fail indication, for example. The result of encryption/decryption operation may be the encrypted/decrypted data. Secure services may include secure key generation, where the keys may be used by components external to the security circuit for various security functions, such as encryption or authentication. The result of secure key generation may be the key or an encrypted key, as described in greater detail below for an embodiment.

Secure services may include any services related to ensuring the protection of private data and/or preventing the unauthorized use of the system including SoC 10. Protecting private data may include preventing unauthorized access (e.g., theft of data) and/or preventing corruption/destruction of the data. Protecting private data may include ensuring the integrity and confidentiality of the data, and the availability of the data to authorized access. Preventing unauthorized use may include, e.g., ensuring that a permitted use is paid for (e.g., network access by a portable device) and may also include deterring nefarious acts. Nefarious acts may include, for example, use of a device to consume power from a battery of the device so that authorized use is curtailed due to a lack of power, acts to cause damage to the system or to another system that interacts with the system, use of the device to cause corruption of data/software, etc. Secure services may include ensuring that the system is available to authorized users as well, and authenticating authorized users.

A security circuit may include any desired circuitry (e.g., cryptographic hardware, hardware that accelerates certain operations that are used in cryptographic functions, etc.). A security circuit need not include a processor. In some embodiments, SEP processor 32 may execute securely loaded software. For example, secure read-only memory (ROM) 34 may include software executable by SEP processor 32. One or more of security peripherals 36 may include an external interface, which may be connected to a source of software. The software from the source may be authenticated or otherwise verified as secure and may be executable by SEP processor 32. In some embodiments, software may be stored in a trust zone in memory 12 that is assigned to SEP 16, and SEP processor 32 may fetch the software from the trust zone for execution.

SEP 16 may be isolated from the rest of SoC 10 except for a carefully-controlled interface (thus forming a secure enclave for SEP processor 32, secure boot ROM 34, and security peripherals 36). Because the interface to SEP 16 is carefully controlled, direct access to SEP processor 32, secure boot ROM 34, and security peripherals 36 may be prevented. Various mechanisms may be used to prevent such direct access. For example, in some embodiments, a secure mailbox mechanism may be implemented. In the secure mailbox mechanism, external devices may transmit messages to an inbox. SEP processor 32 may read and interpret the message, determining the actions to take in response to the message. Response messages from SEP processor 32 may be transmitted through an outbox, which may also be part of the secure mailbox mechanism. In some embodiments, no other access from the external devices to SEP 16 may be permitted. In some embodiments, SEP 16 may send encrypted and/or wrapped keys to some peripherals (e.g., 18A, 18B). In addition, the keys may include policy information that may control how the keys are used.

Security peripherals 36 may be hardware configured to assist in the secure services performed by SEP 16. For example, the security peripherals may include authentication hardware implementing various authentication algorithms, encryption hardware configured to perform encryption, secure interface controllers configured to communicate over a secure interface to an external (to SoC 10) device, etc.

Thus, in some embodiments, SEP 16 may be an SoC within an SoC. SEP 16 may be relatively autonomous from the remainder of SoC 10. While communication between SEP 16 and the remainder of SoC 10 is supported, SEP 16 may execute independent of SoC 10 and vice versa.

CPU complex 14 may include one or more CPU processors (not shown) that serve as the CPU of SoC 10. The CPU of the system includes the processor(s) that execute the main control software of the system, such as an operating system. In some embodiments, software executed by the CPU during use may control other components of the system to realize a desired functionality (except that, in some embodiments, the operating system may not control SEP 16). The CPU processors may also execute other software, such as application programs. The application programs may provide user functionality, and may rely on the operating system for lower level device control. Accordingly, the CPU processors may also be referred to as application processors. The CPU complex may further include other hardware, such as cache memory and/or an interface to the other components of the system (e.g., an interface to communication fabric 27).

Peripherals 18A-18B may be any set of additional hardware functionality included in SoC 10. For example, peripherals 18A-18B may include video peripherals such as cameras, camera interfaces, image processors, video encoder/decoders, scalers, rotators, blenders, graphics processing units, display controllers, etc. The peripherals may include audio peripherals such as microphones, speakers, interfaces to microphones and speakers, audio processors, digital signal processors, mixers, etc. The peripherals may include interface controllers for various interfaces external to SoC 10 (e.g., peripheral 18B) including interfaces, such as Universal Serial Bus (USB), peripheral component interconnect (PCI) including PCI Express (PCIe), serial and parallel ports, as well as other input/output (I/O) interfaces, etc. The peripherals may include networking peripherals, such as media access controllers (MACs). Any set of hardware may be included.

Memory controller 22 may include the circuitry for receiving memory requests from the other components of SoC 10 and for accessing memory 12 to complete the memory requests. Memory controller 22 may be configured to access any type of memory 12. For example, memory 12 may be static random access memory (SRAM), dynamic RAM (DRAM) such as synchronous DRAM (SDRAM) including double data rate (DDR, DDR2, DDR3, etc.) DRAM. Low power/mobile versions of the DDR DRAM may be supported (e.g. LPDDR, mDDR, etc.). In some embodiments, memory controller 22 may include configuration registers (not shown) to identify trust zones within the memory address space mapped to memory 12.

Communication fabric 27 may be any communication interconnect and protocol for communicating among the components of SoC 10. Communication fabric 27 may be bus-based, including shared bus configurations, cross bar configurations, and hierarchical buses with bridges. Communication fabric 27 may also be packet-based, and may be hierarchical with bridges, cross bar, point-to-point, or other interconnects.

Cryptographic units 38 may each perform one or more cryptographic functions for the components in which they are included. For example, each cryptographic unit 38 may be used to encode/decode data using one or more encryption algorithms. Each individual cryptographic unit 38 may also be capable of performing, in whole or in part, a keyed hashing function. A “keyed hashing function” refers to a hash function that requires a keyword to generate a hash value. In addition to performing cryptographic functions, the cryptographic units 38 may be designed to receive policies associated with a keyword received from the SEP 16 and implement the policies on the keyword before using the keyword.

It is noted that the number of components of SoC 10 (and the number of subcomponents for those shown in FIG. 1B, such as within CPU complex 14 and SEP 16) may vary from embodiment to embodiment. There may be more or fewer of each component/subcomponent than the number shown in FIG. 1B.

In some embodiments, SoC 10 with SEP 16 as part of computing node 155 may operate similarly to an SoC of a user or consumer device having SoC 10 with SEP 16, allowing for the same security model that would be enforced on a consumer device to be extended to a data center using fleet 100 using SoC 10 with SEP 16 as described above.

In some embodiments, additional details on a chassis are shown in FIG. 2. Chassis 121 can include a chassis support 161, which can be a load-bearing framework of a manufactured object structurally supporting the object included within. In some embodiments, chassis support 161 can be mounted inside rack 111 or attached to rack 111. In some embodiments, chassis support 161 can include a frame or other internal supporting structure on which the circuit boards and other electronics are mounted. In the description herein, a chassis, such as chassis 121, can refer to a set of computing devices or systems supported by chassis support 161. The operations of chassis 121 described below are performed by computing devices supported by chassis support 161 of chassis 121.

In some embodiments, as shown in FIG. 2, chassis 121 can include carrier board 133, I/O board 131, and other boards. In some embodiments, chassis 121 can include 4 carrier boards, such as carrier board 133, carrier board 133a, carrier board 133b, and carrier board 133c. In some embodiments, BMC 135 and NIC 137 may be placed on I/O board 131. In some embodiments, BMC 135 and NIC 137 may be placed separately from I/O board 131. In some embodiments, carrier board 133, I/O board 131, or any other board can be a PCB, which can also be called as a printed wiring board (PWB). In some embodiments, a PCB may be medium used to connect or “wire” components to one another in a circuit. Carrier board 133 and/or I/O board 131 can take the form of a laminated sandwich structure of conductive and insulating layers, where each of the conductive layers is designed with a pattern of traces, planes, and other features (similar to wires on a flat surface) etched from one or more sheet layers of copper laminated onto and/or between sheet layers of a non-conductive substrate. Carrier board 133 and/or I/O board 131 can be used as a base in electronics-both as a physical support piece and as a wiring area for surface-mounted and socketed components. Carrier board 133 and/or I/O board 131 can be made out of fiberglass, composite epoxy, or other suitable composite materials. Carrier board 133 and/or I/O board 131 can host or include electronic components, such as resistors, capacitors, diodes, and transistors.

In some embodiments, as shown in FIGS. 2-4, carrier board 133 can include a motherboard 163, which may also be called a mainboard, a main circuit board, a backplane board, a base board, a system board, or a logic board. Motherboard 163 can be the main PCB in general-purpose computers and other expandable systems. Motherboard 163 can hold and allow communication between electronic components of a system, such as the central processing unit (CPU) and memory, and provides connectors for other peripherals.

Motherboard 163 can be a PCB with expansion capabilities, where multiple slots (not shown) can host card 151 through a card interface 164 shown in FIG. 4. As shown in FIG. 2, multiple computing nodes can be coupled on carrier board 133 to form a topology, such as a ring topology. Functions performed by card 151 or computing node 155 can also be performed by additional devices that include peripherals, interface cards, sound cards, video cards, network cards, host bus adapters, TV tuner cards, IEEE 1394 cards, and a variety of other suitable components.

In some embodiments, as shown in FIG. 2, NIC 137 can be a network interface card, a network adapter, a LAN adapter, or a physical network interface. NIC 137 can be a computer hardware component that connects a computer to a computer network. In some embodiments, NIC 137 can be implemented on expansion cards that plugs into a computer bus of I/O board 131.

FIGS. 5 and 6 illustrate chassis 121 including an instruction processing device coupled to multiple boards via two different communication networks, according to some embodiments. In some embodiments, chassis 121 can include I/O board 131, and multiple carrier boards, such as carrier board 133, carrier board 133a, carrier board 133b, and carrier board 133c. I/O board 131 can include BMC 135 and network switch device 137a. In some embodiments, network switching device 137a may include a network interface card (NIC). In addition, the structure of carrier boards can be the same for carrier board 133, carrier board 133a, carrier board 133b, and carrier board 133c.

In some embodiments, carrier board 133 can include network switching device 137b that is coupled to network switching device 137a of I/O board 131. Carrier board 133 can further include a number of cards, such as a card 151a, a card 151b, a card 151c, a card 151d, a card 151e, a card 151f, a card 151g, and a card 151h. Eight cards are shown in FIG. 5 as an example for carrier board 133. In some embodiments, carrier board 133 can include a different number of cards, such as 2 cards, 4 cards, 6 cards, or other suitable number of cards. While the term “card” 151 is used herein, card 151 may also include additional suitable devices for performing the functions of card 151 including but not limited to a processor, a SoC, a monolithic IC, a controller, a peripheral component, a storage component, a network component, a multimedia processing component, a security function component, an error correction or encoding component, a timer, an analog circuit component, a Field Programmable Gate Array (FPGA) component, other suitable types of functional components, or combinations thereof, where any of the components can include a digital circuit, an analog circuit, or a mixed signal circuit.

In some embodiments, a controller of each card can be coupled to one another to form a topology 154, which can be a tree-like topology, a star-like topology, a ring topology, a mesh topology, or a graph topology. A controller 153a of card 151a, a controller 153b of card 151b, a controller 153c of card 151c, a controller 153d of card 151d, a controller 153e of card 151e, a controller 153f of card 151f, a controller 153g of card 151g, and a controller 153h of card 151h can be coupled by a communication network having topology 154. In some embodiments, BMC 135 can be coupled to controller 153a of card 151a on carrier board 133 and also coupled to controller 153i of a card 151i on board 133a. Therefore, BMC 135 controls operations beyond a single carrier board. Instead, BMC 135 can be coupled to a first controller of a first card of a first carrier board and coupled to a second controller of a second card of a second carrier board. In some embodiments, an additional controller may be placed on a single carrier board. For example, a board-level controller can be placed on carrier board 133 to communicate and coordinate operations performed by all cards of carrier board 133 but not to control operations performed by any other card of other carrier board. Accordingly, such a board-level controller would perform functions different from functions performed by BMC 135. Embodiments herein present designs that BMC 135 can manage operations of computing devices on multiple cards of a carrier board without a board-level controller designed only for a single board.

In some embodiments, as shown in FIGS. 5 and 6, carrier board 133 can include 8 cards. However, the number of cards is for example only, and carrier board 133 can include any number of cards arranged in multiple different topologies. Each card includes a controller and a computing node to form a pair. For example, card 151d includes controller 153d and a computing node 155d. Other cards can also include a pair formed by a controller and computing node. As shown in FIG. 5, all the controllers of the cards of carrier board 133 form a communication network having topology 154, which can have a tree shape or a star shape. In addition, all the computing nodes of the cards of carrier board 133 can form a different communication network which may have a different topology, such as a topology 156 that is a ring shape as shown in FIG. 6. In some embodiments, other components can be coupled in topology 156, such as a retimer, a bypass circuit (e.g., a multiplexer circuit), and an interconnect controller. In some embodiments, the controllers of the cards of carrier board 133 can form a first communication network having a first topology, and the computing nodes of the cards of carrier board 133 can form a second communication network having a second topology. The first communication network for the controllers of carrier board 133 can have a different communication protocol from the second communication network for computing nodes of carrier board 133. In some embodiments, the first communication network for the controllers of carrier board 133 can have a different topology from the second communication network for computing nodes of carrier board 133.

FIG. 7 illustrates chassis 121 including an instruction processing device, such as BMC 135, for managing operations of multiple boards, according to some embodiments. Chassis 121 can include BMC 135, carrier board 133, and carrier board 133a. In addition, chassis 121 can further include I/O board 131, NIC 137, a power supply unit (PSU) 163, a power management unit (PMU) 165. There can be other components, such as ports and additional functional devices (e.g., security function devices, multimedia function devices, and communication function devices), which can be organized into different boards, cards, or systems (not shown in FIG. 7).

In some embodiments, carrier board 133 can include card 151a and card 151b, where card 151a includes controller 153a and computing node 155a, and card 151b includes controller 153b and computing node 155b. As shown in FIGS. 5 and 6, computing node 155a and computing node 155b are coupled by a communication network with topology 156, while controller 153a and controller 153b are coupled by a communication network with topology 154. In addition, BMC 135 may be coupled to controller 153a or controller 153b by the communication network with topology 154.

In some embodiments, BMC 135 can manage, control and coordinate operations of controllers placed on multiple boards. Hence, BMC 135 is different from a board-level controller placed on a single board controlling operations of computing devices of the single board. In some embodiments, for data center computing, a chassis may be a unit managed by fleet management server 103 or host processor 105. A chassis can be placed or replaced from a rack with ease compared to any change to be made to a board in a chassis. In addition, using BMC 135 at the chassis level instead of at the board-level controller can provide more efficient operations with less complexity.

In some embodiments, carrier board 133a can include card 151aa and card 151ab, where card 151aa includes controller 153aa and computing node 155aa, and card 151ab includes controller 153ab and computing node 155ab. As shown in FIG. 7, computing node 155aa and computing node 155ab are coupled by the communication network with topology 156, while controller 153aa and controller 153ab are coupled by the communication network with topology 154. In addition, BMC 135 may be coupled to controller 153aa or controller 153ab by the communication network with topology 154.

Accordingly, BMC 135 is coupled to controllers of card 151a and card 151aa by the same communication network as topology 154. In some embodiments, BMC 135 can be coupled to controllers of card 151a and card 151aa by a different communication network. BMC 135 can be different from a controller placed on a board level to control operations of computing devices on the board. Instead, BMC 135 controls operations of computing nodes of multiple boards.

In some embodiments, BMC 135 can include multiple layers of software to manage the operations of the multiple boards, where the multiple layers of software can include an application layer 171, a transport layer 172, a platform layer 173, and a daemon 175. In addition, BMC 135 can include a parameter, chassis status 181, which can indicate the status of all computing devices on chassis 121. In some embodiments, chassis status 181 can be implemented by a value stored in a register or other memory device. In some embodiments, chassis status 181 can be in various states, such as a power off state, a power on state, a standby state, an active state, a faulty state, or an unprovisioned state. Chassis status 181 can represent a state of the entire computing system hosted by chassis support 161 of chassis 121. The states can be defined by how chassis 121 is perceived by external software and a site technician. In some embodiments, different states can be defined based on the application of interests, the purpose of the data center, or other suitable parameters.

For example, as shown in FIG. 8, states of chassis status 181 are shown in a state diagram 190. In some embodiments, chassis status 181 can be in an off state 191, a debug state 192, a boot state 193, a recovery state 194, a standby state 195, an active state 196, a shutdown state 198, or a generic state called any state 199. There can be additional states to state diagram 190. In some embodiments, one or more of the states can be removed from state diagram 190.

In some embodiments, off state 191 can be an initial state of the system, boot state 193 can be a transitional state that encapsulates the boot process of BMC 135 or a boot process of a computing node of a card. Debug state 192 can give an operator an opportunity to connect a debug host to the debug port and abort computing node auto-boot. After a computing node auto-boot is aborted, a BMC MCU application can be updated and booted. The booted BMC MCU application can allow an external debug host drive to erase-install the BMC SoC. Standby state 195 can be designed for a spare chassis use case, where a “bad” chassis can be forced by fleet management software into a verifiable state where a known static chassis power limit is guaranteed and inactive “good” chassis can be brought up to active state. Recovery state 194 can be a state of the system where the system can only be recovered manually by an operator. An example of when recovery state 194 is entered is a BMC SoC panic loop; after several unsuccessful attempts to boot BMC AP, the system enters recovery state 194. A visual indication that system has entered recovery state 194 can be displayed.

In some embodiments, examples of BMC 135 interacts with computing devices on multiple boards are illustrated in FIGS. 1, 2, 5, 6, and 7, where BMC 135 can control and communicate with computing nodes of multiple cards on multiple boards. The description below further illustrates additional details on how BMC 135 communicates and controls operations of computing nodes of multiple cards on a single board.

FIG. 9A illustrates data center computing system 100 including an instruction processing device of a chassis for managing operations of multiple cards of a board, according to some embodiments. In some embodiments, data center computing system 100 including a number of chassis, such as chassis 121 placed on rack 111, fleet management server 103, and host processor 105, according to some embodiments. Chassis 121 can include carrier board 133 that can include a card 251, a card 252, and a card 254 having their computing nodes coupled to one another by a communication network 203. In some embodiments, communication network 203 can be a communication network having topology 156. In addition, card 251 can include a controller 253a, card 252 can include a controller 253b, and card 254 can include a controller 253c. BMC 135 of chassis 121 can be coupled to controller 253a, controller 253b, and controller 253c by a communication network 201. In some embodiments, communication network 201 can be a communication network having topology 154. In some embodiments, communication network 203 and communication network 201 can have different topologies or different communication protocols. For example, communication network 201 can operate according to communication protocol T1, while communication network 203 can operate according to communication protocol T2. Communication protocol T1 or T2 can be any suitable communication protocol, such as Universal Serial Bus (USB), Inter-Integrated Circuit (I2C), a parallel computer bus protocol, a serial computer bus protocol, Thunderbolt, Recommended Standard (RS) 232, Ethernet, IEEE 1394 interface, Small Computer System Interface (SCSI), Scalable Coherent Interface (SCI), Peripheral Component Interconnect (PCI) type bus (e.g., PCI express), universal asynchronous receiver/transmitter (UART), and Serial Peripheral Interface (SPI) bus.

In some embodiments, card 251 can include controller 253a and a computing node 255a coupled by a communication link 205. Computing node 255a can include an AP 211 that can be a processing device and an I/O circuit 212 that includes port 215, port 217, and a direct memory access (DMA) engine 213. Similarly, card 252 can include controller 253b and a computing node 255b coupled by a communication link 207. Computing node 255b can include an AP 221 that can be a processing device and an I/O circuit 222 that includes port 225, port 227, and a direct memory access (DMA) engine 223. In some embodiments, a processing device can refer communication node 255a or AP 211. In some embodiments, communication link 205 and communication link 207 can be a part of communication network 201. In some embodiments, communication link 205 and communication link 207 can be different from communication network 201 or communication network 203. Similarly, card 254 can include controller 253c and a computing node 255c, where controller 253c can perform functions similar to controller 253a and computing node 255c can perform functions similar to computing node 255a.

In some embodiments, a multiplexer 262 and a multiplexer 264 can be placed on each side of card 254. Similarly, a multiplexer can be placed on each side of any other card, such as card 251 and card 252 (not shown). Multiplexer 262 is placed between card 254 and card 251, and multiplexer 264 is placed between card 252 and card 254. Multiplexer 262 can be coupled to computing node 255c of card 254 through a communication link 265, and multiplexer 264 can be coupled to computing node 255c of card 254 through a communication link 267. Additionally, there can be a direct link 269 between multiplexer 262 and multiplexer 264. A control signal 261 can select either link 265 or link 269 for multiplexer 262, and a control signal 263 can select either link 267 or link 269 for multiplexer 264 to be a part of communication network 203. Control signal 261 and control signal 263 can be generated or determined by BMC 135. Accordingly, communication network 203 can include a direct link 269 between multiplexer 262 and multiplexer 264 to bypass computing node 255c. Additionally and alternatively, communication network 203 can include link 265 and link 267 to communicate through computing node 255c.

In some embodiments, BMC 135, which can be an instruction processing device, can manage operations of a set of computing devices of chassis 121 including one or more boards, such as carrier board 133. The set of computing devices of chassis 121 can include the computing nodes of all cards in all boards of chassis 121. Carrier board 133 can include a set of cards, such as card 251, card 252, and card 254. Card 251 can include controller 253a and computing node 255a, which can be a processing device. In some embodiments, computing node 255a can include AP 211 and I/O circuit 212, including port 215, port 217, and DMA engine 213. Port 215, port 217, and DMA 213 form a part of communication network 203. Similarly, card 252 can include controller 253b and computing node 255b, which can be a processing device. In some embodiments, computing node 255b can include AP 221 and I/O circuit 222, including port 225, port 227, and DMA engine 223. Port 225, port 227 and DMA 223 form a part of communication network 203. Similarly, card 254 can include controller 253c and computing node 255c, which can be a processing device. Computing node 255c can be a part of communication network 203. In some embodiments, a computing node can be referred to as “a node.” For example, computing node 255a can be referred to as “node 255a.”

In some embodiments, carrier board 133 can include 8 cards, where each card includes a controller similar to controller 253a and a processing device similar to computing node 255a. In some embodiments, communication network 203 can form a ring topology for all the computing nodes of all cards of carrier board 133.

In some embodiments, BMC 135 and the controller of a card, such as controller 253a, controller 253b, and controller 253c, can be coupled by communication network 201. In some embodiments, communication network 201 can be different from communication network 203 in terms of the network topology, communication protocol, or both. BMC 135 can provide and controller 253a can receive an instruction from BMC 135 through communication network 201. Computing node 255a or AP 211 can generate an operation result 951 based on the instruction. In addition, computing node 255a or AP 211 can provide operation result 951 to computing node 255b through DMA engine 213, port 217, port 255, DMA engine 223, which are part of communication network 203. In some embodiments, one or more data packets 953 can be generated based on the operation result 951. One or more data packets 953 can be generated by AP 211, DMA engine 213, or other components of computing node 255a. Card 251, e.g., AP 211 or DMA engine 213, can provide one or more data packets 953 generated based on operation result 951 to card 252 through communication network 203.

In some embodiments, BMC 135 can include various software components, such as application layer 171, transport layer 172, platform layer 173, and daemon 175. In some embodiments, application layer 171 can support any application, such as a security application, a multimedia application, and a communication application. Transport layer 172 can bridge the gap between distributed components in data center computing system 100 and provide an abstraction over low-level protocols, such as IPV6 and I2C. Transport layer 172 can represent the system as a set of platform specific blocks that offer platform specific services to platform layer 173.

In some embodiments, platform layer 173 can describe relationships between platform components (e.g., computing nodes on a carrier board), introduce component and system states, and define supported transitions between those states. Platform layer 173 can represent data center computing system 100 as a set of computing nodes.

In some embodiments, daemon 175 can serve as a center of truth for the system state. Daemon 175 can discover controllers over each card of the boards and their corresponding signals and build high-level constructs on top of controller signals. The high-level constructs can implement platform functions. In addition, daemon 175 can perform system state management, describe components in data center computing system 100 and their states and state transitions, and describe relationships between these components of data center computing system 100.

In some embodiments, controller 253a of card 251 can include various firmware and operating system (OS) 231, which can include drivers and firmware. A communication channel can be established between BMC 135 and controller 253a. In some embodiments, firmware and operating system 231 can be responsible for a clean shutdown of card 251 and perform configuration of communication network 203. In some embodiments, firmware and operating system 231 can manage power budget and other security functions of card 251.

In some embodiments, BMC 135 can manage a slot identifier for each card included in the board, where the slot identifier is unique for cards in the board. For example, card 251, card 252, and card 254 each has a unique slot identifier that is different from the slot identifier of other cards of carrier board 133.

In some embodiments, NIC 137 can be coupled to BMC 135 and carrier board 133 to route traffic from the set of cards of the board. BMC 135 can select an uplink card from the set of cards of the board, such as card 252, and program a connection between the network device and the uplink card. In some embodiments, BMC 135 can assign card 252 as an uplink card coupled to NIC 137 to route traffic from the set of cards, such as card 251 and card 254, to NIC 137.

In some embodiments, BMC 135 can determine or discover a topology formed by the set of cards of the board or a topology formed by the set of computing nodes of the set of cards of the board. For example, BMC 135 can determine or discover a ring topology formed by computing node 255a of card 251, computing node 255b of card 252, and computing node 255c of card 254. BMC 135 can further send location-specific configuration information to the controller of the card, such as sending location-specific configuration information to controller 253a of card 251, location-specific configuration information to controller 253b of card 252, and location-specific configuration information to controller 253c of card 254.

In some embodiments, BMC 135 can determine whether a processing device of a card, such as computing node 255a, is available in orchestration pool 106 managed by job scheduler 104 to accept an assignment of a workload task. In some embodiments, BMC 135 can determine whether the processing device of the card, such as computing node 255a, is not available in orchestration pool 106 managed by job scheduler 104 to accept an assignment of a workload task.

In some embodiments, BMC 135 can receive a message from job scheduler 104 to indicate that no computing device of the set of computing devices of chassis 121 has been provisioned a workload task. Accordingly, BMC 135 can instruct the set of computing devices of the chassis to enter a standby state. In addition, BMC 135 can instruct chassis status 181 to enter the standby state.

In some embodiments, BMC 135 can receive, from job scheduler 104, an assignment of a workload task to be assigned to a processing device of a card, such as computing node 255a of card 251. BMC 135 can transfer an instruction to controller 253a of card 251 about the assignment of the workload task. In addition, BMC 135 can instruct the set of computing devices of the chassis to enter an active state and instruct chassis status 181 to enter the active state. In some embodiments, BMC 135 can determine a workload task has been assigned to the processing device of the card, such as computing node 255a of card 251, and record the workload task that has been assigned to the processing device of the card. In some embodiments, BMC 135 can receive a request from job scheduler 104 to drain the processing device of the card, such as computing node 255a of card 251, to deallocate all workload tasks assigned to the processing device of the card. Accordingly, BMC 135 can instruct the processing device of the card to enter a standby state.

In some embodiments, BMC 135 can detect a fault of the set of computing devices of the chassis. For example, BMC 135 can detect a fault occurring in computing node 255a of card 251 and deallocate a set of workload tasks assigned to the set of computing devices of the chassis to be assigned to a set of computing devices of another chassis. In addition, BMC 135 can transition the set of computing devices of chassis 121 to enter a standby state and instruct chassis status 181 to enter the standby state.

In some embodiments, BMC 135 can manage a state of the processing device of the card, such as computing node 255a of card 251. The state of computing node 255a can be an assigned state 157 indicating a workload task has been assigned to the processing device of the card or an unassigned state 159 indicating no workload task has been assigned to the processing device of the card.

In some embodiments, BMC 135 can enter a state selected from a standby state, an active state, a self-test state, an update state, a recovery state, a restoration state, a boot state, a reboot state, a fault state, and an unprovisioned state. For example, BMC 135 can perform operations to chassis status 181 to enter the selected state.

In some embodiments, BMC 135 can manage the traffic going through the multiple cards of a board, such as traffic going through computing node 255a of card 251, computing node 255b of card 252, and computing node 255c of card 254.

In some embodiments, BMC 135 can receive a message indicating controller 253c of card 254 or computing node 255c of card 254 does not functional normally and inform card 252 or card 251, which are neighbors of faulty card 254, to route traffic to avoid an affected portion of communication network 203 by card 254. In addition, BMC 135 can program one or more links of the communication network, such as link 269, to bypass card 254. In some embodiments, BMC 135 can receive, from card 251, a link-down report of neighbor card 254, a timeout event report for neighbor card 254, or a report that neighbor card 254 is offline from controller of card 251 or processing device of card 251.

In some embodiments, BMC 135 can disable communication link 265 coupled to neighbor card 254 when the neighbor card 254 is reported to be broken. BMC 135 can also enable communication link 265 of communication network 203 coupled to neighbor card 254 when neighbor card 254 is reported to be in working condition. In some embodiments, BMC 135 can program multiplexer 262 between card 251 and card 254 to route traffic bypass card 254. In some embodiments, BMC 135 can route a first traffic along a first direction among a first set of cards of the board to reach a network device and route a second traffic along a second direction among a second set of cards of the board to reach the network device.

In some embodiments, card 251 can include a controller 253a configured to receive an instruction through communication network 201 having a first communication protocol (T1). AP 211 can be configured to generate an operation result based on the instruction. I/O circuit 212 can be configured to receive the operation result from AP 211 and provide the operation result to computing node 255b through communication network 203 having a second communication protocol (T2). In some embodiments, communication network 203 and communication network 201 can have different topologies, different communication protocols, or both.

In some embodiments, I/O circuit 212 can receive a message from a first neighbor I/O circuit of computing node 255c of card 254 through a first link of communication network 203. I/O circuit 212 can forward the message to a second neighbor I/O circuit 222 of computing node 255b of card 252 through a second link of communication network 203.

In some embodiments, controller 253a can send an indication to BMC 135 or job scheduler 104 to indicate that computing node 255a is available to be placed in orchestration pool 106 managed by job scheduler 104 to accept an assignment of a workload task. Similarly, in some embodiments, controller 253a can send an indication to BMC 135 or job scheduler 104 to indicate that computing node 255a is not available to be placed in orchestration pool 106 managed by job scheduler 104 to accept an assignment of a workload task.

In some embodiments, controller 253a can receive an instruction of an assignment of a workload task to be assigned to computing node 255a, where the workload task is performed by computing node 255a. In some embodiments, controller 253a can receive a request from BMC 135 of chassis 121 or job scheduler 104 to drain computing node 255a to deallocate all workload tasks assigned to computing node 255a and instruct computing node 255a to enter a standby state.

In some embodiments, controller 253a can be coupled to multiplexer 262, which is coupled to controller 253c of card 254. Multiplexer 262 is programmable by BMC 135. In some embodiments, controller 253a can receive configuration information from BMC 135 when controller 253a is booted up. In some embodiments, controller 253a can receive an instruction from BMC 135 to be coupled to NIC 137. In some embodiments, computing node 255a of card 251 can be addressed by a MAC address and a slot identifier that can uniquely identify computing node 255a on carrier board 133.

In some embodiments, as shown in FIG. 9B, I/O circuit 212 can include port 215, port 217, and an I/O engine 911 having DMA engine 213, a routing table 271, a traffic matrix 273, and a number of queues (e.g., a queue 241, a queue 243, and a queue 245). Port 215 and port 217 are coupled to DMA engine 213, AP 211, queue 241, queue 243, and queue 245. I/O circuit 212 and AP 211 together can form computing node 255a, which can be referred to as “node 255a.” In some embodiments, node 255a can be a device physically separate from controller 253a of card 251.

In some embodiments, I/O circuit 212 can be coupled to a processing device, e.g., AP 211. I/O circuit 212 can receive the operation result 951 from AP 211 and provide operation result 951 to another card, e.g., card 252, through communication network 203. In some embodiments, I/O circuit 212 can receive an operation result from an I/O circuit of card 252, where a processing device of card 252 can be a source of the operation result and provide the received operation result to AP 211, where processing device AP 211 is a destination of the operation result received from card 252.

In some embodiments, I/O circuit 212 can receive an operation result from an I/O circuit of card 252, where a processing device of card 252 can be a source of the operation result. Afterwards, I/O circuit 212 can forward the operation result received from card 252 to a third card, e.g., card 254, of communication network 203. Accordingly, processing device AP 211 of card 251 is not a destination of the operation result. In some embodiments, the operation result received from card 252 can be forwarded to the third card, e.g., card 254, by I/O circuit 212 of card 251 without being provided to processing device AP 211 of card 251.

In some embodiments, node 255a can be simplified as shown in FIG. 9C, where only the two ports, port 215 (labelled as P0) and port 217 (labelled as P1), are illustrated without showing other components. In some embodiments, additional components for node 255a can be shown. Card 251 or node 255a in communication network 203 can be identified or addressed by a MAC address 955 and a slot identifier 957 that uniquely identifies card 251 or node 255a on carrier board 133. In some embodiments, when carrier board 133 has a second card, such as card 252 different from card 251, card 252 can be addressed by a second MAC address different from the MAC address for card 251. In addition, card 252 can have a second slot identifier different from the slot identifier for card 251. In some embodiments, node 255a can optionally include additional ports, such as port P3 and port P4. Hence, node 255a can have total 4 ports or other number of ports. In some embodiments, node 255a can be used to construct a communication network having a topology different from a ring topology, such as a mesh topology, a star topology, and a tree topology. Descriptions below are mainly focused on node 255a having two ports to form a ring topology. However, similar functions can be performed for node 255a having 4 ports to form a mesh topology, a star topology, or other suitable topology.

In some embodiments, a queue, such as queue 241, queue 243, and queue 245, can be configured to store traffic packets (e.g., data packets 953) of a unique source address and destination address combination. For example, a first packet stored in queue 241 is identified by a first source address and a first destination address and a second packet stored in queue 243 is identified by a second source address and a second destination address. The first source address can be different from the second source address, the first destination address can be different from the second destination address, or both. In some embodiments, a source address or a destination address can include the slot identifier of a card (e.g., card 251, card 252, or card 254), the MAC address of the card, or both.

In some embodiments, data packets 953 can include a source address and a destination address for the data packets. In some embodiments, data packets 953 can be a layer 2 network data, which can be implemented as Ethernet frames. Accordingly, layer 2 frames can be sent between nodes or cards, which can be addressable by a MAC address, which is a hardware address for the network interface of the cards. Since there are no additional headers or footers that occur to the frames sent between nodes, data packets 953 can be taken directly from the networking stack sent over the communication links between two cards or two nodes.

In some embodiments, port 215 and port 217 can include one or more processors. For example, port 215 can include a first processor 272 and a second processor 274, where first processor 272 can be a coherent I/O processor and the second processor 274 can be a time management unit coprocessor. In some embodiments, the first processor 272 and the second processor 274 can be coupled to I/O engine 911 and/or DMA engine 213. In some embodiments, port 215 can include a single processor or one or more application specific circuits. Similarly, port 217 can include one or more processors, such as a first processor 276 and a second processor 278. Packets or frames can be forwarded from processor 272 to processor 276, where both processors can be coherent I/O processors. A packet received by processor 276 can be placed into a queue based on a queue identifier included in the packet. Packets are generated so they can be forwarded along communication network 203 through port 215 or port 217.

In some embodiments, I/O circuit 212 can also include a storage device configured to store routing table 271 to determine which port to use to send a packet to a computing node of another card of the board. The storage device can further store traffic matrix 273 to determine whether to accept a received packet as having the computing device as a destination or to forward the received packet to another computing device of another card of the board. In some embodiments, I/O circuit 212 can also include a processor (not shown), which can be coupled to the storage device and further configured to perform various operations described herein, e.g., operations performed by DMA engine 213 or by I/O engine 911.

FIG. 9D illustrates a software structure of computing node 255a of card 251, according to some embodiments. A kernel driver 901 and a user space system 903 can operate on AP 211. Kernel driver 901 can include various components to perform functions, as described below. In some embodiments, kernel driver 901 can be responsible for acting as a bridge between the firmware for I/O engine 911 and the networking layer of the operating system of AP 211. Additionally, kernel driver 901 can allow for configuration and status queries for communication network 203 where computing node 255a is placed. In some embodiments, communication network 203 can have a ring network topology. In some embodiments, kernel driver 901 and user space system 903 can provide functions, such as low level firmware and command line tools.

In some embodiments, I/O engine 911 can be used primarily as DMA engine 213 for low speed peripheral buses, such as UART, SPI, I2C, and other types of buses, connected to computing node 255a. Kernel driver 901 and user space system 903 can provide a firmware that runs on the AP 211 to replace this functionality of I/O engine 911 for managing the low speed peripheral buses. Accordingly, I/O engine 911 can behave as a DMA engine, but only interact with the ports (e.g., port 215 and port 217) for operations relevant to the ring network performed by communication network 203.

In some embodiments, RingCPU manager 902 can be the kernel representation of I/O engine 911. All information between the operating system of AP 211 and I/O engine 911 passes through RingCPU manager 902, according to some embodiments. Such information can include any traffic sent or received by node 255a, ring configuration changes, link state updates, and other operations. In some embodiments, RingCPU manager 902 can use functionality provided by device driver stack 908 to interface with I/O engine 911.

In some embodiments, RingService 904 can provide the network interface for a networking stack 905, which can be the networking stack of the operating system for AP 211. RingService 904 can be responsible for interacting with the networking stack's packet queues, either instructing I/O engine 911 (through RingCPU manager 902) to transmit packets or taking packets received by I/O engine 911 and enqueueing them for further processing and delivery. RingService 904 can be coupled to RingCPU manager 902, with networking-generic (and not I/O engine 911 specific) tasks in RingService 904.

In some embodiments, RingLink 906 can be instantiated when a connection is made on a port of node 255a. RingLink 906 can represent a connection with another system that supports the protocol for communication network 203.

In some embodiments, User client 907 can allow communication with a driver from user space system 903. User client 907 can be attached to RingService 904, providing an interface for Ringtool 909 to configure the operation of communication network 203, which can be a ring network.

In some embodiments, RingSupport 913 can be a framework within Ringtool 909, which implements abstractions for user space system 903 to interact with the kernel driver 901. The framework for Ringtool 909 can handle locating the driver for RingService 904, instantiating user clients, and a variety of methods for configuring the ring network. In some embodiments, Ringtool 909 can be a command line tool provided by Ringtool 909 that allows for interactive configuration and introspection into the ring state. RingSupport 913 can be used to interface with the kernel driver 901 via user client 907.

In some embodiments, the description above for kernel driver 901 and user space system 903 is exemplary and not limiting. There can be additional operations and software components not described. The operations and software components described can be altered depending on the application of communication network 203.

FIGS. 9E-9G illustrate the operations and interactions a card or a node can perform related to one or more other cards of a board, according to some embodiments. These operations can include sending, receiving, forwarding, and bypassing.

In some embodiments, node 255a can play various roles in communication network 203. Node 255a can provide a network interface for information in node 255a. For example, node 255a can initiate a file transfer by sending network traffic out to another node which can perform server functions. In addition, node 255a can facilitate access to the network for other nodes in communication network 203. Since each node is only connected to exactly two other nodes in the ring network, traffic may need to pass through multiple nodes on the route from the source to the destination. In some embodiments, node 255a can perform a forwarding function when node 255a is not the source or destination of a data packet being transmitted. In addition, when node 255a is faulty or offline, node 255a can be passed in communication network 203.

In some embodiments, FIG. 9E illustrates node 255a performs a sending function while node 255b performs a receiving function. Node 255a can be identified by a slot identifier, e.g., slot 0, and can have two ports, port 0 (P0) and port 1 (P1). Similarly, node 255b can be identified by a slot identifier slot 1, and can have two ports, port 0 (P0) and port 1 (P1). Port P1 of node 255a of card 251 at slot 0 can be coupled to port P0 of node 255b of card 252 at slot 1 located on carrier board 133. A client application 921 operates on node 255a and a server application 923 operates on node 255b. Using client application 921, node 255a can send one or more data packets to node 255b. Using server application 923, node 255b can receive one or more data packets from node 255a.

In some embodiments, FIG. 9F illustrates node 255a performs forwarding function. In addition to node 255a and node 255b described above, node 255c is shown as identified by a slot identifier, e.g., slot 2, and can have two ports, port 0 (P0) and port 1 (P1). A client application 925 operates on node 255c, and a server application 927 operates on node 255b. Using client application 925, node 255c can send one or more data packets to node 255a at slot 0. Node 255a at slot 0 can receive one or more data packets from node 255c and forward the one or more data packets to node 255b. In some embodiments, the one or more data packets can be generated by node 255c based on an operation result created by a processing device of node 255c. Using server application 927, node 255b can receive one or more data packets forwarded from node 255a that is originated from node 255c. Node 255c is the source of the one or more data packets received by node 255b, while node 255b is the destination of the one or more data packets. Node 255a at slot 0 only performs forwarding function for the one or more data packets. In some embodiments, since the forwarding task is delegated to the I/O engine of node 255a, the processing device, e.g., AP 211, of node 255a can be free to perform other functions not related to the one or more data packets. Hence, the one or more data packets can be forwarded by node 255a without being provided to processing device AP 211 of card 251.

In some embodiments, FIG. 9G illustrates a bypassing function performed around node 255a on carrier board 133. A MUX circuit 931 can be coupled to port P0 of card 251 and further coupled to port P1 of card 254. A MUX circuit 933 can be coupled to port P1 of card 251 and further coupled to port P0 of card 252. Card 251, card 252, and card 254 are coupled to BMC 135 through communication network 201. In addition, MUX circuit 931 and MUX circuit 933 are coupled to BMC 135 to control the operations of MUX circuit 931 and MUX circuit 933 through communication network 201. In some embodiments, MUX circuit 931 and MUX circuit 933 can be programmed to route a data packet bypassing card 251 by going through MUX circuit 931 and MUX circuit 933 without going through port P0 and port P1 of node 255a or card 251. In some embodiments, node 255a can be inactive when node 255a is bypassed. Other nodes of communication network 203 can have MUX circuits placed on each side of the node, which are not shown. When node 255a is bypassed, node 255b at slot 1 and node 255c at slot 2 are directly connected in communication network 203.

FIG. 10A illustrates data center computing system 100 including an instruction processing device (e.g., BMC 135) of a chassis for managing operations of multiple cards of a board using a hierarchical manager and one or more network managers, according to some embodiments. In some embodiments, data center computing system 100 can include a number of chassis, such as chassis 121, which can be placed on a rack. Chassis 121 can include carrier board 133. Carrier board 133 can include a card 251, a card 252, and a card 254 having their computing nodes coupled to one another by a communication network 203. In addition, card 251 can include a controller 253a, card 252 can include a controller 253b, and card 254 can include a controller 253c. BMC 135 of chassis 121 can be coupled to controller 253a, controller 253b, and controller 253c by a communication network 201. Various details for the structures and operations for BMC 135, card 251, card 252, and card 254 are described above with respect to FIGS. 9A-9B. Additional details for BMC 135, card 251, card 252, and card 254 are provided below. In some embodiments, BMC 135 is used as an example of an instruction processing device to manage operations of a set of computing devices of a chassis with one or more boards.

In some embodiments, BMC 135 can include various software components, such as application layer 171, transport layer 172, platform layer 173, and daemon 175. In some embodiments, daemon 175 can serve as a center of truth for the system state. Daemon 175 can discover controllers over each card of the boards and their corresponding signals. Daemon 175 can also build high-level constructs on top of controller signals, in which the high-level constructs can implement platform functions. In addition, as described below, daemon 175 can perform system state management, describe components in data center computing system 100 and their states and state transitions, and describe relationships between these components of data center computing system 100.

In some embodiments, daemon 175 can include a hierarchical manager 1001 operated by BMC 135. Hierarchical manager 1001 can be configured to manage operations of a set of computing devices of chassis 121. Chassis 121 includes one or more boards, such as carrier board 133, carrier board 133a, and other boards.

In some embodiments, card 251 can include controller 253a and a computing node 255a coupled by a communication link 205. Computing node 255a can include an AP 211 that can be a processing device and an I/O circuit 212 that includes port 215, port 217, and a direct memory access (DMA) engine 213. A first system, e.g., a computing node controller, 1031, can be operated by the processing device, e.g., AP 211, to control operations of the processing device. In addition, a second system, e.g., firmware and OS 231, can be operated by controller 253a to control operations of computing node 255a, such as operations by AP 211, port 215, port 217, and DMA engine 213. In some embodiments, firmware and OS 231 can refer to any software, operating system, or firmware operated by controller 253a.

Similarly, card 252 can include controller 253b and a computing node 255b coupled by a communication link 207. Computing node 255b can include an AP 221 that can be a processing device and an I/O circuit 222 that includes port 225, port 227, and a DMA engine 223. Similarly, card 254 can include controller 253c and a computing node 255c coupled by a communication link (not shown). In some embodiments, computing node 255a, computing node 255b, and computing node 255c can form communication network 203. Two computing nodes are coupled by a communication link or a link through their corresponding ports. In addition, communication network 203 can include other components, such as a switch 1051, a multiplexer 1053 controlled by a control signal 1054, multiplexer 264, and multiplexer 262, which are located between computing nodes. Control signal 1054 can select input 1055 as the output for multiplexer 1053 to bypass the output generated by port 217 of computing node 255a. In some embodiments, communication network 203 can include a ring network formed by computing nodes of the set of cards of the board. In some embodiments, each computing node of the network topology of communication network 203 can be ranked based on a position index. For example, when communication network 203 has 8 computing nodes, the 8 computing nodes can have a position index as 0, 1, 2, 3, 4, 5, 6, and 7.

In some embodiments, BMC 135 can provide an instruction and controller 253a can receive an instruction from BMC 135 through communication network 201. Computing node 255a or AP 211 can generate an operation result based on the instruction. In addition, computing node 255a or AP 211 can provide the operation result to computing node 255b through DMA engine 213, port 217, port 225, and DMA engine 223, all of which are part of communication network 203. Communication network 203 can have a network topology that includes computing node 255a, computing node 255b, computing node 255c, and any other components and links between the computing nodes.

In some embodiments, hierarchical manager 1001 can receive at least one of first data from the first system 1031 operated by the processing device (AP 211) of computing node 255a and second data from a second system, e.g., firmware and OS 231, operated by controller 253a of card 251. In addition, hierarchical manager 1001 can create a network manager 1003 operated by BMC 135 for communication network 203 on carrier board 133. Network manager 1003 can be configured to manage operations of one or more processing devices of computing nodes of communication network 203 of carrier board 133. In some embodiments, hierarchical manager 1001 can create a network manager 1003a operated by BMC 135 for a communication network including a set of computing nodes on carrier board 133a of chassis 121.

In some embodiments, the first data received by hierarchical manager 1001 can be generated by a discovery event by AP 211, which is a processing device of computing node 255a, and the second data can be generated by a discovery event by controller 253a. In some embodiments, the first data and second data can be a part of device discovery data 1023 received by hierarchical manager 1001 and stored in event queue 1005.

In some embodiments, hierarchical manager 1001 can create network manager 1003 based on receiving either the first data generated by a discovery event by AP 211 or the second data generated by a discovery event by controller 253a. Accordingly, once hierarchical manager 1001 receives a discovery signal from AP 211 or controller 253a, hierarchical manager 1001 can create network manager 1003.

In some embodiments, hierarchical manager 1001 can create network manager 1003 based on a determination that the second data generated by the discovery event by controller 253a is received by hierarchical manager 1001. Accordingly, when hierarchical manager 1001 receives the first data generated by the discovery event by AP 211 before receiving the second data generated by the discovery event by controller 253a, hierarchical manager 1001 can store the first data into a record of partial network 1002, without generating network manager 1003. Hence, the record of partial network 1002 can include information about computing node 255a. In some embodiments, a startup process using the record of partial network 1002 can be referred to as “a dirty startup process.” In some embodiments, after carrier board 133 or controller 253a is crashed, hierarchical manager 1001 can receive the first data generated by the discovery event by AP 211 before receiving the second data generated by the discovery event by controller 253a. Afterwards, hierarchical manager 1001 can create network manager 1003 based on the record of the partial network 1002 and a determination that the second data generated by the discovery event by controller 253a is received. In some embodiments, hierarchical manager 1001 and network manager 1003 cannot be operational until an execution command, such as run( ) procedure, is called by BMC 135 or other device. After creating network manager 1003, hierarchical manager 1001 can delegate coordination of communication network 203 to network manager 1003. In some embodiments, network manager 1003 can dynamically construct, attach, or detach computing nodes or processing devices to communication network 203. Accordingly, network manager 1003 can allow BMC 135 or hierarchical manager 1001 to handle partially populated carrier board 133 with one or more computing nodes broken or non-operational with minimal interruption or impact to the rest computing nodes of carrier board 133.

In some embodiments, computing node 255a can include a computing node state 1033 to indicate the operational state of computing node 255a or AP 211. In some embodiments, computing node state 1033 can indicate a connected state, a bypassed state, an off state, an on state, a booted state, a no-operation state, or a topology state, which computing node 255a or AP 211 is at. Accordingly, computing node state 1033 can indicate computing node 255a or AP 211 can participate in communication network 203 or not. When computing node state 1033 is in a booted state, a no-operation state, computing node 255a cannot participate in communication network 203. On the other hand, when computing node state 1033 is in a connected state, computing node 255a can participate in communication network 203. In some embodiments, a topology state can refer to whether computing node 255a is included in communication network 203. A topology state can have a connected state (also referred to as “a forwarding state”) or a bypassed state, which can be a subset of computing node state 1033.

In some embodiments, computing node 255a can be at a first computing node state 1033 at a first time instance and can change to a second computing node state having a different value at a second time instance. Accordingly, communication network 203 can have a first network topology 1012 at the first time instance when computing node 255a is at the first computing node state, and communication network 203 can have a second network topology 1014 at the second time instance when computing node 255a is at the second computing node state. In some embodiments, at the first time instance, the first network topology 1012 for communication network 203 can include computing node 255a when computing node 255a is in a connected state. Afterwards, at the second time instance, the second network topology 1014 for communication network 203 cannot include computing node 255a when computing node 255a is in a non-operational state or bypassed state. In some embodiments, the change of computing node state 1033 can be caused by various factors, such as a malfunction of computing node 255a. When computing node 255a changes its computing node state, computing node 255a can generate a computing node state change event signal. In some embodiments, device discovery events cannot be sufficient for creating network manager 1003. Instead, a computing node state change event signal 1021 can be received by hierarchical manager 1001 to create network manager 1003.

In some embodiments, hierarchical manager 1001 can receive a computing node state change event signal 1021 from computing node 255a. Hierarchical manager 1001 can transmit, in response to receiving the computing node state change event signal, a notification signal to network manager 1003 for network manager 1003 to monitor operations of computing node 255a. In some embodiments, computing node state change event signal 1021 can be stored in event queue 1005 of hierarchical manager 1001.

In some embodiments, communication network 203 can have the first network topology of carrier board 133 including card 251 and card 252. Network manager 1003 can receive the notification signal from hierarchical manager 1001 in response to receiving computing node state change event signal 1021 from computing node 255a. Also, network manager 1003 can store the notification signal into event buffer 1009 managed by network manager 1003. Further, network manager 1003 can update the first network topology 1012 to generate the second network topology 1014 of communication network 203 by attaching or removing a computing node of carrier board 133 from the first network topology 1012.

In some embodiments, network manager 1003 can notify controller 253a of card 251 that I/O circuit 212 of computing node 255a coupled to AP 211 is disabled. In some embodiments, controller 253a can disable I/O circuit 212. In some embodiments, controller 253a can further enable, based on a determination that computing node state 1033 includes a bypassed state, multiplexer 1053 (coupled to computing node 255a) to route traffic to bypass computing node 255a.

In some embodiments, network manager 1003 can be responsible for bypassing and inserting computing nodes into communication network 203 with minimal disruption. Each network manager created by hierarchical manager 1001, such as network manager 1003, corresponds to a physical carrier board of a chassis. In some embodiments, network manager 1003 can include up to eight references to a set of eight computing nodes in communication network 203, as well as corresponding controllers of computing nodes.

In some embodiments, network manager 1003 can implement a logic to keep the network synchronized with the rest of the system state for chassis 121. Any computing node state change event signal received by hierarchical manager 1001 can cause an update of an internal mapping of a computing node state to a connected state or a bypassed state. The new internal mapping can be enqueued into event buffer 1009 storing a buffered stream of topology updates to be applied. A task running on network manager 1003 can process the stream and apply each update according to various schedules, such as a first in first out (FIFO) schedule.

In some embodiments, network manager 1003 cannot cache or store the previous topology state (connected or bypassed) that causes no-op computing node state changes, like “off” to “on,” to trigger a topology update. Network manager 1003 can update the network topology by tearing down all links between computing nodes in communication network 203 having the first network topology 1012. In some embodiments, the first network topology 1012 can be a ring network, and the links can be high-speed USB4 links. Afterwards, network manager 1003 can rebuild the entire communication network into the second network topology 1014. As a result, network manager 1003 can avoid any explicit state tracking and caching at the cost of massive network disruptions whenever updates need to occur.

In some embodiments, a topology update of communication network 203 performs operations to change communication network 203 having the first network topology 1012 to the second network topology 1014. In some embodiments, a topology update of communication network 203 from the first network topology 1012 to the second network topology 1014 can update the computing node state of all computing nodes of communication network 203 at the same time by using a single command from network manager 1003. In some embodiments, a topology update of communication network 203 can involve running the following operations serially:
(1) Notify all computing nodes of communication network 203 using the corresponding controllers that the communication link is disconnected or unplugged. For example, hierarchical manager 1001 can notify controller 253a corresponding to computing node 255a that the communication link (which in some embodiments may be a USB4 cable) coupled to port 215 and port 217 are unplugged. In an instruction issued by hierarchical manager 1001, soc-mcu can represent a controller for a computing node, e.g., controller 253a and 253b. A port, e.g., port 215 and port 217, can be represented by “atc.” In some embodiments, communication network 203 can be a ring network including 8 cards each having a computing node coupled by USB4 cables. Accordingly, in some embodiments, hierarchical manager 1001 can issue an instruction such as:

$$soc - mcu : X / \{ 0 - 7 \} atc / \{ 0 - 1 \} / plug = 0.$$

(2) The corresponding controller can issue instructions to notify all the switches or other components of communication network 203 that the communication link is unplugged. In some embodiments, a switch can be implemented by a retimer circuit, for example, although appropriate circuitry may also be used. In some embodiments, an instruction issued by a controller 253a can be:

$$controller : X retimer / \{ 0 - 6 \} / plug = 0$$

(3) Enable or disable all bypass multiplexes as needed.

$$controller : X ring / bypass / \{ 0 - 7 \} = \{ 0 - 1 \}$$

(4) Notify all switches that the communication link is operational.

$$controller : X retimer / \{ 0 - 6 \} / plug = 1$$

(5) Notify all enabled computing nodes that the communication link is operational.

$$soc - mcu : X / \{ 0 - 7 \} atc / \{ 0 - 1 \} / plug = 1.$$

In some embodiments, network manager 1003 can include a network node state 1037 including node state parameters, such as a topology state, a bypass mux enabled state, a traffic flow through state, and a port enabled state for a port of the first computing node coupled to the processing device. In some embodiments, network node state 1037 can also be stored in computing node 255a. Network node state 1037 can include more information than computing node state 1033, which can facilitate more efficient operations to update the network topology for communication network 203. Network manager 1003 can select an individual computing node, e.g., computing node 255a, to transition into or out of the network topology in a series of operations called a path, which will be explained below. Updating the network topology based on individual computing node operations can simplify the operational complexity for updating the network topology in response to the computing condition changes in any individual computing nodes.

In some embodiments, network node state 1037 can include a network node state indicator 1035, which can be a multiple-bit string to represent the bypass mux enabled state, the traffic flow through state, and the port enabled state. Moreover, a computing node can include a media access control address (MAC) address. For example, computing node 255 can include a MAC address 1045 that can identify computing node 255a from other computing nodes.

In some embodiments, network node state indicator 1035 can have a first bit of the multiple-bit string to indicate if the bypass multiplexer should be enabled. For computing node 255a, the first bit of network node state indicator 1035 can indicate the physical state of multiplexer 1053 along the communication link in communication network 203. When the first bit is true, multiplexer 1053 is enabled and traffic passing through computing node 255a can flow into computing node 255a. When false, multiplexer 1053 is disabled and traffic passing through computing node 255a will flow around computing node 255a without entering computing node 255a.

In some embodiments, network node state indicator 1035 can have a second bit of the multiple-bit string to indicate if traffic should be routed through computing node 255a at all. When true, traffic can flow through computing node 255a to enter computing node 255a on either side. When false, traffic cannot flow through computing node 255a. This property can be different than the first bit of network node state indicator 1035 that describes whether traffic flowing through computing node 255a will pass through computing node 255a. On the other hand, the second bit of network node state indicator 1035 indicates whether any traffic should be routed through computing node 255a at all. In some embodiments, only the first bit or the second bit of network node state indicator 1035 can be available.

In some embodiments, network node state indicator 1035 can further include two bits to indicate whether port 215 and port 217 of computing node 255a are in a “plug” or “connected” state. Network manager 1003 can enable or disable a port of computing node 255a by triggering a communication link, e.g., USB4 cable, plug or unplug event via controller 253a. When true, computing node 255a is electrically connected to switch 1051, e.g., a retimer or other retiming circuit or network interface circuit (NIC). When false, computing node 255a is disconnected. Port 215 and port 217 can have a numeral label. Port 0 refers to port 215 or port 217 that is connected to the communication link towards the lower-valued (clockwise) computing node based on the position index of the computing nodes. Similarly, port 1 refers to a port of port 215 and port 217 that is connected to the communication link towards the higher-valued (counter-clockwise) computing node based on the position index of the computing nodes.

In some embodiments, network node state indicator 1035 can represent a network node state according to Table 1.

TABLE 1

| | Positive | Negative |
|---|---|---|
| Multiplexer | Y (yes) | N (no) |
| Allow traffic flow | T (through) | A (away) |
| Port 0 | E (enabled) | D (disabled) |
| Port 1 | E (enabled) | D (disabled) |

In some embodiments, based on Table 1, when network node state indicator 1035 has a string “YAED,” network node state indicator 1035 indicates that computing node 255a is bypassed, traffic is routing away from computing node 255a, port 215 is enabled while port 217 is disabled. In some embodiments, there can be other ways to represent the same configuration for string “YAED.”

In some embodiments, the character “X” can be used in any position to indicate a “don't care” or “any value.” The character “X” can describe multiple patterns of states (e.g. “XXEE” can refer to any node with both ports enabled).

In some embodiments, one or more bit strings of network node state indicator 1035 can be invalid such that they can be impossible to configure or inefficient to use for computing node 255a. When network node state indicator 1035 has the value “NTDD,” network node state indicator 1035 would indicate an invalid state because there are no circumstances that a traffic can be routed through as indicated by “T” while both ports are disabled as indicated by “DD.” In some embodiments, network manager 1003 can perform operations to determine invalidate states for network node state indicator 1035.

In some embodiments, network node state indicator 1035 can indicated various properties of computing node 255a, based on observed, gathered, and debug properties of computing node 255a. There can be two topology states represented by network node state indicator 1035, “NTEE” (forwarding) or “YTDD” (bypassed). When computing node 255a is “booted” indicating a state where computing node 255a is on and connected to communication network 203 and the MAC address of computing node 255a is known, the topology state is “NTEE,” otherwise network node state indicator 1035 can be “YTDD.” In some embodiments, computing node 255a can have separate parameters to indicate its topology state corresponding to network node state indicator 1035. In some embodiments, computing node 255a can be in a first topology state at a first time instance as indicated by network node state indicator 1035 at the first time instance, and in a second topology state at a second time instance as indicated by network node state indicator 1035 at the second time instance.

In some embodiments, network node state 1037 can include computing node state 1033 as a component. In some embodiments, network node state 1037 and computing node state 1033 can be stored as two separate parameters. In some embodiments, computing node state 1033 can indicate information about the state of the processing device, e.g., AP 211. In comparison, network node state 1037 can include more information, such as information about port 215, port 217, and information about connection with multiplexer 1053 or switch 1051, which are coupled to computing node 255a.

In some embodiments, network manager 1003 can include a network state 1011 of communication network 203 determined based on a network node state for each computing node of the network topology of communication network 203. In some embodiments, network state 1011 can include an array of network node states or network node state indicators for each computing node of communication network 203. Initially, network state 1011 can include a nil element in the array for each computing node of carrier board 133. Nil elements represent devices that have not been discovered, inoperable, or cannot be physically present in the chassis. Once a computing node is discovered, the nil element in the array can be replaced with a proper network node state of the computing node. The network node state of a computing node can store the current network node state. In addition, network manager 1003 can transition computing nodes of communication network 203 into their target topology state. In some embodiments, not all possible combinations of network state 1011 represent desirable topologies. For example, computing nodes in position 0 and 1 can have the topology states “NXXE” and “NXDX,” respectively. These states can be individually valid but in combination they form a topology where port 1 of node 0 is enabled and port 0 of node 1 is disabled; such a combination would result in an inoperable communication link between computing node 0 and computing node 1. Accordingly, such a network state 1011 includes invalid state for communication network 203. Network manager 1003 can perform operations to check network state 1011 is valid or not.

In addition, network manager 1003 can communicate with event queue 1005 configured to store an event signal received from a computing node of the network topology of communication network 203. Furthermore, network manager 1003 can include a network state machine (not shown) operated by network manager 1003 and configured to update network state 1011 to generate a next network state 1013 based on one or more event signals received from one or more computing nodes of the network topology of communication network 203. Moreover, network manager 1003 can further include an event buffer 1009, e.g., a mailbox, configured to store event signals received from the one or more computing nodes while network state machine or network manager 1003 performs operations to update network state 1011. In some embodiments, to update network state 1011, network state machine or network manager 1003 can transmit a remote procedure call (RPC) 1025 to a processing device, e.g., AP 211 of computing node 255a, to perform an operation.

In some embodiments, network node state 1037 of computing node 255a is a current network node state. To update network state 1011, network manager 1003 can transmit RPC 1025 to AP 211 or controller 253a of computing node 255a to cause computing node 255a to transfer the current network node state 1037 to a target network node state 1038 by going through a path 1040 of network node states of computing node 255a. Path 1040 of network node states of computing node 255a can include points having the current network node state 1037 as a starting point of path 1040, target network node state 1038 as an ending point of path 1040, and one or more points including one or more intermediate network node states, such as a next network node state 1039. In some embodiments, a next network node state 1039 of path 1040 differs from another point, e.g., another next network node state, of path 1040 adjacent to the intermediate network node state by one or two node state parameters. For example, path 1040 can include a starting point network node state represented as YTDD, which is the network node state indicator 1035 for node 3 at time t0. Path 1040 can further include an ending point network node state represented as NTEE, which is the network node state indicator 1035 for node 3 at time t6. Furthermore, path 1040 can include a sequence of network node state indicators listed as {YTDD, YADD, YADD, NADD, NAEE, NTEE, NTEE}, which represents the network node state of node 3 at time instance t0, t1, t2, t3, t4, t5, and t6. To change from the starting point YTDD at time instance to to an intermediate network node state indicator YADD at time instance t1, a RPC 1025 can be issued to node 3 to perform the operations to switch the network node state indicator from YTDD at time instance t0 to YADD at time instance t1.

In some embodiments, network manager 1003 can handle an array of accumulated inputs that are event signals. An input can update or change network state 1011 of communication network 203 and trigger further operations to be performed by computing notes of communication network 203. In some embodiments, if compute node state 1033 changes to “booted” and the MAC address of computing node 255a is unknown, network manager 1003 can generate a RPC, e.g., computeNode MACAddressFetch, to be transmitted to AP 211 or controller 253a to request the MAC address of computing node 255a. If the RPC completes successfully, an event signal, e.g., computeNodeMACAddressFetched, can be sent to event buffer 1009 with a MAC address of computing node 255a.

In some embodiments, RPC 1025 is a first remote procedure call, and to update network state 1011, network manager 1003 can further transmit a second remote procedure call 1027 to a processing device AP 221 or controller 253b of a partner computing node, e.g., computing node 255b, of computing node 255a on carrier board 133 to cause computing node 255b to transfer from a first network node state 1047 to a second network node state 1049 of computing node 255b. Network node state 1047 and network node state 1049 are shown as stored in computing node 255b. In some embodiments, network node state 1047 and network node state 1049 can be stored in network manager 1003 as well. The first network node state 1047 and the second network node state 1049 can be determined based on path 1040 of network node states of computing node 255a. In some embodiments, computing node 255b is a partner computing node of computing node 255a when there is a direct communication link between computing node 255b and computing node 255a without going through another computing node. There can be other components, such as multiplexer 1053 and switch 1051, included in the communication link between computing node 255b and computing node 255a, but there is no other communication node between computing node 255b and computing node 255a.

In some embodiments, computing node 255a can be in a first topology state 1041 at a first time instance corresponding to network state 1011 and a second topology state 1043 at a second time instance corresponding to next network state 1013. Due to physical conditions, such as hardware or software condition changes, computing node 255a can change from the first topology state 1041 to the second topology state 1043 at the second time instance. In some embodiments, the first topology state 1041 can be a current topology state, and the second topology state 1043 can be a target topology state. In some embodiments, the first topology state 1041 can have a first network node state indicator YADD, and the second topology state 1043 can have a second network node state indicator NTEE.

In some embodiments, for a computing node, e.g., computing node 255a, if a current topology state of the computing node does not match its target topology state, network manager 1003 can generate an instruction, for example, nextStateApply, to be transmitted to each computing node to update the topology state of each computing node. The instruction can include a next topology state for every computing node from the appropriate path.

In some embodiments, network manager 1003 can update the next topology state for every computing node by setting each bit of the network node state indicator for the computing node. A bit of the network node state indicator of a computing node can be determined, changed, or set by the controller of the computing node, or by the processing device of the computing node using a RPC. Among all the computing nodes, every RPC runs completely in parallel without any sequencing. When walking operations of a path, each operation modifies a small subset of topology states, resulting in redundant RPCs on each application. In some embodiments, there can be redundant RPCs shared among multiple computing nodes. Reducing the number of RPCs is possible by caching the values set on each operation and invalidating the caches when the RPC's target device changes state.

In some embodiments, when updating the topology state of a computing node, a path describes the series of operations needed to transition a computing node into and out of the communication network. Paths are invertible and each operation is an atomic time-independent state. The first operation to determine a path can include selecting a transitioning node. The selection of the transitioning node depends on the network topology of communication network 203.

In some embodiments, selection of the transitioning node for updating the topology state of a computing node can follow the following process. If a transitioning node has been selected by network manager 1003, then the selection is maintained. Otherwise, network manager 1003 can select a computing node in the network topology for communication network 203 having the lowest position index in the network topology. For the selected transitioning node, network manager 1003 can determine the next topology state of the transitioning node. In some embodiments, the next topology state can be different from the target topology state. The next topology state indicates one operation in a path from the current topology state towards the target topology state of the transitioning node. The path taken by the node can be a function of the number of partner nodes that participate in the network topology for communication network 203. In a network topology for a communication network, a second computing node is a partner node of a first computing node when pairs of computing nodes that have “NXXX” (non-bypassed) network node state with any number of “YXXX” (bypassed) nodes between them.

In some embodiments, the simplest path is used when the transitioning node has no partners. This is the only case where the next topology state of the transitioning node is always its target topology state. Table 2 shows the details on the path for the transitioning node. As shown in column 2 of Table 2, all ring nodes have a network node state indicator “YTDD” (bypassed topology state) and node 3 can be moved to a target network node state indicator “NTEE” (forwarding topology state). Node 0, 1, 2, 4, 5, 6, and 7 maintain network node state indicator “YTDD” at time instance t0, t1, t2. For node 3, the following path is shown in the row for node 3.

Operations, where t0, t1, t2 are discrete time sequence:
t0: initial state.
t1: node 3 is set to its target topology state.
t2: steady state.

TABLE 2

| | Target | | | |
|---|---|---|---|---|
| | topology | | | |
| Node | state | t0 | t1 | t2 |
| 0 | YTDD | | | |
| 1 | YTDD | | | |
| 2 | YTDD | | | |
| 3 | NTEE | YTDD | NTEE | NTEE |
| 4 | YTDD | | | |
| 5 | YTDD | | | |
| 6 | YTDD | | | |
| 7 | YTDD | | | |

In some embodiments, node 3 can have one partner, indicating there is only one other node in the communication network, which can be a one-partner path. Table 3 shows the details on the path for node 3 and one partner node, node 4. As shown in column 2 of Table 3, all computing nodes, node 0, 1, 2, 5, 6, and 7, have a network node state indicator as “YTDD,” except node 4 which has a network node state indicator as “NTEE.” Node 0, 1, 2, 5, 6, and 7 maintain network node state indicator “YTDD” at time instance t0, t1, t2, t3, t4, t5, and t6. For node 3, the following path is shown in the row for node 3. Node 3 should be moved from a topology state having a network node state indicator as “YTDD” at time instance t0 to a target topology state having a network node state indicator as “NTEE” at time instance t6, following the operations below:

Operations, where t0, t1, t2, t3, t4, t5, t6 are discrete time sequence:
t0: initial state.
t1: network traffic is routed away from node 3, resulting in traffic from node 4 flowing in the reverse direction.
t2: the communication link through node 3 is terminated by disabling port 0 on node 4.
t3: the bypass multiplexer under node 3 is disabled.
t4: both ports of node 3 and port 0 of node 4 are enabled in order to create communication links between the nodes 3 and 4.
t5: network traffic is routed through node 3, resulting in traffic from node 3 and node 4 flowing in the forward direction.
t6: steady state.

TABLE 3

| | Target | | | | | | | |
|---|---|---|---|---|---|---|---|---|
| | topology | | | | | | | |
| Node | state | t0 | t1 | t2 | t3 | t4 | t5 | t6 |
| 0 | YTDD | | | | | | | |
| 1 | YTDD | | | | | | | |
| 2 | YTDD | | | | | | | |
| 3 | NTEE | YTDD | YADD | YADD | NADD | NAEE | NTEE | NTEE |
| 4 | NTEE | NTEE | NTEE | NTDE | NTDE | NTEE | NTEE | NTEE |
| 5 | YTDD | | | | | | | |
| 6 | YTDD | | | | | | | |
| 7 | YTDD | | | | | | | |

In some embodiments, the path can include two partner nodes. Accordingly, there are at least two other computing nodes in the communication network. Table 4 shows the details on the path for node 3 and two partner nodes, nodes 2 and 5. All computing nodes have a network node state indicator as “NTEE,” except node 4 which has network node state indicator as “YTDD.” Node 0, 1, 2, 4, 6, and 7 maintain network node state indicator “NTEE” or “YTDD” at time instance t0, t1, t2, t3, t4, t5, and t6. Node 3 can be moved from a topology state having a network node state indicator as “YTDD” at time instance t0 to a target topology state having a network node state indicator as “NTEE” at time instance t6, following the operations below:

Operations, where t0, t1, t2, t3, t4, t5, t6 are discrete time sequence:
t0: initial state.
t1: network traffic is routed away from node 3, resulting in traffic destined to nodes node 5 through node 7 flowing in the reverse direction.
t2: the communication link through node 3 is terminated by disabling port 1 of node 2 and port 0 on node 5.
t3: the bypass multiplexer under node 3 is disabled.
t4: port 1 on node 2, both ports on node 3, and port 0 on node 4 are enabled in order to create communication links between the nodes.
t5: network traffic is routed through node 3, resulting in traffic from all nodes flowing in the forward direction.
t6: steady state.

TABLE 4

| | Target | | | | | | | |
|---|---|---|---|---|---|---|---|---|
| | topology | | | | | | | |
| Node | state | t0 | t1 | t2 | t3 | t4 | t5 | t6 |
| 0 | NTEE | | | | | | | |
| 1 | NTEE | | | | | | | |
| 2 | NTEE | NTEE | NTEE | NTED | NTED | NTEE | NTEE | NTEE |
| 3 | NTEE | YTDD | YADD | YADD | NADD | NAEE | NTEE | NTEE |
| 4 | YTDD | | | | | | | |
| 5 | NTEE | NTEE | NTEE | NTDE | NTDE | NTEE | NTEE | NTEE |
| 6 | NTEE | | | | | | | |
| 7 | NTEE | | | | | | | |

FIG. 10B illustrates a flowchart of process 1090 performed by a hierarchical manager and one or more network managers operated by an instruction processing device of a chassis of a data center computing system, according to some embodiments. For illustrative purposes, the operations illustrated in process 1090 will be described with reference to BMC 135 of chassis 121 as shown in FIG. 10A. Other representations of systems for performing operations by a hierarchical manager and one or more network managers are within the scope of the present disclosure. Also, additional operations can be performed between various operations of process 1090 and can be omitted merely for clarity and ease of description. The additional operations can be provided before, during, and/or after process 1090, in which one or more of these additional operations are briefly described herein. Moreover, not all operations can be needed to perform the disclosure provided herein. Additionally, some of the operations can be performed simultaneously or in a different order than shown in FIG. 10B. In some embodiments, one or more other operations can be performed in addition to or in place of the presently-described operations.

At operation 1091, process 1090 can include receiving, by a hierarchical manager operated by an instruction processing device, at least one of first data from a first system operated by a processing device of a first computing node and second data from a second system operated by a controller coupled to the first computing node. For example, hierarchical manager 1001 can receive at least one of first data from the first system 1031 operated by the processing device (AP 211) of computing node 255a and second data from a second system, e.g., firmware and OS 231, operated by controller 253a of card 251.

At operation 1093, process 1090 can include creating, based on the at least one of the first data and the second data and by the hierarchical manager, a network manager operated by the instruction processing device for the second communication network. For example, hierarchical manager 1001 can create network manager 1003 based on receiving either the first data generated by a discovery event by AP 211, or the second data generated by a discovery event by controller 253a.

At operation 1095, process 1090 can include managing, by the network manager, operations of one or more processing devices of computing nodes of the second communication network. For example, network manager 1003 can manage operations of one or more processing devices of computing nodes of communication network 203. In some embodiments, network manager 1003 can dynamically construct, attach, or detach computing nodes or processing devices to communication network 203. Accordingly, network manager 1003 can allow BMC 135 or hierarchical manager 1001 to gracefully handle partially populated carrier board 133 with one or more computing nodes broken or non-operational.

FIGS. 11A-11C illustrate operations of a ring communication network on carrier board 133 of chassis 121 of a data center computing system 100, according to some embodiments. Detailed descriptions for a ring communication network on carrier board 133 can be examples of operations described previously. A ring communication network can be an example of communication network 203 having a ring topology. While a ring topology is shown as an example, other topologies may be used including a mesh topology or a star topology. In such other topologies, the connections between cards 305a-305h may be in different configurations, but will logically behave in a similar manner as the ring topology described herein as described in more detail in FIG. 11C.

In some embodiments, as shown in FIG. 11A, carrier board 133 can include multiple cards, such as a card 301a, a card 301b, a card 301c, a card 301d, a card 301e, a card 301f, a card 301g, and a card 301h. Card 301a, card 301b, card 301c, card 301d, card 301e, card 301f, card 301g, and card 301h can be examples of card 251, card 252, or card 254 shown in FIG. 9A. Accordingly, each card can include a computing node and a controller. In addition, a multiplexer can be placed between any two cards, such as multiplexer 262 as shown in FIG. 9A. The computing node of each card can be coupled to one another by a communication network 304 having a ring topology connecting computing node 305a of card 301a, computing node 305b of card 301b, computing node 305c of card 301c, computing node 305d of card 301d, computing node 305e of card 301e, computing node 305f of card 301f, computing node 305g of card 301g, and computing node 305h of card 301h.

BMC 135 and the controller of each card can be coupled to one another to form a different communication network (not shown). Communication network 304 can further include a NIC 303a and a NIC 303b that can route traffic in and out of carrier board 133. In some embodiments, communication network 304 can have USB or USB4 links, where a link coupling two computing nodes of two cards is a USB or a USB4 link.

In some embodiments, each computing node, such as computing node 305a, can be responsible for forwarding traffic destined for a computing node on the other side along the ring topology of communication network 304. Computing node 305a is assigned as a uplink node coupled to NIC 303a, which can actively route packets from other computing nodes of the ring to NIC 303a and NIC 303b, which can be a high-speed Ethernet NIC.

In some embodiments, BMC 135 can discover the topology of communication network 304 formed by the computing nodes of the cards during power-on, by exploring the internal management layer 2 connection of communication network 304 and identifying boards of communication network 304. In some embodiments, the layer 2 connection of communication network 304 can include an Ethernet tree. In addition, BMC 135 can send location-specific configuration information to each card, the controller of each card, and the computing node of each card. Accordingly, BMC 135 can inform the computing node of each card of the configuration it can use, saving the need for a complex discovery procedure by each card.

In some embodiments, when a card or a computing node of a card fails to participate in the ring of communication network 304, the ring breaks into smaller chains (e.g., two smaller chains). To improve resilience and allow for a graceful failure, every card can be coupled to a pair of multiplexers to route data traffic in different directions. Examples of the pair of multiplexers can be multiplexer 262 and multiplexer 264, which are coupled to card 254. In some embodiments, multiplexer 262 and multiplexer 264 can each be a USB4 analog multiplexer. BMC 135 can program the links between the two multiplexers to bypass card 254. Communication network 304 can still function even when, for example, 6 cards of the total 8 cards are bypassed.

In some embodiments, a card or a controller of a card can report to BMC 135 link-down and timeout events, which initiates a sequence of actions to bypass a broken or faulty card in the ring of communication network 304. BMC 135 can receive a report of a broken computing node or a broken card. After, BMC 135 can inform all other cards on carrier board 133 to route traffic the long path around the ring having more hops, where the more direct path having fewer hops is broken. In addition, BMC 135 can disable all links (including re-timers and multiplexers) for the broken computing node and program the multiplexers around the broken computing node to bypass the broken card. In addition, communication links are enabled to pass through the multiplexers, and peer computing nodes on either side of the broken card can line up with each other to form two different sub-chains of communication network 304. In some embodiments, the above sequence of actions can be applied to any event requiring reconfiguration of communication network 304. For example, BMC 135 can issue an instruction, based on quality of service information for carrier board 133, to reconfigure communication network 304.

In some embodiments, as shown in FIG. 11B, card 301c can be a faulty or broken card. Hence, card 301c can go offline and not participate in traffic flows of communication network 304. Accordingly, the ring for communication network 304 is broken. BMC 135 can reconfigure the multiplexers in bypassing circuit 312 so that card 301c is bypassed. Communication link 304a from 301c to 301d and communication link 304b from 301c to 301b on both sides of card 301c are disabled. Instead, communication link 304c from card 301b to bypassing circuit 312 is enabled. Similarly, communication link 304d from card 301d to bypassing circuit 312 is enabled. Hence, without going through card 301c, traffic can pass through card 301b, bypassing circuit 312, and card 301d.

In some embodiments, BMC 135 can reroute traffic. BMC 135 can assign card 301a to be an uplink card coupled to NIC 303a. In addition, BMC 135 can request traffic from cards 301b, 301d, and 301e destined for NIC 303a to travel in a clockwise direction. Hence, card 301b can send traffic to NIC 303a via card 301a, while card 301e can send traffic to NIC 303a through cards 301d, 301b, and 301a, with a total of 4 hops. In addition, BMC 135 can request traffic from cards 301f, 301g, and 301h destined for NIC 303a to travel in a counterclockwise direction. Hence, card 301f can send traffic to NIC 303a via cards 301g and 301h, with a total of 3 hops.

In some embodiments, BMC 135 can receive a report that card 301c is not forwarding traffic. BMC 135 can begin the bypass reconfiguration sequence, which includes closing communication link 304a and communication link 304b, switching the multiplexer in bypassing circuit 312, and turning on communication link 304c and communication link 304d. In addition, BMC 135 can request card 301d and card 301e to route traffic destined for NIC 303a in a clockwise direction. Similarly, BMC 135 can request all other cards to route traffic destined for NIC 303a via a path having the fewest hops, but avoiding faulty card 301c. In some embodiments, when card 301c is available for routing traffic in communication network 304, BMC 135 can request cards 301a, 301b, 301c, 301d, 301e, 301f, 301g, and 301h to route traffic via a path having the fewest number of hops, where the path can include card 301c.

In some embodiments, BMC 135 can change the NIC uplink card. Either card 301a or card 301h can be the uplink card for NIC 303a, since card 301a and card 301h are physically connected to NIC 303a. If card 301a is currently the NIC uplink card and is unable to forward traffic, BMC 135 can receive a report that card 301a is not forwarding traffic. BMC 135 can reset NIC 303a and card 301h so that card 301h can become the NIC uplink card. BMC 135 can further request card 301b, card 301c, card 301d, card 301e, card 301f, and card 301g to route traffic in communication network 304 by a path having the fewest hops, while avoiding faulty card 301a. In some embodiments, the bypassing circuit for card 301a can be enabled and configured to route traffic, and traffic can be routed to NIC 303a, bypassing card 301a through the bypassing circuit.

FIG. 11C illustrates a ring communication network 314, which can be communication network 203 on carrier board 133, according to some embodiments. Ring communication network 314 has 4 cards instead of the 8 cards for ring communication network 304 shown in FIGS. 11A-11B. When communication network 203 has a ring topology including a set of cards or nodes forming a ring, the set of cards can have multiple cards, such as 3 cards, 4 cards, and more. Ring communication network 314 is an example of communication network 203, which can have a tree, a star, a mesh topology, or other suitable topology.

In some embodiments, ring communication network 314 can include a set of cards, where each card is configured to be addressed by a MAC address and a slot identifier that uniquely identifies the card on carrier board 133. Ring communication network 314 can include a card with slot identifier as slot 0, which can be referred to as “a slot 0 card.” Similarly, ring communication network 314 can further include a slot 1 card, a slot 2 card, and a slot 3 card. In some embodiments, when data communication is discussed, the function of the card is primarily performed by the computing node of the card. Accordingly, slot 0 card can be referred to as “a slot 0 node,” both of which can be used interchangeably depending on the context. In some embodiments, slot 0 card has a first MAC address, slot 1 card has a second MAC address, slot 2 card has a third MAC address, and slot 3 card has a fourth MAC address. The first MAC address, the second MAC address, the third MAC address, and the fourth MAC address are different from one another, according to some embodiments.

In some embodiments, carrier board 133 can further include a card with a slot identifier 4, which can be referred to as “a slot 4 card.” Slot 4 card can be separate from ring communication network 314. Ring communication network 314 can be formed by slot 0 card, slot 1 card, slot 2 card, and slot 3 card, without slot 4 card.

In some embodiments, carrier board 133 can further include a network switching device 137 that is coupled to ring communication network 314. Network switching device 137 can have a slot identifier, such as slot 5 as shown in FIG. 11C. Data traffic or data packets can be routed to a destination off ring communication network 314 to a computing device located in chassis 121, which may be located in another board of the chassis. In some embodiments, network switching device 137 may be coupled to an outbound node or an outbound card for carrier board 133 or ring communication network 314. The outbound node or card of ring communication network 314 can be a node or card of ring communication network 314, such as slot 0 card, which is directly coupled to network switching device 137. In some embodiments, ring communication network 314 does not operate in isolation, but is connected to a larger network through the outbound node. Network switching device 137 can transmit traffic from ring communication network 314 to another network and also transmit traffic back from other networks to ring communication network 314. When a packet with a destination outside of ring communication network 314 is sent through any node of ring communication network 314, the firmware or the software of the node can send the packet to the outbound node, e.g., network switching device 137.

In some embodiments, a card of ring communication network 314 can have a left neighbor card coupled to the card at one side and a right neighbor card coupled to the card at another side along the ring topology of ring communication network 314. For example, slot 0 card can be coupled to a left neighbor card, which can be slot 3 card. In addition, slot 0 card can be coupled to a right neighbor card, which can be slot 1 card. The direction of right or left is relative and the direction can be reversed. For example, slot 1 card can be the left neighbor card and slot 3 card can be the right neighbor card for slot 0 card. Accordingly, slot 0 card can communicate in two different directions: one direction to slot 1 card and another direction to slot 3 card. The ability to communicate in two directions can provide redundancy and fault tolerance capability in case one of the communication directions fails for slot 0 card.

In some embodiments, there can be many different ways to assign the slot identifier for the cards of carrier board 133. For ring communication network 314, the slot identifiers are assigned as slot 0, 1, 2, and 3. In some embodiments, the slot identifiers can be assigned as slot 1, 2, 3, and 4. Other assignments for the slot identifier are possible. In some embodiments, a card of ring communication network 314 can have a slot identifier, the left neighbor card can have a left slot identifier, and the right neighbor card can have a right slot identifier. In some embodiments, a difference between the slot identifier for the card and the left slot identifier can be 1. Similarly, a difference between the slot identifier for the first card and the right slot identifier can be 1.

In some embodiments, a card or a node can have two ports as shown in FIG. 9C. For example, slot 0 card can have a port P0 and a port P1. Each of other cards can have a port P0 and a port P1. In some embodiments, two cards are coupled together by a communication link through one port of each card. For example, port P1 of slot 0 card is coupled to port P0 of slot 1 card by a communication link that is a part of ring communication network 314. In some embodiments, there can be a MUX circuit between port P1 of slot 0 card and port P0 of slot 1 card, which is not shown.

In some embodiments, each card, such as slot 0 card, slot 1 card, slot 2 card, slot 3 card, and slot 4 card of carrier board 133, can be coupled to BMC 135. BMC 135 can be configured to perform various functions described above, for example, to discover the ring topology for ring communication network 314.

FIGS. 12A-12L illustrate further operations of various ring communication networks on a board, such as carrier board 133, of a chassis of a data center computing system, according to some embodiments.

FIG. 12A shows ring communication network 1214 including 8 nodes or cards, which can be identified as slot 0 card, slot 1 card, slot 2 card, slot 3 card, slot 4 card, slot 5 card, slot 6 card, and slot 7 card. Alternatively, the corresponding card can be referred to as slot 0 node, slot 1 node, slot 2 node, slot 3 node, slot 4 node, slot 5 node, slot 6 node, and slot 7 node if functions of data communications are performed by the computing node of a card. Each card of ring communication network 1214 can perform functions similar to the cards of ring communication network 314. In addition, carrier board 133 can further include network switching device 137 that is coupled to ring communication network 1214 to send data packets off ring communication network 1214 or to receive data packets sent to ring communication network 1214 from other devices in another carrier board. An outbound card can be coupled to network switching device 137.

In some embodiments, a card of ring communication network 1214 can have a slot identifier, the left neighbor card can have a left slot identifier, and the right neighbor card can have a right slot identifier. In some embodiments, a difference between the slot identifier for the card and the left slot identifier can be 1. Similarly, a difference between the slot identifier for the first card and the right slot identifier can be 1. However, slot 0 card can have slot 7 card as a neighbor card with a difference between the slot identifiers larger than 1.

In some embodiments, each card in ring communication network 1214 can be addressable by a MAC address. However, ring communication network 1214 can use a slot identifier of a card to route the data packets. To facilitate the routing of data packets, a table is maintained for a MAC address of a card and its corresponding slot identifier, as shown below. In some embodiments, the MAC address and slot identifier correspondence table can be configured before traffic can be transmitted to other cards in the ring communication network.

### Example MAC Address and Slot Identifier Correspondence Table

| MAC Address | Slot ID |
|---|---|
| F2:E2:D3:C4:B5:A6 | 3 |
| F2:E2:D3:C9:BA:AB | 7 |
| F2:E2:D3:BB:CC:DD | 0 |
| F2:E2:D3:01:01:03 | 5 |
| F2:E2:D3:9A:8B:7C | 4 |
| F2:E2:D3:C3:D4:E5 | 1 |
| F2:E2:D3:BA:D0:0D | 2 |
| F2:E2:D3:DE:AD:DD | 6 |

FIG. 12B shows ring communication network 1214 having multiplexer circuits placed between neighboring cards. By programming these multiplexers, one or multiple cards can be bypassed, such that they are no longer part of the ring communication network. A multiplexer circuit 1201 is placed between slot 6 card and slot 7 card, and a multiplexer circuit 1203 is placed between slot 6 card and slot 5 card. Other multiplexer circuits can be placed between any two neighbor cards, which are not shown. Multiplexer circuit 1203 and multiplexer circuit 1201 can be controlled by BMC 135 through communication network 201.

In some embodiments, a communication link 1202 couples slot 6 card and multiplexer circuit 1201, while a communication link 1204 couples slot 6 card and multiplexer circuit 1203. Communication link 1202 and communication link 1204 are disabled, which is shown as dashed lines, to indicate that no data flows from slot 6 card to any of the multiplexer circuits. In addition, a communication link 1205 between multiplexer circuit 1201 and multiplexer circuit 1203 can be enabled and active. Accordingly, slot 6 card is bypassed and does not participate in ring communication network 1214 at the time instance shown in FIG. 12B. In some embodiments, slot 6 card can be bypassed due to being offline, inactive, or faulty. Data packets can be routed from slot 5 card to slot 7 card through multiplexer circuit 1203 and multiplexer circuit 1201 without going through slot 6 card. Hence, slot 5 card is coupled to slot 4 card and slot 7 card, while slot 7 card is coupled to slot 1 card and slot 5 card. In some embodiments, all other cards instead of slot 6 card have the multiplexer circuits coupled to them to be configured such that they are not bypassed.

FIG. 12C shows ring communication network 1214 including 8 nodes or cards, slot 0 card, slot 1 card, slot 2 card, slot 3 card, slot 4 card, slot 5 card, slot 6 card, and slot 7 card, which are the same as explained above in FIG. 12A. In some embodiments, each card of ring communication network 1214 can maintain a routing table that is used to determine which port of the card to be used to transmit a data packet out of the card. In some embodiments, the routing table can be indexed by a slot identifier. Hence, slot 0 card can store a routing table 0, slot 1 card can store a routing table 1, and other routing tables can be similarly labelled as shown. In some embodiments, the routing table can be stored in the I/O circuit of the card. The I/O circuit of the card can be configured to determine whether to use port P0 or port P1 of the card to send the data packet from the card.

In some embodiments, the routing table can store one or more routing policies, where each entry of the routing table includes a routing policy. A card can determine the operations to be performed to route a data packet based on a slot identifier of the source address of the data packet and a slot identifier of the destination address of the data packet. The I/O circuit of the card can determine whether to use port P0 or port P1 of the card based on the routing policy. In some embodiments, a routing policy can be labeled as “Normal,” “Reverse,” and “Drop”, with the meaning described in the table below. As indicated in Routing Policy Table, the “Normal” routing policy and the “Reverse” routing policy can transmit a data packet in an opposite direction.

### Example Routing Policy Table

| Policy | Meaning |
|---|---|
| Normal | If destination slot identifier < slot identifier of the current |
| | card, transmit the data packet through port 0 of the current |
| | card, otherwise, transmit the data packet through port 1 of the |
| | current card. |
| Reverse | If destination slot identifier < slot identifier of the current |
| | card, transmit the data packet through port 0 of the current card; |
| | otherwise, transmit the data packet through port 1 of the current |
| | card. |
| Drop | The destination cannot receive packets, do not transmit. |

In some embodiments, a routing table in a card can store a set of routing policies corresponding to the set of cards of ring communication network 1214. An entry of the routing table can store a routing policy for a card of ring communication network 1214. By default, the routing table can have “Drop” policy for all entries. Accordingly, no traffic can be transmitted when a card stores the default routing table including “Drop” policy for all entries. The routing table can be configured to change from the default “Drop” policy into a routing policy to control the traffic to be transmitted. Each card can have its own routing table that determines how to send traffic or data packets to any other cards in ring communication network 1214.

In some embodiments, every card participating in ring communication network 1214. Hence, ring communication network 1214 includes slot 0 card, slot 1 card, slot 2 card, slot 3 card, slot 4 card, slot 5 card, slot 6 card, and slot 7 card. Accordingly, a routing table of any card of ring communication network 1214 can have the policy “Normal” for all slot identifiers, as shown in the following exemplary Nominal Routing Table, which is saved in routing table 0, routing table 1, . . . , and routing table 7.

### Example Nominal Routing Table

| Slot ID | Policy |
|---|---|
| 0 | Normal |
| 1 | Normal |
| 2 | Normal |
| 3 | Normal |
| 4 | Normal |
| 5 | Normal |
| 6 | Normal |
| 7 | Normal |

FIG. 12D shows a communication path 1221 to route traffic between slot 0 card and slot 7 card for ring communication network 1214 as configured in FIG. 12C, where each card can store the Nominal Routing Table shown above. The traffic route of a data packet is determined based on the Nominal Routing Table saved at each card.

In some embodiments, ring communication network 1214 including 8 cards as slot 0 card, slot 1 card, slot 2 card, slot 3 card, slot 4 card, slot 5 card, slot 6 card, and slot 7 card. Each card is connected to its two neighbor cards, which a slot identifier to have a difference of 1 (slot identifier plus or minus 1 mod 8). A communication link 1222 between slot 0 card and slot 7 card can physically couple port P1 of slot 7 card to port P0 of slot 0 card. However, based on the Nominal Routing Table, communication link 1222 is not used in routing data packets from slot 0 card to slot 7 card. If slot 0 card sends traffic to slot 7 card, the routing table prescribes that this traffic take the “Normal” route. Since slot identifier 7>slot identifier 0, the traffic can go through port P1 of slot 0 card. Similarly, when slot 7 card sends traffic to slot 0 card, the “Normal” routing policy of the Nominal Routing Table indicates that the traffic should take the normal route. Since the slot identifier 0 is less than slot identifier 7, the traffic will leave through port P0 of the slot 7 node to reach slot 6 card. Accordingly, slot 7 card does not send traffic to slot 0 card directly through communication link 1222 between them. A data packet sent from slot 0 card to slot 7 card can go through communication path 1221 including slot 1 card, slot 2 card, and increasingly going through each card to reach slot 7 card as its destination. On the other hand, a data packet sent from slot 7 card to slot 0 card can go through slot 6 card, slot 5 card, and decreasingly go through each card to reach slot 1 card, and further reach slot 0 card as its destination.

FIG. 12E shows a communication path 1223 to route traffic between slot 2 card and slot 5 card for ring communication network 1214 when ring communication network 1214 is configured in its nominal state as shown in FIG. 12C. A data packet can go through communication path 1223 from slot 2 card to slot 5 card going through slot 3 card, slot 4 card, and reaching slot 5 card as its destination. On the other hand, a data package routed through communication path 1223 from slot 5 card to slot 2 card can go through slot 4 card and slot 3 card to reach slot 2 card as its destination.

FIG. 12F shows slot 4 card is offline or inactive in a ring communication network. Accordingly, a communication link 1207 between slot 4 card and slot 3 card and a communication link between slot 4 card and slot 5 card do not transmit any data packets or traffic. For example, suppose ring communication network 1214 including all 8 cards is operating in the nominal state, and slot 4 card suddenly ceases to have the ability to forward traffic. In this case, if each card of ring communication network 1214 still maintains the Nominal Routing Table described in FIG. 12C, ring communication network 1214 can be broken into two subnetworks, where a first network is formed by slot 0 card, slot 1 card, slot 2 card, and slot 3 card; and a second network is formed by slot 5 card, slot 6 card, and slot 7 card. In some embodiments, a modified routing table can be used to preserve network connectivity for the remaining functional cards including slot 0 card, slot 1 card, slot 2 card, slot 3 card, slot 5 card, slot 6 card, and slot 7 card.

FIG. 12G shows ring communication network 1215 formed by the remaining functional cards including slot 0 card, slot 1 card, slot 2 card, slot 3 card, slot 5 card, slot 6 card, and slot 7 card. Ring communication network 1215 can include a communication path 1225 between slot 2 card and slot 5 card. In some embodiments, the routing tables for {slot 0 card, slot 1 card, slot 2 card, slot 3 card} can be reconfigured so that they reach {slot 5 card, slot 6 card, slot 7 card} with the alternate (“Reverse”) route, and vice versa. In addition, slot 4 card is configured by the “Drop” policy since slot 4 card is not functional. The routing table for slot 2 card and slot 5 card can be as follows:

### Routing Table for Slot 2 Card when Slot 4 Card is Offline

| Slot ID | Policy |
|---|---|
| 0 | Normal |
| 1 | Normal |
| 2 | Normal |
| 3 | Normal |
| 4 | Drop |
| 5 | Reverse |
| 6 | Reverse |
| 7 | Reverse |

### Routing Table for Slot 5 Card when Slot 4 Card is Offline

| Slot ID | Policy |
|---|---|
| 0 | Reverse |
| 1 | Reverse |
| 2 | Reverse |
| 3 | Reverse |
| 4 | Drop |
| 5 | Normal |
| 6 | Normal |
| 7 | Normal |

In some embodiments, slot 2 card can use port P0 to communicate with any card other than slot 3 card, and slot 5 card can use port P1 to communicate with any card (it is right next to slot 4 card, so port P0 has no use). Slot 2 card and slot 5 card can communicate with slot 1 card, slot 0 card, slot 7 card, and slot 6 card forwarding traffic between them by communication path 1225.

In some embodiments, the “Reverse” policy can only be used when reacting to transient, exceptional events that affect the ability of a card to forward data packets. For steady state operation of a ring communication network, a non-participating card can be bypassed to form a different ring communication network instead of using the “Reverse” policy to route data packages as shown above. In addition, if a ring communication network is broken into multiple subnetworks by faulty cards, using the “Reverse” policy would not be able to reconnect the multiple subnetworks as shown in FIG. 12H.

FIG. 12H shows carrier board 133 having slot 1 card and slot 4 card offline. Accordingly, no communication path exists between a first subnetwork formed by slot 2 card and slot 3 card and between a second subnetwork formed by slot 5 card, slot 6 card, slot 7 card, and slot 0 card. Therefore, the first subnetwork and the second subnetwork can be disconnected with no options to reconnect them by changing the routing policies on any of the cards.

FIG. 12I shows a ring communication network where slot 4 card is by passed to form a ring communication network 1216. Instead of continually operating with the alternate route after slot 4 card has unexpectedly failed as shown in FIG. 12G, slot 4 card can be bypassed. A communication link 1231 between port P1 of slot 3 card and port P0 of slot 5 card can be enabled to route data packets from slot 3 card to slot 5 card without going through slot 4 card. Accordingly, a card of ring communication network 1216 can store a Revised Nominal Routing Table with a change for slot 4 card. In some embodiments, a card of ring communication network 1216 can store the Revised Nominal Routing Table shown below. In the Revised Nominal Routing Table, data traffic for slot 4 card is dropped since slot 4 card is not a part of ring communication network 1216.

### Revised Nominal Routing Table with Slot 4 Card Bypassed

| Slot ID | Policy |
|---|---|
| 0 | Normal |
| 1 | Normal |
| 2 | Normal |
| 3 | Normal |
| 4 | Drop |
| 5 | Normal |
| 6 | Normal |
| 7 | Normal |

FIG. 12J shows a communication path 1227 between slot 5 card and slot 2 card of ring communication network 1216, where communication path 1227 has slot 4 card bypassed. Slot 2 card can send a data packet to slot 5 card along communication path 1227 going through slot 3 card and further reaching slot 5 card as its destination. On the other hand, slot 5 card can send a data packet along communication path 1227 going through slot 3 card and further reaching slot 2 card as its destination.

FIG. 12K shows carrier board 133 having slot 1 card and slot 4 card offline while the remaining functional cards form a ring communication network 1217. Furthermore, communication link 1231 is enabled between slot 3 card and slot 5 card bypassing slot 4 card. Compared to ring communication network 1216 shown in FIG. 12I, slot 1 card is further offline.

In some embodiments, when slot 1 card is offline, there can still be a communication path for all remaining cards of carrier board 133 to form ring communication network 1217. Any card of slot 2 card, slot 3 card, slot 5 card, slot 6 card, and slot 7 card can reach each other using communication link 1231 when needed. In addition, slot 0 card can use “Reverse” routing policy to send data packets to any of the slot 2 card, slot 3 card, slot 5 card, slot 6 card, and slot 7 card. Accordingly, slot 2 card can store a routing table shown below, where slot 0 card can reach all non-offline, non-bypassed cards with the reverse route defined by “Reverse” routing policy.

### Routing Table for Slot 2 Card when Slot 1 Card is Offline and Slot 4 Card is Bypassed

| Slot ID | Policy |
|---|---|
| 0 | Reverse |
| 1 | Drop |
| 2 | Normal |
| 3 | Normal |
| 4 | Drop |
| 5 | Normal |
| 6 | Normal |
| 7 | Normal |

### Routing Table for Slot 0 Card when Slot 1 Card is Offline and Slot 4 Card is Bypassed

| Slot ID | Policy |
|---|---|
| 0 | Normal |
| 1 | Drop |
| 2 | Reverse |
| 3 | Reverse |
| 4 | Drop |
| 5 | Reverse |
| 6 | Reverse |
| 7 | Reverse |

FIG. 12L shows a communication path 1229 between slot 0 card and slot 2 card of ring communication network 1217, where communication path 1229 has slot 4 card bypassed. Slot 0 card can send a data packet to slot 2 card along communication path 1229 going through slot 7 card, slot 6 card, slot 5 card, slot 3 card, and further reaching slot 2 card as its destination. On the other hand, slot 2 card can send a data packet along communication path 1229 going through slot 3 card, slot 5 card, slot 6 card, slot 7 card, and further reaching slot 0 card as its destination.

FIGS. 13A-13C illustrate operations performed by computing node 255a of card 251 to route data packets in a ring communication network. Some details on the functions of computing node 255a of card 251 are shown in FIGS. 9A-9B. Computing node 255a or card 251 can be used as a card in communication network 203, or a card in any of the ring communication networks 1214, 1215, 1216, and 1217 shown in FIGS. 12A-12L, such as slot 0 card, slot 1 card, . . . , slot 7 card.

FIG. 13A shows additional details on computing node 255a. Computing node 255a can include AP 211 and I/O circuit 212. I/O circuit 212 can include port 215, port 217, and I/O engine 911 having DMA engine, routing table 271, traffic matrix 273, and other components. Port 215 can be referred to as “port P0,” and port 217 can be referred to as “port P1.” In some embodiments, I/O circuit 212 can also include a storage device configured to store routing table 271, which can be used by I/O engine 911 to determine which port to use to send a packet to a computing node of another card of the board or other computing device out of the board. Examples of the routing table have been described with respect to FIGS. 12C-12L. The storage device can further store traffic matrix 273 to determine whether to accept a received packet as having the computing device as a destination or to forward the received packet to another computing device of another card of the board. In addition, a visual representation 1374 of traffic matrix 273 is shown. Visual representation 1374 illustrates the actions performed by computing node 255a of card 251 in ring communication network 1214, which is used as an example ring communication network.

In some embodiments, once port P0 or port P1 notifies I/O engine 911 that a data packet has been received, I/O engine 911 can determine whether computing node 255a is the intended destination for the data packet. In some embodiments, it is possible for multicast data packets to leave through port P0 or port P1. For a non-multicast data packet, the data packet can enter computing node 255a from one port and leave computing node 255a at another port.

In some embodiments, the data packet can be a layer 2 frame, such as an Ethernet frame. I/O engine 911 can further determine whether to forward the data packet by transmitting the data packet through another port different from the port the data packet is received. Instead of testing each packet's destination MAC address, the source or destination card address of the data packet can be encoded by its slot identifier, which can be shorter than the MAC address to save space. A data packet having a destination slot identifier can be sent through communication network 203 on carrier board 133, where computing node 255a is located in card 251 of communication network 203. In some embodiments, traffic or data packets can be sent off carrier board 133 or off communication network 203 by going through a network switching device, such as network switching device 137 shown in FIG. 11C. In addition, multicast traffic can be sent on communication network 203, which can include any of the ring communication networks 1214, 1215, 1216, and 1217 shown in FIGS. 12A-12L.

In some embodiments, I/O engine 911 can maintain traffic matrix 273, which is built based on routing table 271, to direct a data packet appropriately going through a port of computing node 255a. An example traffic matrix 273 can be formatted as shown below, where the symbol “?” is used as a default value for the entry in traffic matrix 273:

Traffic Matrix

| | | |
|---|---|---|
| Ring | | |
| communication | Forward From? | Accept From? |

| network | P0 | P1 | P0 | P1 |
|---|---|---|---|---|
| slot 0 card | ? | ? | ? | ? |
| slot 1 card | ? | ? | ? | ? |
| slot 2 card | ? | ? | ? | ? |
| slot 3 card | ? | ? | ? | ? |
| slot 4 card | ? | ? | ? | ? |
| slot 5 card | ? | ? | ? | ? |
| slot 6 card | ? | ? | ? | ? |
| slot 7 card | ? | ? | ? | ? |
| Multicast | ? | ? | ? | ? |

An entry in the “Forward From?” column of the traffic matrix can answer the question whether to forward a data packet when the data packet is received from a port (P0 or P1) of a slot i card (i=0, 1, 2, 3, 4, 5, 6, and 7). Similarly, an entry in the “Accept From?” column of the traffic matrix can answer the question whether to accept a data packet when the data packet is received from a port (P0 or P1) of a slot i card (i=0, 1, 2, 3, 4, 5, 6, and 7). A “yes” entry in “Forward From?” P0 column for the row of slot 1 card can indicate that when a data packet is received on port P0 of slot 1 card, the data packet are forwarded, e.g., being sent out of slot 1 card through port P1. Similarly, a “yes” entry in “Accept From?” P1 column for the row of slot 3 card can indicate that when a data packet is received on port P1 of slot 3 card, the data packet should be accepted by slot 3 card, which can be sent to the kernel driver of slot 3 card. On the other hand, a “no” entry indicates that the corresponding action is not taken.

In some embodiments, the nominal scenario of computing node 255a of card 251 is shown in FIG. 12C, where all nodes are participating in ring communication network 1214. In some embodiments, computing node 255a of card 251 can be used as slot 2 card of ring communication network 1214, where computing node 255a can have a traffic matrix shown below, where the symbol “+” indicates a “yes” answer and “−” indicates a “no” answer for the entry.

Traffic Matrix for slot 2 card in ring communication network 1214

| | | |
|---|---|---|
| Ring | | |
| communicatior | Forward From? | Accept From? |

| network 1214 | P0 | P1 | P0 | P1 |
|---|---|---|---|---|
| slot 0 card | + | + | − | − |
| slot 1 card | + | + | − | − |
| slot 2 card | − | − | + | + |
| slot 3 card | + | + | − | − |
| slot 4 card | + | + | − | − |
| slot 5 card | + | + | − | − |
| slot 6 card | + | + | − | − |
| slot 7 card | + | + | − | − |
| Multicast | + | + | + | + |

In some embodiments, the traffic matrix for slot 2 card in ring communication network 1214 shows that slot 2 card can accept and forward multicast traffic from either port P0 or port P1. In addition, slot 2 card can accept data packets having slot 2 card at the destination. Furthermore, slot 2 card can forward from either port P0 or port P1 a data packet that does not have slot 2 card as its destination.

In some embodiments, visual representation 1374 for the above traffic matrix for slot 2 card in ring communication network 1214 can illustrate the content of the traffic matrix. A line in visual representation 1374 can be marked by a slot identifier to identify a source of the data packet, which can be any of the slot 0 card to slot 7 card shown in the above traffic matrix. As shown, the lines are labelled in increasing order from top to bottom (0 to 7). In addition, visual representation 1374 also include a line labelled by “8” representing multicast traffic. Visual representation 1374 does not provide any additional operations beyond the operations performed based on the above traffic matrix for slot 2 card in ring communication network 1214.

In some embodiments, as shown by visual representation 1374, the above traffic matrix for slot 2 card in ring communication network 1214 indicates that slot 2 card can accept and forward multicast traffic from any of port P0 or port P1, where the action of “accept” is marked by a solid circle on the line. In addition, slot 2 card can accept traffic having slot 2 card as the destination from either port P0 or port P1, where the accept action is marked by a solid circle on the line. Furthermore, slot 2 card can forward any traffic not destined to slot 2 card from either port P0 or port P1. However, it does not forward anything from other cards corresponding to slot 2 card as the destination, where the action “do not forward” is marked as an “x” symbol on the line.

In some embodiments, in the nominal scenario where all nodes are participating in ring communication network 1214 as shown in FIG. 12C, slot 7 card can have a traffic matrix shown below. For slot 7 card, the traffic matrix is different from the traffic matrix for slot 2 card of ring communication network 1214, since slot 7 card does not forward any traffic. Any data packets reaching slot 7 card have slot 7 card as the destination. Additionally, slot 7 card can receive multicast traffic over ring communication network 1214. Furthermore, slot 7 card can only receive data packets from port P0. The traffic matrix for slot 7 card of ring communication network 1214 can have a visual representation 1375 shown in FIG. 13B, where the notations in FIG. 13B have the same meaning as the corresponding notations in FIG. 13A described above.

Traffic Matrix for slot 7 card of ring communication network 1214

| | | |
|---|---|---|
| Ring | | |
| communication | Forward From? | Accept From? |

| network 1214 | P0 | P1 | P0 | ATC1 |
|---|---|---|---|---|
| slot 0 card | − | − | − | − |
| slot 1 card | − | − | − | − |
| slot 2 card | − | − | − | − |
| slot 3 card | − | − | − | − |
| slot 4 card | − | − | − | − |
| slot 5 card | − | − | − | − |
| slot 6 card | − | − | − | − |
| slot 7 card | − | − | + | − |
| Multicast | − | − | + | − |

In some embodiments, as shown in FIG. 12C, one of the cards of ring communication network 1214 of carrier board 133 can be an outbound card coupled to network switching device 137. Accordingly, a data packet has a computing node on another board as its destination can go through the outbound card to reach network switching device 137 before being routed to the computing node on another board. In some embodiments, slot 0 card can be an example of the outbound card for ring communication network 1214. As the outbound card, slot 0 card can accept data packets having slot 0 card as the destination or data packets sent by multicast. Accordingly, slot 0 card can accept data packets from any card of ring communication network 1214. The resulting traffic matrix for slot 0 card as the outbound card is shown below.

Traffic Matrix for slot 0 card of ring communication
network 1214 as the outbound card

| | | |
|---|---|---|
| Ring | | |
| communication | Forward From? | Accept From? |

| network 1214 | P0 | P1 | P0 | P1 |
|---|---|---|---|---|
| slot 0 card | − | − | − | + |
| slot 1 card | − | − | − | + |
| slot 2 card | − | − | − | + |
| slot 3 card | − | − | − | + |
| slot 4 card | − | − | − | + |
| slot 5 card | − | − | − | + |
| slot 6 card | − | − | − | + |
| slot 7 card | − | − | − | + |
| Multicast | − | − | − | + |

In some embodiments, as shown in the traffic matrix for slot 0 card of ring communication network 1214 as the outbound card, slot 0 card does not perform any forward function because it only communicates through port P1. Instead, slot 0 card can accept data packets from any card of ring communication network 1214 so that the received data packets can be transmitted to another board. A visual representation 1376 is shown in FIG. 13C for the traffic matrix for slot 0 card of ring communication network 1214 as the outbound card.

In some embodiments, kernel driver 901 of computing node 255a can perform operations to route data packets based on the traffic matrix for a card of ring communication network 1214, where computing node 255a can be used as the computing node of the card. When kernel driver 901 receives a data packet from the packet queue of networking stack 905, kernel driver 901 can use the traffic matrix to decide how to send the data packet. A simplified version of the operation flow performed by kernel driver 901 of computing node 255a can be as follows:
1. Read the destination MAC address of the data packet. In some embodiments, the MAC address can include 6 bytes of the data packet.
2. If the MAC address has the multicast bit set,
   a) For port P0, get the slot identifier of a neighbor card connected to computing node 255a through port P0.
   b) Using the routing table stored in computing node 255a, determine if computing node 255a can send the data packet destined for the neighbor card with the slot identifier through port P0. If so, send the data packet to the neighbor card through port P0.
   c) Repeat the above operations for port P1.
3. Else, look up the destination MAC address of the data packet in the MAC address to slot identifier map, as shown in MAC address and slot identifier correspondence table in paragraph [0177].
   a) If there is an entry for the destination MAC address of the data packet Retrieve the slot identifier corresponding to the destination MAC address
   b) Else
      Retrieve the slot identifier for the outbound card of ring communication network 1214
   c) Use the slot identifier for the outbound card to index the routing table, determining which port to send the data packet out of computing node 255a.

FIG. 14 illustrates a flowchart of process 1400 for operations performed by an instruction processing device of a chassis, according to some embodiments. For illustrative purposes, the operations illustrated in process 1400 will be described with reference to BMC 135 of chassis 121 as shown in FIGS. 1, 7, and 9. Other representations of systems for performing operations by an instruction processing device of a chassis are within the scope of the present disclosure. Also, additional operations can be performed between various operations of process 1400 and can be omitted merely for clarity and ease of description. The additional operations can be provided before, during, and/or after process 1400, in which one or more of these additional operations are briefly described herein. Moreover, not all operations can be needed to perform the disclosure provided herein. Additionally, some of the operations can be performed simultaneously or in a different order than shown in FIG. 14. In some embodiments, one or more other operations can be performed in addition to or in place of the presently-described operations.

At operation 1401, process 1400 can include generating, by an instruction processing device, an instruction for a processing device of a card to generate an operation result based on the instruction. For example, as shown in FIGS. 1, 7, and 9, BMC 135 of chassis 121 can generate an instruction for AP 211 of card 251 to generate an operation result based on the instruction. BMC 135 can be configured to manage operations of a set of computing devices of chassis 121 including one or more boards (e.g., carrier board 133 and carrier board 133a). At least one board of the one or more boards includes a set of cards including the card. For example, carrier board 133 can include card 251, card 252, and card 254. Card 251 can include controller 253a and computing node 255a that further includes AP 211. In some embodiments, either computing node 255a or AP 211 can be referred to as “a processing device.”

At operation 1403, process 1400 can include transmitting, by the instruction processing device, the instruction to the controller of the card to instruct the processing device of the card to generate the operation result. For example, as shown in FIGS. 1, 7, and 9, BMC 135 of chassis 121 can transmit the instruction to controller 253a of card 251 to instruct AP 211 to generate the operation result. In some embodiments, BMC 135 is coupled to controller 253a by a first communication network having a first communication protocol (e.g., communication network 201).

At operation 1403, process 1400 can include providing, by the processing device of the card, the operation result to another device of the at least one board through a second communication network having a second communication protocol different from the first communication protocol. For example, computing node 255a or AP 211 can generate the operation result based on the instruction received from controller 253a, where the instruction is received from BMC 135. After, computing node 255a or AP 211 can provide the operation result to computing node 255b of card 252 on carrier board 133, where computing node 255a or AP 211 can be coupled to computing node 255b of card 252 by communication network 203.

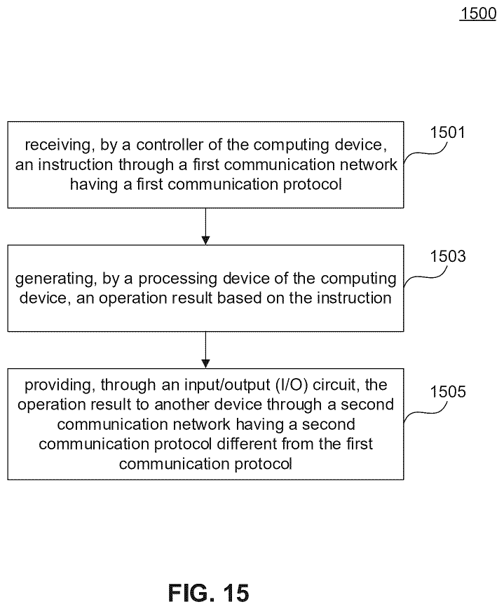

FIG. 15 illustrates a flowchart of process 1500 for operations performed by a card on a board managed by an instruction processing device of a chassis, according to some embodiments. For illustrative purposes, the operations illustrated in process 1500 will be described with reference to BMC 135 of chassis 121 as shown in FIGS. 1, 7, and 9. Other representations of systems for performing operations by an instruction processing device of a chassis are within the scope of the present disclosure. Also, additional operations can be performed between various operations of process 1500 and can be omitted merely for clarity and ease of description. The additional operations can be provided before, during, and/or after process 1500, in which one or more of these additional operations are briefly described herein. Moreover, not all operations can be needed to perform the disclosure provided herein. Additionally, some of the operations can be performed simultaneously or in a different order than shown in FIG. 15. In some embodiments, one or more other operations can be performed in addition to or in place of the presently-described operations.

At operation 1501, process 1500 can include receiving, by a controller of the computing device, an instruction through a first communication network having a first communication protocol. For example, controller 253a of card 251 can receive an instruction from BMC 135 through a first communication network having a first communication protocol (e.g., communication network 201).

At operation 1503, process 1500 can include generating, by a processing device of the computing device, an operation result based on the instruction. For example, computing node 255a of card 251 or AP 211 can generate the operation result based on the instruction received by controller 253a of card 251.

At operation 1505, process 1500 can include providing, through an input/output (I/O) circuit, the operation result to another device through a second communication network having a second communication protocol different from the first communication protocol. For example, computing node 255a of card 251 or AP 211 can provide the operation result through I/O circuit 212 that includes port 215, port 217, and a DMA engine 213 to computing node 255b of card 252 on carrier board 133, where AP 211 can be coupled to computing node 255b of card 252 by communication network 203.

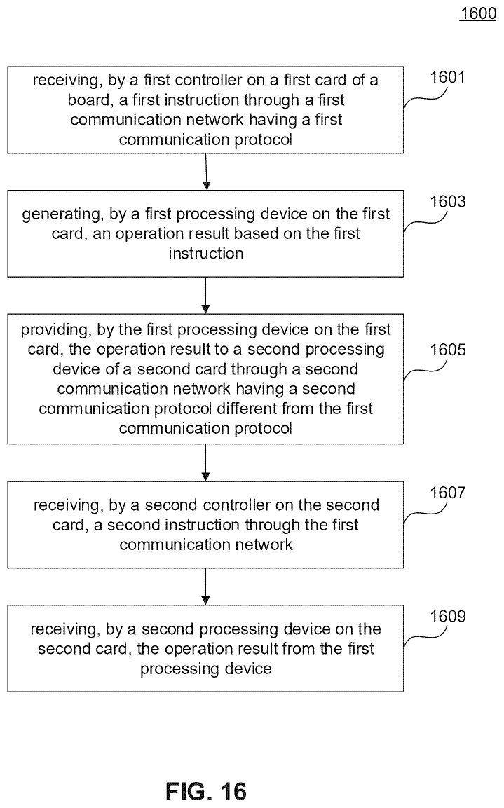

FIG. 16 illustrates a flowchart of process 1600 for operations performed by a board managed by an instruction processing device of a chassis, according to some embodiments. For illustrative purposes, the operations illustrated in process 1600 will be described with reference to BMC 135 of chassis 121 as shown in FIGS. 1, 7, and 9A-9G. Other representations of systems for performing operations by an instruction processing device of a chassis are within the scope of the present disclosure. Also, additional operations can be performed between various operations of process 1600 and can be omitted merely for clarity and ease of description. The additional operations can be provided before, during, and/or after process 1600, in which one or more of these additional operations are briefly described herein. Moreover, not all operations can be needed to perform the disclosure provided herein. Additionally, some of the operations can be performed simultaneously or in a different order than shown in FIG. 16. In some embodiments, one or more other operations can be performed in addition to or in place of the presently-described operations.

At operation 1601, process 1600 can include receiving, by a first controller on a first card of a board, a first instruction through a first communication network having a first communication protocol. For example, controller 253a of card 251 can receive an instruction from BMC 135 through a first communication network having a first communication protocol (e.g., communication network 201). Card 251 can be a first card of carrier board 133. Card 252 can be a second card of carrier board 133.

At operation 1603, process 1600 can include generating, by a first processing device on the first card, an operation result based on the first instruction. For example, AP 211 of card 251 can generate an operation result based on the first instruction received by controller 253a of card 251 from BMC 135.

At operation 1605, process 1600 can include providing, by the first processing device on the first card, the operation result to a second processing device of a second card through a second communication network having a second communication protocol different from the first communication protocol. For example, AP 211 of card 251 can provide the operation result to computing node 255b of card 252 through a second communication network having a second communication protocol (e.g., communication network 203).

At operation 1607, process 1600 can include receiving, by a second controller on the second card, a second instruction through the first communication network. For example, controller 253b of card 252 can receive a second instruction from BMC 135 through the first communication network (e.g., communication network 201).

At operation 1609, process 1600 can include receiving, by a second processing device on the second card, the operation result from the first processing device. For example, computing node 255b of card 252 can receive the operation result from AP 211 or computing node 255a through the second communication network (e.g., communication network 203).

FIG. 17A illustrates data center computing system 100 including chassis and racks of fleet 101 having power management devices, according to some embodiments. Data center computing system 100 can include fleet 101, rack 111, chassis 121, BMC 135, carrier board 133, cards 251 and 252, computing nodes 255a and 255b, and other components, which can function as described with respect to FIGS. 1, 9A-9B, and 10A. Data center computing system 100 further includes additional components related to power management devices or power management unit (PMU), as described below.

In some embodiments, fleet 101 can include multiple racks, e.g., rack 111 as the first rack, and have a total of m racks. A rack, e.g., rack 111, can include multiple chassis, e.g., chassis 121 as the first chassis, and have a total of n chassis. A chassis can include multiple boards, e.g., carrier board 133 as the first board, and have a total of k boards. A board, e.g., carrier board 133, can include multiple cards, e.g., card 251 as the first card and card 252, and have a total of s cards. A carrier board k can include multiple cards, e.g., card 1751 and card 1752. The sizes n, m, k, and s are natural numbers.

In some embodiments, devices within fleet 101 can include the m racks, multiple chassis on each rack, multiple boards on each chassis, multiple cards on each board, and at least one controller and one computing node on each card. Each of the racks, chassis, boards, cards, and computing nodes is a hierarchical layer of the hierarchical structure of fleet 101. A hierarchical layer can be referred to as a layer or a level of fleet 101. Accordingly, a layer can refer to a fleet, a rack, a chassis, a board, a card, or a computing node. A layer of fleet 101 can have (i) a parent layer including a parent component and (ii) a child layer including one or more child components. In some embodiments, a rack can have a fleet as its parent component and one or more chassis as its child components. A chassis can have a rack as its parent component and multiple boards as its child component. A board can have a chassis as its parent component and multiple cards as its child components. Similarly, a card can have a board as its parent component and a computing node as its child component. In some embodiments, a device at any hierarchical layer of fleet 101 can include a PMU to manage power consumption by the device. The hierarchical structure presented herein for fleet 101 is exemplary. There can be other similar hierarchical structures for fleet 101. In some embodiments, a card can include multiple computing nodes.

In some embodiments, BMC 135 is placed at a chassis, but not on a board, a card, or a rack. Other control units can be placed on a board, a card, or a rack, but perform functions different from BMC 135.

In some embodiments, devices at the various hierarchical layers within fleet 101 can share the same power supply with a fixed amount of power. In some embodiments, there can be total 80 kW power supplied to 10 racks within fleet 101. When the power supply is evenly divided among the 10 racks, each rack can have a rack power budget of 8 kW. Each rack can include 20 chassis, each having a chassis power budget of 400 W when the rack power budget 8 kW is evenly divided among the 20 chassis. When there are 4 boards within a chassis with an equal board power budget, each board can have a board power budget of 100 W. When a board has total 8 cards, each card can have a card power budget of 12.5 W if the board power budget of 100 W is evenly divided among the 8 cards. The numbers provided above are exemplary. There can be other amounts of power allocated to be the rack power budget, the chassis power budget, the board power budget, and the card power budget.

In some embodiments, the assumptions presented above are for nominal working workloads when each card can have a card power budget that is an evenly divided part of a board power budget, the board power budget is an evenly divided part of a chassis power budget, and the chassis power budget is an evenly divided part of a rack power budget. Such nominal workload assignments for data center computing system 100 or fleet 101 can work in some environments, e.g., when a subset of components of a card are used for computing or when the workload assignments have a duty cycles. In some embodiments, the evenly divided budget for the devices on multiple racks of data center computing system 100 or fleet 101 cannot sufficiently function when the power consumption for one or more cards, boards, chassis, or rack exceeds the corresponding power budget.

In some embodiments, data center computing system 100 or fleet 101 can have a wide range of power consumptions, with some workloads exceeding what would be the equal share of the corresponding power budget. Inside a hierarchical layer, e.g., a rack, a chassis, a board, or a card, some workload tasks can exceed the current limit, or heat dissipation rate, of the layer, e.g., a chassis, a carrier board, or individual card. Embodiments herein present techniques to allow data center computing system 100 or fleet 101 to continue the performance of the workload tasks when some devices or components temporarily exceed the assigned power budget. Accordingly, instead of a static power budget assignment for a device in the hierarchy of fleet 101, the embodiments herein can allow power distribution to exceed the equal share of the device at the hierarch layer of fleet 101. In some embodiments, such a way to dynamically allow power consumption over an allocated power budget can be referred to as an oversubscribed power model. In some embodiments, the workload tasks assigned to the different devices in various level of hierarchy of fleet 101 can have uncorrelated power demands. Even if a device in the hierarchy of fleet 101 can have power consumption temporarily over the allocated power budget for the device, the aggregate power consumption of the parent device in the parent level in the hierarchy of fleet 101 can still remain within the allocated power budget for the parent device.

In some embodiments, actions can be taken to reduce the power consumption for the device at a hierarchical layer of fleet 101 that has a power consumption over the allocated power budget. In some embodiments, actions can be taken by the PMU of the device to adjust a performance mechanism from a first performance indicator to a second performance indicator. In some embodiments, a performance mechanism can refer to any physical parameter that can be adjusted or controlled to impact the performance of device or the power consumption of the device. In some embodiments, the performance mechanism can include a clock speed. In some embodiments, the performance mechanism can include shutting off a component of a device or turning on a component of the device.

In some embodiments, techniques presented here can provide more flexibility than dividing power budget equally among every card, every board, or every chassis. Techniques presented herein can further mitigate momentary peak power consumption so that a system may run closer to the power limit policy. Accordingly, additional workload tasks can be scheduled where power limits are underutilized. Fleet 101 can optionally have some system information of how much power a workload task can use and can schedule more workload tasks.

In some embodiments, the PMU is implemented in every layer of the hierarchical structure of data center computing system 100. Rack 111 includes chassis 121, which includes carrier board 133 to carrier board k. Carrier board 133 includes card 251 and card 252, while carrier board k includes card 1751 and card 1752. Card 251 includes a PMU 1701, card 252 includes a PMU 1701b, card 1751 includes a PMU 1751a, and card 1752 includes a PMU 1752a. Carrier board 133 includes a PMU 1711, carrier board k includes a PMU 1753, chassis 121 includes a PMU 1721, and rack 111 includes a PMU 1731. In addition, carrier board 133 can further include a controller 1715. Computing node 255a and controller 253a of card 251 are presented herein as examples. As described previously for FIG. 9A, controller 253a is coupled to BMC 135 by communication network 201, computing node 255a is coupled to another computing node of another card, e.g., computing node 255b, by communication network 203.

In some embodiments, devices of fleet 101 at any layer of the hierarchy can have a corresponding power budget. Card 251 can have a power budget 1704 for the card for operations performed by computing node 255a, card 252 can have a power budget 1704b for the card for operations performed by computing node 255b, card 1751 can have a power budget 1714a for the card for operations performed by computing node of card 1751, and card 1752 can have a power budget 1714b for the card for operations performed by computing node of card 1752. Carrier board 133 can have a power budget 1714 for the board for operations performed by computing nodes of all cards of carrier board 133. Carrier board k can have a similar power budget (not shown). Chassis 121 can have a power budget 1724 for the chassis for operations performed by computing nodes of all cards of all boards of chassis 121. Rack 111 can have a power budget 1734 for the rack for operations performed by computing nodes of all cards of all boards of all chassis of rack 111. In some embodiments, fleet 101 can have m racks, where each rack can have a power budget as 1/m of the power budget for fleet 101. Rack 111 can have n chassis, where each chassis can have a power budget as 1/n of the power budget for the rack. Chassis 121 can have k boards, where each board can have a power budget of 1/k of the power budget for the chassis. Carrier board 133 can have s cards, where each card can have a power budget as 1/s of the power budget for carrier board 133.

In some embodiments, PMU 1701, controller 253a, and computing node 255a including AP 211 and I/O circuit 212 are located on card 251. Any other card can include a PMU as well, e.g., PMU 1701b on card 252. PMU 1701 is coupled to computing node 255a including AP 211 and I/O circuit 212 by a communication network 1707. In some embodiments, controller 253a can be configured to receive an instruction from BMC 135 through communication network 201, and computing node 255a can be configured to generate an operation result based on the instruction and provide the operation result to computing node 255b of card 252 through communication network 203. In some embodiments, communication network 201 can be a control network, communication network 203 can be a data communication network, and communication network 1707 can be a power control network different from communication network 201 and communication network 203. In some embodiments, communication network 1707 can be a faster control network than communication network 201 and communication network 203 and can be operational regardless whether communication network 201 or communication network 203 is operational or not.

In some embodiments, PMU 1701 located on card 251 can be configured to perform various operations. In some embodiments, PMU 1701 can assess or determine whether the power consumption of computing node 255a as indicated by a power consumption indicator 1702 exceeds power budget 1704. In some embodiments, power consumption indicator 1702 can include one or more of a current indicator, a power indicator, and a heat dissipation rate indicator for computing node 255a. In response to power consumption indicator 1702 exceeding power budget 1704 for computing node 255a associated with performing a workload task 1706, PMU 1701 can adjust a performance mechanism for computing node 255a as indicated by a performance indicator 1708 to have a different value to reduce the power consumption by computing node 255a. In some embodiments, performance indicator 1708 can include a clock speed. In some embodiments, computing node 255a can initially operate at a first clock speed, and PMU 1701 can adjust the clock speed of clock 1705 so that computing node 255a can operate at a second clock speed slower than the first clock speed after PMU 1701 making the adjustment of the performance mechanism. When computing node 255a performs operations for workload task 1706 at the first clock speed, PMU 1701 can detect that power consumption indicator 1702 exceeding power budget 1704 for computing node 255a. Accordingly, PMU 1701 can adjust the clock speed for clock 1705. After PMU 1701 adjusts clock 1705 so that computing node 255a operates at the second clock speed, computing node 255a can consume less power while continuing to perform operations for workload task 1706 without interruption to the operations for workload task 1706.

In some embodiments, PMU 1701 of card 251 can adjust performance indicator 1708 in response to power consumption indicator 1702 exceeding power budget 1704 for card 251. In some embodiments, PMU 1701 of card 251 can make the adjustment under a condition that a power consumption indicated by a power consumption indicator 1712 of carrier board 133 does not exceed power budget 1714 for carrier board 133. When power consumption indicator 1712 of carrier board 133 exceeds power budget 1714 for carrier board 133, PMU 1711 of carrier board 133 can take further actions and can instruct PMU 1701 of card 251 accordingly.

In some embodiments, in response to power consumption indicator 1702 exceeding power budget 1704 for computing node 255a, PMU 1701 can assert a power control pin 1709 for computing node 255a to generate an interruption signal in response to determining that power consumption indicator 1702 exceeds power budget 1704 for computing node 255a. In some embodiments, controller 253a can record an event 1710 associated with the determination that power consumption indicator 1702 exceeds power budget 1704 for computing node 255a. Event 1710 is recorded by controller 253a instead of PMU 1701 so that the operations can be separated to allow PMU to manage operations related to power control only, which can increase the overall efficiency for fleet 101.

In some embodiments, FIG. 17B illustrates additional details on operations performed by PMU 1701 of card 251 at multiple time instances, e.g., T1, T2, T3, T4, and T5, to demonstrate the process of power control and monitoring operations performed by PMU 1701 for card 251, where T1<T2<T3<T4<T5. In addition, a timer 1703 is configured to control further operations, where timer 1703 can expire at an expiration time T (expiration). Timer 1703 can be controlled by PMU 1701 or controller 253a of card 251.

In some embodiments, at different time instances, card 251 can have a power budget value, as indicated by power budget 1704-1 at time T1, power budget 1704-3 at time T3, power budget 1704-5 at time T5, and a power budget 1704-e at time T (expiration). In some embodiments, power budget 1704-1, power budget 1704-3, power budget 1704-5, and power budget 1704-e at the different time instances can be equal to one another, where card 251 can have a steady power budget allocation. In some embodiments, power budget 1704-1, power budget 1704-3, power budget 1704-5, and power budget 1704-e can have different values at the different time instances following a dynamic power budget allocation scheme.

In some embodiments, at a first time instance T1, PMU 1701 can receive a power consumption indicator 1702-1 based on a power consumption of computing node 255a at time T1. In some embodiments, PMU 1701 can request power consumption indicator 1702-1 by sending a request to collect the information from computing node 255a. Additionally and alternatively, computing node 255a can periodically monitor the power consumption and send power consumption indicator 1702-1 to PMU 170 without a request. PMU 1701 can compare power consumption indicator 1702-1 and power budget 1704-1 to determine whether power consumption indicator 1702-1 exceeds power budget 1704-1 at time T1.

In some embodiments, in response to power consumption indicator 1702-1 exceeding power budget 1704-1 for computing node 255a at time T1, PMU 1701 can issue a PMU instruction 1719 to adjust a performance mechanism for computing node 255a from a performance indicator 1708-1 at time T1 to a performance indicator 1708-2 at time T2 to reduce the power consumption by computing node 255a. In some embodiments, T2 is a time instance when the adjustment made by PMU 1701 can take effect. In some embodiments, a gap between T1 and T2 can be less than 10 clock cycles or another number of clock cycles to execute the instruction by PMU 1701 to adjust the performance mechanism. In some embodiments, the performance mechanism being adjusted for computing node 255a can be clock speed. In some embodiments, computing node 255a can operate at a first clock speed at time T1, and PMU 1701 can adjust the clock speed of clock 1705 so that computing node 255a can operate at a second clock speed slower than the first clock speed at time T2.

In some embodiments, computing node 255a can perform workload task 1706 with the first clock speed at time T1 and can perform the same workload task 1706 at time T2 with the second clock speed slower than the first clock speed at time T1. Accordingly, computing node 255a can continue to perform workload task 1706 without interruption while PMU 1701 adjusts the performance mechanism for computing node 255a.

In some embodiments, PMU 1701 of card 251 can work with PMU 1711 of carrier board 133 in coordination with the detection of power consumption indicator 1702-1 exceeding power budget 1704-1 for computing node 255a. In order for PMU 1701 of card 251 to adjust the clock speed of card 251, PMU 1711 can determine that a power consumption indicator 1712-1 for carrier board 133 at time T1 does not exceed a power budget 1714-1 for carrier board 133 at time T1. If PMU 1711 determines that power consumption indicator 1712-1 for carrier board 133 at time T1 exceeds power budget 1714-1, PMU 1711 can take further actions beyond adjusting the performance of card 251, where the further action can include adjusting the performance of additional cards besides card 251. In some embodiments, carrier board 133 can include s cards, and power budget 1704-1 for computing node 255a can be I/s of power budget 1714-1 for carrier board 133.

In some embodiments, PMU 1701 of card 251 can receive a power consumption indicator 1702-3 at a third time instance T3 based on a power consumption of computing node 255a at time T3 after time T2. In response to power consumption indicator 1702-3 at time T3 being below a power budget 1704-3 for computing node 255a at time T3, PMU 1701 can return the performance mechanism for computing node 255a from performance indicator 1708-2 to performance indicator 1708-1 at a fourth time instance T4 after T3. A gap between time T4 and time T3 is determined by how fast computing node 255a can adjust its clock speed or other performance mechanism based on an instruction from PMU 1701.

Accordingly, computing node 255a can operate with performance indicator 1708-2 during the time period between time T2 and time T3 and return back to performance indicator 1708-1 after the time period from time T2 to time T3. The time period from time T2 to time T3 is the period of time computing node 255a can operate at a slower clock speed or reduced component activities, which is measured by performance indicator 1708-2. Accordingly, computing node 255a can reduce the power consumption from exceeding power budget 1704-1 at time T1 to below power budget 1704-3 at time T3. At time T4, computing node 255a can return to the normal operation with performance indicator 1708-1. After computing node 255a returns to the normal operation, PMU 1701 can continue to monitor and control the operations of computing node 255a.

In some embodiments, PMU 1701 of card 251 can collect a power consumption indicator 1702-5 at a fifth time instance T5 based on a power consumption of computing node 2055a, where time T5 is after time T4. PMU 1701 can determine that power consumption indicator 1702-5 at time T5 exceeds a power budget 1704-5 for computing node 2055a. PMU 1701 can further determine a time gap between time instances T1 and T5. In response to the time gap between time instances T1 and T5 being shorter than a predetermined gap for recurrence for power consumption over the power budget, PMU 1701 can report an error. Operations herein can be based on the observation that a repeated event of power consumption over the allocated power budget can be an error of fleet 101. In response to the error being determined and reported, PMU 1701 can further shut down or turn off computing node 255a. Other actions can be taken to reduce the power consumption for computing node 255a.

In some embodiments, in response to determining that power consumption indicator 1702-1 at time T1 exceeds power budget 1704-1 at time T1, PMU 1701 of card 251 can start a timer 1703 for a predetermined time period. Tier 1703 can be used to ensure the time period for power consumption indicator 1702-1 exceeding power budget 1704-1 lasts only a short period of time to avoid damage to devices of fleet 101. At an expiration time instance T (expiration) corresponding to timer 1703 reaching the predetermined time period T (expiration), PMU 1701 can collect a power consumption indicator 1702-e based on the power consumption of computing node 255a at time T (expiration). In response to determining that power consumption indicator 1702-e exceeds a power budget 1704-e at time T (expiration), PMU 1701 can turn off power to computing node 255a. In some embodiments, T (expiration) can be longer than time T3 and time T4. In some embodiments, when T (expiration) is shorter than time T3, PMU 1701 can turn off power to computing node 255a.

In some embodiments, FIG. 17C illustrates additional details on operations performed by PMU 1711 of carrier board 133 at multiple time instances, e.g., T11, T12, T13, T14, and T15, to demonstrate the process of power control and monitoring operations performed by PMU 1711 of carrier board 133, where T11<T12<T13<T14<T15. To distinguish from the time instances T1, T2, T3, T4, and T4 illustrated in FIG. 17B, T11 can be referred to as a first board time instance, T12 a second board time instance, T13 a third board time instance, T14 a fourth board time instance, and T15 a fifth board time instance. In addition, there can be a timer 1713 to control further operations, where timer 1713 can expire at an expiration time for the board referred to as TB (expiration).

In some embodiments, at different time instances, carrier board 133 can have a power budget value for the board, as indicated by a power budget 1714-11 at time T11, a power budget 1714-13 at time T13, a power budget 1714-15 at time T15, and a power budget 1714-1e at time TB (expiration).

In some embodiments, at a first board time instance T11, PMU 1711 of carrier board 133 can receive a power consumption indicator 1712-11 based on a power consumption of carrier board 133 at time T11.

In some embodiments, in response to power consumption indicator 1712-11 exceeding power budget 1714-11 for carrier board 133 at time T11, PMU 1711 can issue a PMU instruction 1729 to adjust a performance mechanism for one or more computing nodes of carrier board 133. In some embodiments, PMU 1711 can adjust performance indicator 1708-11 of computing node 255a at time T11 to a performance indicator 1708-12 at time T12 to reduce the power consumption by computing node 255a. In addition, PMU 1711 can adjust performance indicator 1708b-11 of computing node 255b at time T11 to a performance indicator 1708b-12 at time T12 to reduce the power consumption by computing node 255b. PMU 1711 can adjust performance indicator for other computing nodes of carrier board 133 as well (not shown). In some embodiments, T12 is a time instance when the adjustment made by PMU 1711 can take effect. In some embodiments, a gap between time T11 and time T12 can be less than 10 clock cycles or another number of clock cycles to execute the instruction by PMU 1711 to adjust the performance mechanism. In some embodiments, the performance mechanism being adjusted for computing node 255a and computing node 255b can be clock speed. In some embodiments, computing node 255a can operate at a first clock speed at time T11, and PMU 1711 can adjust the clock speed of clock 1705 so that computing node 255a can operate at a second clock speed slower than the first clock speed at time T12. Similarly, computing node 255b can operate at a first clock speed at time T11, and PMU 1711 can adjust the clock speed of computing node 255b so that computing node 255b can operate at a second clock speed slower than the first clock speed at time T12.

In some embodiments, PMU 1711 of carrier board 133 can work with PMU 1721 of chassis 121 in coordination with the detection of power consumption indicator 1712-11 exceeding power budget 1714-11 for carrier board 133. In order for PMU 1711 of carrier board 133 to adjust the clock speed of one or more cards of carrier board 133, PMU 1721 of chassis 121 can determine that a power consumption indicator 1722-11 for chassis 121 at time T11 does not exceed a power budget 1724-11 for chassis 121 at time T11. If PMU 1721 determines that power consumption indicator 1722-11 for chassis 121 at time T11 exceeds power budget 1724-11, PMU 1721 can take further actions beyond adjusting performance of devices of chassis 121, where the further action can include adjusting performance of devices on other boards of chassis 121. In addition, chassis 121 can include an instruction processing device, e.g., BMC 135, to record an event representing the determination that the power consumption indicator of carrier board 133 at the first board time instance exceeds the power budget for the board at the first board time instance.

In some embodiments, PMU 1711 of carrier board 133 can receive a power consumption indicator 1712-13 at a third board time instance T13 based on a power consumption of carrier board 133 at time T13 after time T12. In response to power consumption indicator 1712-13 at time T13 being below a power budget 1714-13 for carrier board 133, PMU 1711 can return the performance mechanism for one or more computing nodes of carrier board 133. In some embodiments, PMU 1711 can return the performance mechanism for computing node 255a from the second performance indicator 1708-12 to performance indicator 1708-11 at a fourth time instance T14 after time T13 and can further return computing node 255b from the second performance indicator 1708-12 to performance indicator 1708-11 at time T14. At time instance T4, computing node 255a can return to the normal operation with performance indicator 1708-11, and computing node 255b can return to the normal operation with performance indicator 1708b-11. Afterwards, PMU 1711 can continue to monitor and control the operations of computing nodes of carrier board 133.

In some embodiments, PMU 1711 of carrier board 133 can collect a power consumption indicator 1712-15 at a fifth time instance T15 based on a power consumption of computing nodes of carrier board 133, where time T15 is after time T14. PMU 1711 can determine that power consumption indicator 1712-15 at time T15 exceeds a power budget 1714-15 for carrier board 133. PMU 1711 can further determine a time gap between time instances T11 and T15. In response to the time gap between time instances T11 and T15 being shorter than a predetermined gap for recurrence for power consumption over the power budget, PMU 1711 can report an error. In response to the error being determined and reported, PMU 1701 can further shut down or turn off one or more computing nodes of carrier board 133. Other actions can be taken to reduce the power consumption for computing nodes of carrier board 133.

In some embodiments, in response to determining that power consumption indicator 1712-11 at time T1 exceeds power budget 1714-11 at time T11, PMU 1711 of carrier board 133 can start a timer 1713 for a predetermined time period. In some embodiments, timer 1713 can be started and managed by a controller of carrier board 133, e.g., controller 1715. At an expiration time instance TB (expiration) corresponding to timer 1713 reaching the predetermined time period TB (expiration), PMU 1711 can collect a power consumption indicator 1712-1e based on the power consumption of computing nodes of carrier board 133 at time TB (expiration). In response to determining that power consumption indicator 1712-1e exceeds a power budget 1714-1e at time TB (expiration), PMU 1711 can turn off power to one or more computing nodes of carrier board 133.

In some embodiments, FIG. 17D illustrates additional details on operations performed by PMU 1721 of chassis 121 at multiple time instances, e.g., T21, T22, T23, T24, and T25, to demonstrate the process of power control and monitoring operations performed by PMU 1721 of chassis 121, where T21<T22<T23<T24<T25. To distinguish from the time instances T1, T2, T3, T4, and T5 illustrated in FIG. 17B, and time instances T11, T12, T13, T14, and T15 illustrated in FIG. 17C, T21 can be referred to as a first chassis time instance, T22 a second chassis time instance, T23 a third chassis time instance, T24 a fourth chassis time instance, and T25 a fifth chassis time instance. In addition, there can be a timer 1723 to control further operations, where timer 1723 can expire at an expiration time for the chassis referred to as TC (expiration). In some embodiments, chassis 121 can include an I/O board, and PMU 1721 can be located in the I/O board. The I/O board may manage operations related to communication for all the boards of chassis 121, instead of performing specific operations such as carrier board 133.

In some embodiments, at different time instances, chassis 121 can have a power budget value for the board, as indicated by power budget 1724-21 at time T21, power budget 1724-23 at time T23, power budget 1724-25 at time T25, and a power budget 1724-2e at time TC (expiration).

In some embodiments, at a first board chassis instance T21, PMU 1721 can receive a power consumption indicator 1722-21 based on a power consumption of chassis 121 at time T21.

In some embodiments, in response to power consumption indicator 1722-21 exceeding power budget 1724-21 for chassis 121, PMU 1721 can issue a PMU instruction 1739 to adjust a performance mechanism for one or more computing nodes of chassis 121. In some embodiments, PMU 1721 can adjust performance indicator 1708-21 of computing node 255a at time T21 to a performance indicator 1708-22 at time T22 to reduce the power consumption by computing node 255a. In addition, PMU 1721 can adjust performance indicator 1708b-21 of computing node 255b at time T21 to a performance indicator 1708b-22 at time T22 to reduce the power consumption by computing node 255b. PMU 1721 can adjust performance indicator for other computing nodes of carrier board 133 as well (not shown). In addition, PMU 1721 can adjust performance indicator 1718a-21 of computing node of card 1751 of carrier board k at time T21 to a performance indicator 1718a-22 at time T22 to reduce the power consumption by computing node of card 1751 of carrier board k. PMU 1721 can further adjust performance indicator 1718b-21 of computing node of card 1752 of carrier board k at time T21 to a performance indicator 1718b-22 at time T22 to reduce the power consumption by computing node of card 1751 of carrier board k. PMU 1721 can adjust performance indicator for other computing nodes of cards of carrier board k or other boards (not shown).

In some embodiments, T22 is a time instance when the adjustment made by PMU 1721 can take effect. In some embodiments, a gap between time T21 and time T22 can be less than 10 clock cycles or another number of clock cycles to execute the instruction by PMU 1721 to adjust the performance mechanism. In some embodiments, the performance mechanism being adjusted for computing nodes can be clock speed. In some embodiments, computing node 255a can operate at a first clock speed at time T21, and PMU 1721 can adjust the clock speed of clock 1705 so that computing node 255a can operate at a second clock speed slower than the first clock speed at time T22. Other computing nodes can perform similar adjustments of their clock speed.

In some embodiments, PMU 1721 of chassis 121 can work with PMU 1731 of rack 111 in coordination with the detection of power consumption indicator 1722-21 exceeding power budget 1724-21 for chassis 121. In order for PMU 1721 of chassis 121 to adjust the clock speed of one or more cards of chassis 121, PMU 1731 can determine that a power consumption indicator 1732-21 for rack 111 at time T21 does not exceed a power budget 1734-21 for rack 111 at time T21. If PMU 1731 determines that power consumption indicator 1732-21 for rack 111 at time T21 exceeds power budget 1734-21, PMU 1731 can take further actions beyond adjusting performance of devices of rack 111, where the further action can include adjusting performance of devices on additional chassis.

In some embodiments, PMU 1721 of chassis 121 can receive a power consumption indicator 1722-23 at a third board time instance T23 based on a power consumption of chassis 121 at time T23 after time T22. In response to power consumption indicator 1722-23 at time T23 being below a power budget 1724-23 for chassis 121, PMU 1721 can return the performance mechanism for one or more computing nodes of carrier board 133. In some embodiments, PMU 1721 can return the performance mechanism for computing node 255a from the second performance indicator 1708-22 to performance indicator 1708-21 at a fourth time instance T24 after T23 and can further return computing node 255b from the second performance indicator 1708b-22 to performance indicator 1708b-21 at time T24. Similarly, PMU 1721 can return the performance mechanism for card 1751 from the second performance indicator 1718a-22 to performance indicator 1718a-21 at time T24 after time T23, and can further return card 1752 from the second performance indicator 1718b-22 to performance indicator 1718b-21 at time T24. At time instance T24, computing node 255a can return to the normal operation with performance indicator 1708-21, while other computing nodes can return to the normal operation as well. Afterwards, PMU 1721 can continue to monitor and control the operations of computing nodes of chassis 121.

In some embodiments, PMU 1721 of chassis 121 can collect a power consumption indicator 1722-25 at a fifth time instance T25 based on a power consumption of computing nodes of chassis 121, where time T25 is after time T24. PMU 1721 can determine that power consumption indicator 1722-25 at time T25 exceeds a power budget 1724-25 for chassis 121. PMU 1721 can further determine a time gap between time instances T21 and T25. In response to the time gap between time instances T21 and T25 being shorter than a predetermined gap for recurrence for power consumption over the power budget, PMU 1721 can report an error. In response to the error being determined and reported, PMU 1721 can further shut down or turn off one or more computing nodes of chassis 121. Other actions can be taken to reduce the power consumption for computing nodes of chassis 121.

In some embodiments, in response to determining that power consumption indicator 1722-21 at time T21 exceeds power budget 1724-21 at time T1, PMU 1721 of chassis 121 can start a timer 1723 for a predetermined time period. In some embodiments, timer 1723 can be started or managed by BMC 135 or another controller of chassis 121. At an expiration time instance TC (expiration) corresponding to timer 1723 reaching the predetermined time period TC (expiration), PMU 1721 can collect a power consumption indicator 1722-2e based on the power consumption of computing nodes of chassis 121 at time TC (expiration). In response to determining that power consumption indicator 1722-2e exceeds a power budget 1724-2e at time TC (expiration), PMU 1721 can turn off power to one or more computing nodes of chassis 121.

FIG. 18 illustrates the details of a controller 1801 within a chassis having a bootloader with multiple partial bootloaders, according to some embodiments. In some embodiments, controller 1801 can be an example of a controller of a card of any carrier board of a chassis, e.g., controller 153, controller 153a of card 151a of board 133 of chassis 121, controller 253a of card 251, or other controllers on a card, a board, or within a chassis.

In some embodiments, controller 1801 can include a storage device 1821 coupled to a processor 1819. A firmware 1813 can be operated by processor 1819 to support application software, such as an application 1811 stored in an application storage area 1822 within storage device 1821. Application 1811 can be operated by processor 1819 and booted by firmware 1813. In some embodiments, an application can be an application software operated by a processor. Furthermore, storage device 1821 can be divided into a few different areas, such as a data storage area 1831, a first bootloader storage area 1833, a second bootloader storage area 1835, a third bootloader storage area 1837, and application storage area 1822. In some embodiments, storage device 1821 can include a non-volatile memory storage device. In some embodiments, the non-volatile memory storage device may include one or more of the following non-volatile memories, e.g., an electrically erasable programmable read-only memory (EEPROM), such as a flash memory, a phase change random access memory (PRAM), a resistance random access memory (RRAM), a nano floating gate memory (NFGM), a polymer random access memory (PoRAM), a magnetic random access memory (MRAM), and a ferroelectric random access memory (FRAM), etc. In some embodiments, storage device 1821 can include a volatile memory storage device, such as a dynamic random access memory (DRAM) device, and/or a static random access memory (SRAM) device. In some embodiments, storage device 1821 can be a single storage device including multiple portions. In some embodiments, storage device 1821 can include multiple different storage devices physically separated in different packages while being referred to as storage device 1821.

In some embodiments, firmware or application software, such as application 1811 or firmware 1813, can be booted by a bootloader 1802. In some embodiments, firmware 1813 can perform hardware initialization during the boot process, such as during power-on startup, providing runtime services for operating system, programs, or application software. Firmware 1813 can include a bare metal runtime, platform hardware abstractions, and applications. Firmware is thus lower-level computer-executable code than operating systems and can be responsible for starting up the hardware of a computing device prior to starting the operating system. Firmware can further provide services to the operating system of a computing device, including power management and other services. Types of firmware for the primary processing subsystem of a computing device can include the basic input/output system (BIOS), the unified extensible firmware interface (UEFI), or other suitable firmware. Firmware distribution and installation can post challenges.

In some embodiments, bootloader 1802 can be stored in a server 1810. In some embodiments, server 1810 can be an example of BMC 135 of chassis 121 or other servers, such as a factory server. In some embodiments, bootloader 1802 can be instructions executable by processor 1819 to boot/load an operating system 1817 or application 1811. In some embodiments, bootloader 1802 may be hardcoded or fused instructions executable by processor 1819 to boot/load an operating system. Further, in some embodiments, bootloader may refer to the set of instructions, a software object containing the instructions, the area of memory storing the instructions, or the component and/or controller responsible for executing the boot/load instructions. In addition, bootloader can be a combination of hardware and software performing the functions described herein. Accordingly, bootloader can include concrete hardware such as transistors and/or software code executing on hardware. Accordingly, bootloader 1802 may perform a boot sequence that includes handling initializing hardware on controller 1801, performing one or more verification checks, initiating the execution of the operating system kernel, etc. In some embodiments, bootloader 1802 can further verify configuration settings during the boot process in order to, for example, ensure that settings have not been altered in an unauthorized manner. As will be described below, bootloader 1802 can verify configuration settings using a security signature along with a public key included in a security certificate.

In some embodiments, bootloader 1802 can include a first partial bootloader 1803 and a second partial bootloader, such as a second partial bootloader 1809. In some embodiments, first partial bootloader 1803 can be compact and include minimal bootloader program to perform minimal functionality, as discussed in the current disclosure. In some embodiments, a first partial bootloader may be referred by the same name but perform different functionalities from other first partial bootloaders. Accordingly, the first partial bootloaders can perform different functions from one another. In some embodiments, first partial bootloader 1803 can be stored in first bootloader storage area 1833 and remain unchanged while second partial bootloader 1809 can be stored in second bootloader storage area 1835 or third bootloader storage area 1837 and can be changed over time. Hence, different versions of second partial bootloader 1809 can be created to become a set of second partial bootloaders 1804. Accordingly, in some embodiments, bootloader 1802 can include a set of second partial bootloaders 1804, where a second partial bootloader 1805 can be an initial second partial bootloader. The set of second partial bootloaders 1804 can further include a set of updated second partial bootloaders, such as an updated second partial bootloader 1807. In some embodiments, a second partial bootloader of the set of second partial bootloaders 1804 can include an associated version identifier. For example, initial second partial bootloader 1805 can have an initial version identifier 1806 as an associated version identifier. Similarly, updated second partial bootloader 1807 can have an updated version identifier 1808 as an associated version identifier. In some embodiments, the set of second partial bootloaders 1804 can further include a device-specific version of the second partial bootloader, which can be denoted as device specific second partial bootloader 1812 that is generated by certificate authority 141 based on device identifier 1824. In some embodiments, device specific second partial bootloader 1812 can have a device specific version identifier 1814 as an associated version identifier. In some embodiments, each second partial bootloader of the set of second partial bootloaders 1804 can have an associated version identifier.

In some embodiments, first bootloader storage area 1833 can store first partial bootloader 1803 at a time of manufacturing or during a time of manufacturing before controller 1801 is deployed (referred to herein as “manufacturing time”). Similarly, data storage area 1831 can store security data 1832 provided at manufacturing time for security operations performed by first partial bootloader 1803. In some embodiments, security data 1832 can include various security parameters, such as a public root key, a local private key, one or more security tags, a chip identifier, a board serial number, a device identifier, a nonce, a card identifier, a controller identifier, and other suitable security parameters. In some embodiments, data storage area 1831 can store a device identifier 1824, which can be a pin strap or a unique identifier assigned to controller 1801. Accordingly, different controllers can have a different device identifier. In addition, second bootloader storage area 1835 can store a first copy 1836 of second partial bootloader 1809, while third bootloader storage area 1837 can store a second copy 1838 of second partial bootloader 1809. In some embodiments, first copy 1836 of the second partial bootloader and second copy 1838 of the second partial bootloader can have the same content of second partial bootloader 1809. In some embodiments, first copy 1836 and second copy 1838 can store the same content as initial second partial bootloader 1805 having initial version identifier 1806. In some embodiments, first copy 1836 of the second partial bootloader can be stored in second bootloader storage area 1835 at manufacturing time, and second copy 1838 of the second partial bootloader can be stored in third bootloader storage area 1837 at manufacturing time. Accordingly, both first copy 1836 and second copy 1838 are stored at manufacturing time as an inactive second partial bootloader before controller 1801 is deployed. After controller 1801 is deployed, one of first copy 1836 and second copy 1838 can be selected to be an active second partial bootloader and in operation. Accordingly, saving both first copy 1836 and second copy 1838 into two different bootloader storage areas can be useful in speeding up the boot process. In some embodiments, first partial bootloader 1803 performs only a selection function to select one of first copy 1836 and second copy 1838 to boot. In some embodiments, if only one copy of second partial bootloader is saved, first partial bootloader 1803 would not be able to perform the selection function between first copy 1836 and second copy 1838 of the second partial bootloader.

In some embodiments, first copy 1836 and second copy 1838 can be members of set of second partial bootloaders 1804 with different associated version identifiers. In some embodiments, first bootloader storage area 1833 can be locked at manufacturing time to be in an immutable state after controller 1801 is deployed, and data storage area 1831 can also be locked at manufacturing time to be in the immutable state. Consistent with some embodiments, an immutable state is a state that cannot be changed after an object, such as first bootloader storage area 1833, is created. Accordingly, data storage area 1831 and first bootloader storage area 1833 can be in a permanently locked region 1823.

In some embodiments, first partial bootloader 1803 can boot a selected copy 1841 of the second partial bootloader, where selected copy 1841 of the second partial bootloader can be selected from first copy 1836 of the second partial bootloader and second copy 1838 of the second partial bootloader. In some embodiments, selected copy 1841 of the second partial bootloader can boot firmware 1813 for application 1811 operated by controller 1801 or processor 1819 in response to selected copy 1841 of the second partial bootloader being in operation. In some embodiments, first partial bootloader 1803 can include a security flag 1834 indicating whether a secure boot of selected copy 1841 of the second partial bootloader is implemented. Selected copy 1841 may not be a separate copy from first copy 1836 or second copy 1838. Instead, selected copy 1841 can be a decision that one of first copy 1836 or second copy 1838 is selected for operation. Accordingly, first partial bootloader 1803 may only perform the selection function to determine which one of first copy 1836 or second copy 1838 to be selected copy 1841, and first partial bootloader 1803 may further authenticate and boot selected copy 1841 of second partial bootloader. Therefore, first partial bootloader 1803 may not need to download first copy 1836 or second copy 1838 since first copy 1836 or second copy 1838 may have been stored in storage device 1821 already. Accordingly, the operation efficiency can be improved when first partial bootloader 1803 does not download first copy 1836 or second copy 1838.

In some embodiments, selected copy 1841 of the second partial bootloader can always be first copy 1836 of the second partial bootloader stored in second bootloader storage area 1835. Accordingly, first copy 1836 stored in second bootloader storage area 1835 can have a priority in being selected for booting firmware 1813 over second copy 1838. In some embodiments, selected copy 1841 of the second partial bootloader can be second copy 1838 of the second partial bootloader stored in third bootloader storage area 1837 in response to a failure to authenticate first copy 1836 of the second partial bootloader.

In some embodiments, second bootloader storage area 1835 can be write protected in response to selected copy 1841 of the second partial bootloader being first copy 1836 of the second partial bootloader stored in second bootloader storage area 1835. Similarly, third bootloader storage area 1837 can be write protected in response to selected copy 1841 of the second partial bootloader being second copy 1838 of the second partial bootloader stored in third bootloader storage area 1837. In some embodiments, first partial bootloader 1803 can be locked in first bootloader storage area 1833 by selected copy 1841 of the second partial bootloader, and security data 1832 can be locked in data storage area 1831 by selected copy 1841 of the second partial bootloader. In some embodiments, first partial bootloader 1803 and security data 1832 can be locked by firmware 1813 that sets the permanent lock of first bootloader storage area 1833 and security data storage areas, which can be achieved through a factory data service that runs only in the application.

In some embodiments, to implement the secure boot of selected copy 1841 of the second partial bootloader, first partial bootloader 1803 can authenticate selected copy 1841 of the second partial bootloader before booting selected copy 1841 of the second partial bootloader. In addition, selected copy 1841 of the second partial bootloader can authenticate firmware 1813 for application 1811 before booting firmware 1813 for application 1811.

In some embodiments, first copy 1836 of the second partial bootloader and second copy 1838 of the second partial bootloader can be copies of members of the set of second partial bootloaders 1804. In some embodiments, first copy 1836 of the second partial bootloader has a first version identifier, second copy 1838 of the second partial bootloader has a second version identifier, and selected copy 1841 of the second partial bootloader can be first copy 1836 of the second partial bootloader in response to the first version identifier representing first copy 1836 of the second partial bootloader being an updated version of second copy 1838 of the second partial bootloader having the second version identifier. In some embodiments, when the first version identifier, which can be a first number, is bigger than the second version identifier that can be a second number, first copy 1836 can be an updated version of second copy 1838. In some embodiments, first copy 1836 can be an updated version of second copy 1838 when the first version identifier is smaller than the second version identifier.

In some embodiments, device-specific version 1812 of the second partial bootloader can be stored in second bootloader storage area 1835 at manufacturing time. In some embodiments, second copy 1838 of the second partial bootloader stored in third bootloader storage area 1837 can be device-specific version 1812 of the second partial bootloader. In some embodiments, device-specific version 1812 of the second partial bootloader can be received from certificate authority 141 through an instruction processing device, such as BMC 135, that is configured to manage operations of a set of computing devices of chassis 121 including one or more boards, such as carrier board 135. At least one board of the one or more boards can include a set of cards such as card 151. At least one card of the set of cards can include controller 1801 and a processing device.

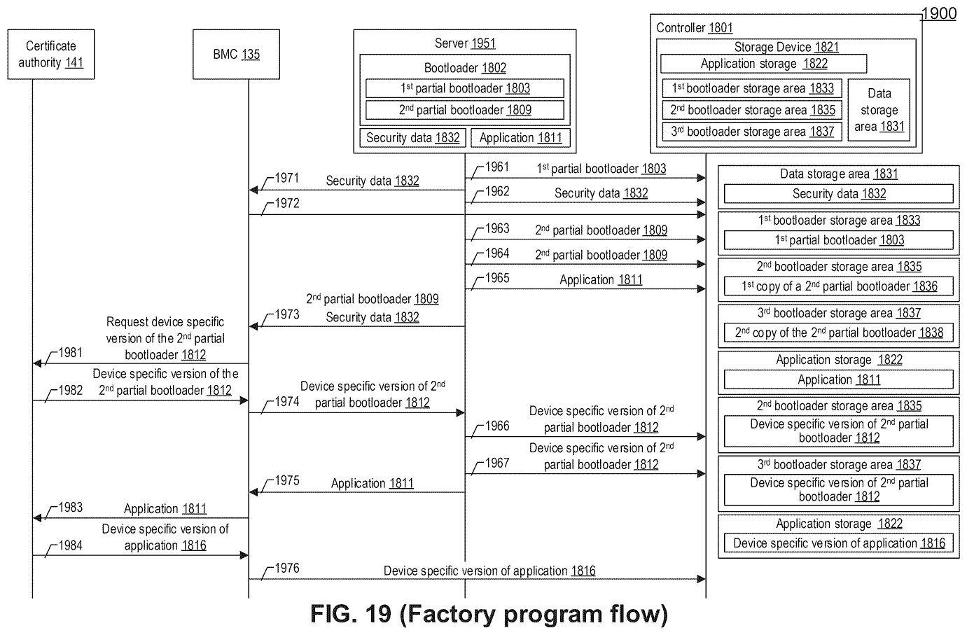

FIG. 19 illustrates a program flow 1900 for programming bootloader 1802 with multiple partial bootloaders into a controller of a chassis, according to some embodiments. In some embodiments, bootloader 1802 can be programmed into controller 1801 of chassis 121. It is to be appreciated that not all operations of program flow 1900 may be needed to perform the disclosure provided herein. Further, some of the operations may be performed simultaneously, or in a different order than shown in FIG. 19.

In some embodiments, a server 1951 can be a server in a factory or a facility that programs controller 1801. In some embodiments, server 1951 can be in a facility operated by a business entity while controller 1801 can be a controller manufactured by another business entity. Server 1951 can be an example of server 1810 and can include bootloader 1802 having first partial bootloader 1803 and second partial bootloader 1809, security data 1832, application 1811, and any other suitable security or bootloader related data or applications. In some embodiments, there can be other versions of second partial bootloaders included in bootloader 1802. Controller 1801 can include storage device 1821 divided into data storage area 1831, first bootloader storage area 1833, second bootloader storage area 1835, and third bootloader storage area 1837. In addition, server 1951 can be in communication with certificate authority 141, BMC 135, and controller 1801 to perform operations of program flow 1900. Before program flow 1900 starts, data storage area 1831, first bootloader storage area 1833, second bootloader storage area 1835, and third bootloader storage area 1837 may not contain data or program for bootloader 1802 or security data 1832.

In some embodiments, at operation 1961, server 1951 can store, in first bootloader storage area 1833 of storage device 1821, first partial bootloader 1803 of bootloader 1802 at a manufacturing time before controller 1801 is deployed.

In some embodiments, at operation 1962, server 1951 can store, in data storage area 1831, security data 1832 provided at manufacturing time for security operations performed by first partial bootloader 1803. In some embodiments, at operation 1971, server 1951 can provide security data 1832 to BMC 135. At operation 1972, BMC 135 can provide security data 1832 to controller 1801.

In some embodiments, at operation 1963, server 1951 can store, in second bootloader storage area 1835, first copy 1836 of second partial bootloader 1809.

In some embodiments, at operation 1964, server 1951 can store, in third bootloader storage area 1837, second copy 1838 of second partial bootloader 1809.

In some embodiments, first copy 1836 and second copy 1838 can be copies of the same second partial bootloader 1809. In some embodiments, second partial bootloader 1809 can be initial second partial bootloader 1805 provided by server 1951 at manufacturing time before controller 1801 is deployed. After controller 1801 is deployed, there can be updated version of second partial bootloader generated by BMC 135. Accordingly, in server 1951, bootloader 1802 can have two components: first partial bootloader 1803 and second partial bootloader 1809. At manufacturing time, server 1951 can generate two copies of the same second partial bootloader 1809 and store the two copies, first copy 1836 and second copy 1838, into two different storage areas of storage device 1821. Having two copies of the same second partial bootloader 1809 (e.g., first copy 1836 and second copy 1838) can provide redundancy and additional security for operations of controller 1801.

In some embodiments, at operation 1965, server 1951 can store, in storage device 1821, application 1811 in controller 1801. In some embodiments, application 1811 can be booted by bootloader 1802 as described herein.

In some embodiments, to increase the security of the operations for controller 1801, controller 1801 can facilitate the generation of device specific version of second partial bootloader 1812, instead of the generic second partial bootloader 1809, as described below.

In some embodiments, at operation 1973, server 1951 can transfer second partial bootloader 1809 and security data 1832 to BMC 135. At operation 1981, BMC 135 can send a request for a device specific version of second partial bootloader together with second partial bootloader 1809 and security data 1832 to certificate authority 141. Certificate authority 141 can generate device specific version of second partial bootloader 1812 upon receiving the request from BMC.

At operation 1982, certificate authority 141 can transmit device specific version of second partial bootloader 1812 to BMC 135. At operation 1974, BMC 135 can transmit a device specific version of second partial bootloader 1812 to server 1951. At operation 1966, server 1951 can store the device specific version of second partial bootloader 1812 in second bootloader storage area 1835. In addition, at operation 1967, server 1951 can store device specific version of second partial bootloader 1812 into third bootloader storage area 1837.

In some embodiments, at operation 1975, server 1951 can send application 1811 to BMC 135, which can be transmitted to certificate authority 141 at operation 1983. Certificate authority 141 can generate a device specific version of application 1816 and further transmit device specific version of application 1816 to BMC 135 at operation 1984. Afterwards, at operation 1976, BMC 135 can transmit device specific version of application 1816 to controller 1801 to be stored in storage device 1822.

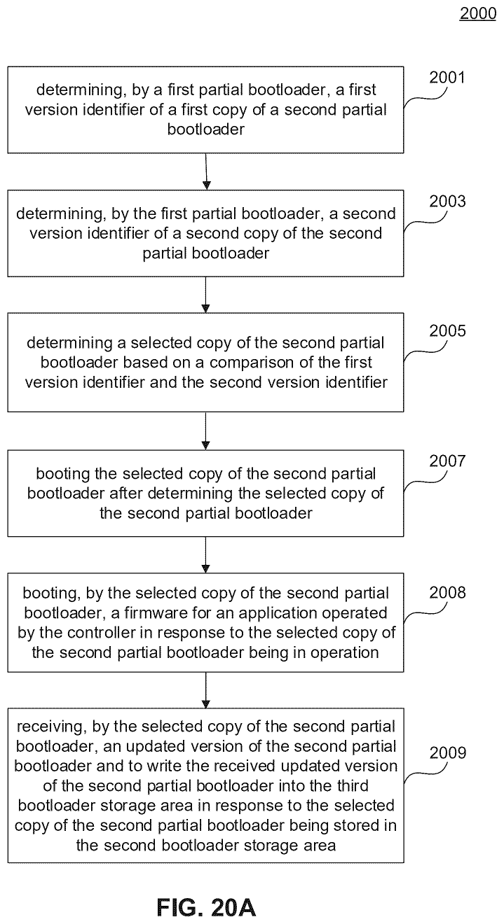

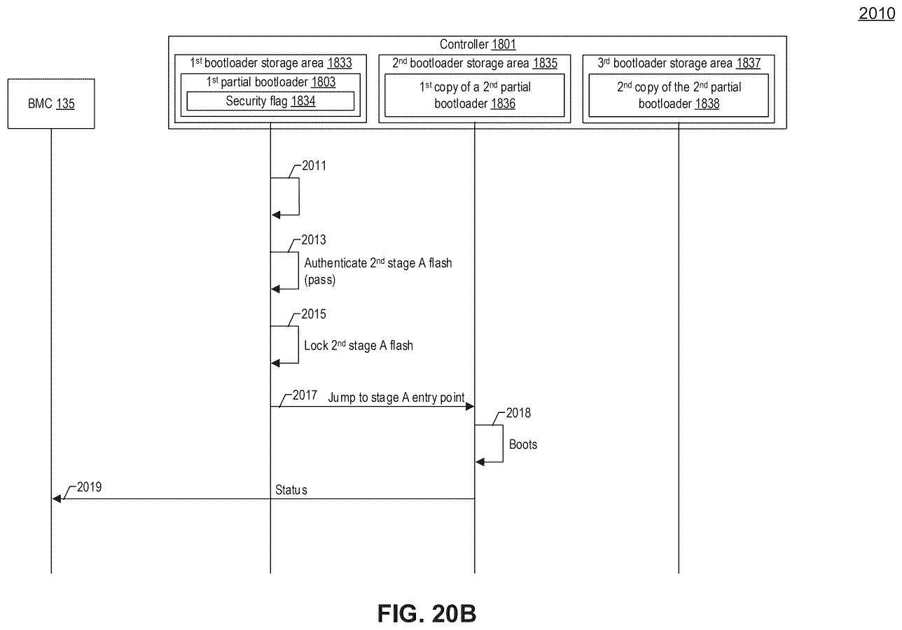

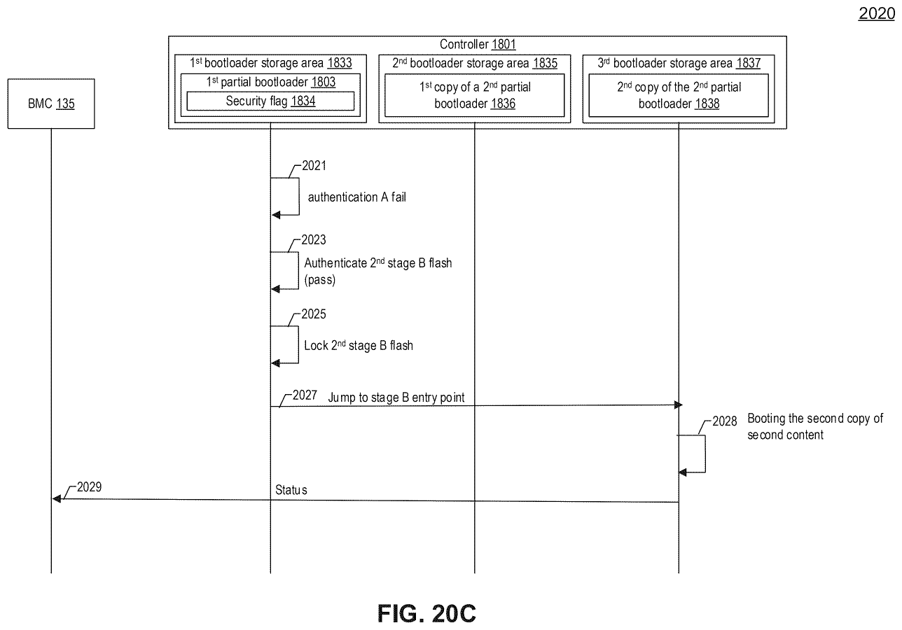

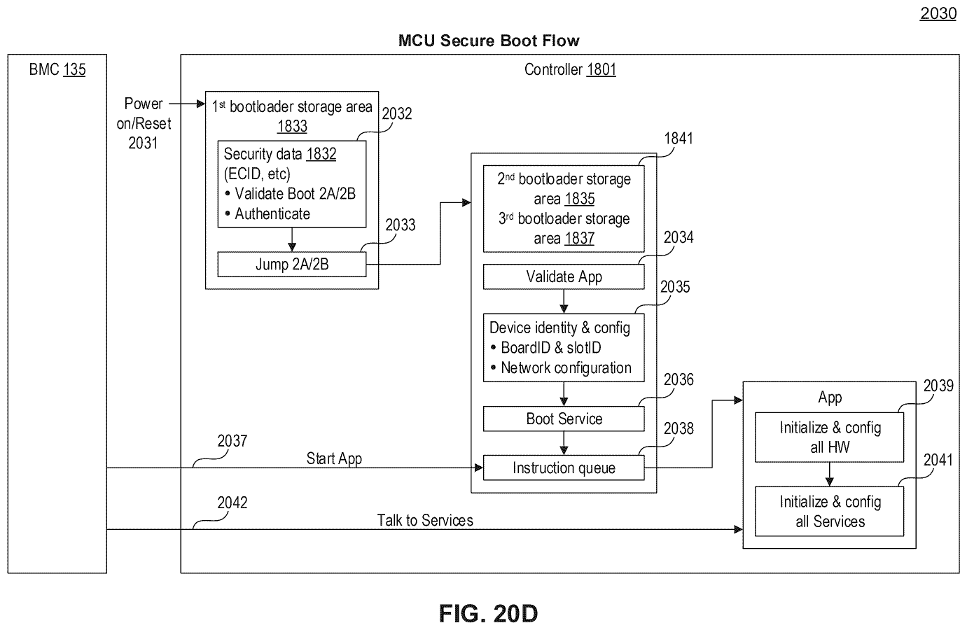

FIGS. 20A-20D illustrate processes for booting firmware for an application by a controller having a bootloader with multiple partial bootloaders, according to some embodiments. It is to be appreciated that not all operations of the processes shown may be needed to perform the disclosure provided herein. Further, some of the operations may be performed simultaneously, or in a different order than shown in FIGS. 20A-20D.

FIG. 20A illustrates a process 2000 that can be performed by bootloader 1802 for booting firmware for an application by controller 1801, where bootloader 1802 can include first partial bootloader 1803 and a second partial bootloader, which can be a second partial bootloader of set of second partial bootloaders 1804. In some embodiments, process 2000 can be used to boot firmware 1815.

At operation 2001, first partial bootloader 1803 can determine a first version identifier of first copy 1836 of the second partial bootloader stored in second bootloader storage area 1835. In some embodiments, first copy 1836 of the second partial bootloader is a member of set of second partial bootloaders 1804 with a first version identifier.

At operation 2003, first partial bootloader 1803 can determine a second version identifier of second copy 1838 of the second partial bootloader stored in third bootloader storage area 1837.

At operation 2005, selected copy 1841 of the second partial bootloader can be determined based on a comparison of the first version identifier and the second version identifier. In some embodiments, the determination of selected copy 1841 can be based on security flag 1834. There can be multiple ways to determine selected copy 1841 based on a comparison of the first version identifier and the second version identifier, which can be described below.

At operation 2007, first partial bootloader 1803 can boot selected copy 1841 of the second partial bootloader.

At operation 2008, selected copy 1841 of the second partial bootloader can boot firmware 1813 for application 1811 operated by controller 1801 in response to selected copy 1841 of the second partial bootloader being in operation.

At operation 2009, selected copy 1841 of the second partial bootloader can receive an updated version of the second partial bootloader. Afterwards, selected copy 1841 of the second partial bootloader can write the received updated version of the second partial bootloader into third bootloader storage area 1837 in response to selected copy 1841 of the second partial bootloader being stored in second bootloader storage area 1835. Similarly, selected copy 1841 of the second partial bootloader can write the received updated version of the second partial bootloader into second bootloader storage area 1835 in response to selected copy 1841 of the second partial bootloader being stored in third bootloader storage area 1837.

FIG. 20B illustrates a process 2010 that can be performed by bootloader 1802 for booting a firmware for an application by controller 1801, where bootloader 1802 can include first partial bootloader 1803 and a second partial bootloader. First copy 1836 of the second partial bootloader can be stored in second bootloader storage area 1835, while second copy 1838 of the second partial bootloader can be stored in third bootloader storage area 1837. Both first copy 1836 of the second partial bootloader and second copy 1838 of the second partial bootloader can be selected from a set of second partial bootloaders 1804. Process 2010 can be an example of process 2000 shown in FIG. 20A.

At operation 2011, first partial bootloader 1803 can determine a first version identifier of first copy 1836 of the second partial bootloader stored in second bootloader storage area 1835. In addition, first partial bootloader 1803 can determine a second version identifier of second copy 1838 of the second partial bootloader stored in third bootloader storage area 1837. Accordingly, it can be determined, e.g., based on security flag 1834, the first version identifier is equal to the second version identifier. Accordingly, selected copy 1841 of the second partial bootloader can be determined to be first copy 1836 of the second partial bootloader.

At operation 2013, first partial bootloader 1803 can perform authentication of selected copy 1841, which is first copy 1836 of the second partial bootloader. In some embodiments, first partial bootloader 1803 can perform authentication of first copy 1836 generated by certificate authority 141.

At operation 2015, first partial bootloader 1803 can perform operations to lock second bootloader storage area 1835, which can be a flash storage area. Accordingly, first partial bootloader 1803 can enable second bootloader storage area 1835 to be write protected in response to selected copy 1841 of the second partial bootloader being the first copy 1836 of the second partial bootloader stored in second bootloader storage area 1835.

At operation 2017, first partial bootloader 1803 can transfer control to first copy 1836 of the second partial bootloader. In some embodiments, the control can be transferred to an entry point of first copy 1836 of the second partial bootloader.

At operation 2018, first copy 1836 of the second partial bootloader can boot itself from the entry point. In addition, first copy 1836 can boot firmware 1813 for application 1811 operated by controller 1801 in response to first copy 1836 of the second partial bootloader being in operation.

At operation 2019, first copy 1836 of the second partial bootloader can communicate the operational status of firmware 1813 for application 1811 to BMC 135.

FIG. 20C illustrates a process 2020 that can be performed by bootloader 1802 for booting a firmware for an application by controller 1801, where bootloader 1802 can include first partial bootloader 1803 and a second partial bootloader. First copy 1836 of the second partial bootloader is stored in second bootloader storage area 1835, while second copy 1838 of the second partial bootloader is stored in third bootloader storage area 1837. Both first copy 1836 of the second partial bootloader and second copy 1838 of the second partial bootloader can be selected from set of second partial bootloaders 1804. Process 2020 can be an example of process 2000 shown in FIG. 20A.

At operation 2021, first partial bootloader 1803 can determine a first version identifier of first copy 1836 of the second partial bootloader stored in second bootloader storage area 1835. In addition, first partial bootloader 1803 can determine a second version identifier of second copy 1838 of the second partial bootloader stored in third bootloader storage area 1837. In some embodiments, first version identifier of first copy 1836 and second version identifier of second copy 1838 are numbers, such as integers. In some embodiments, it can be determined, based on security flag 1834, that the first version identifier is less than the second version identifier, where a bigger version identifier indicates an updated version of the second partial bootloader. Accordingly, it can be determined that selected copy 1841 of the second partial bootloader is second copy 1838 of the second partial bootloader. In some embodiments, it can be determined that the first version identifier is larger than or equal to the second version identifier. In such a case, selected copy 1841 of the second partial bootloader can be first copy 1836. Afterwards, first partial bootloader 1803 can perform authentication of first copy 1836 but the authentication may fail. Accordingly, first partial bootloader 1803 can further determine selected copy 1841 of the second partial bootloader to be second copy 1838 of the second partial bootloader.

At operation 2023, first partial bootloader 1803 can perform authentication of selected copy 1841, which is second copy 1838 of the second partial bootloader. In some embodiments, first partial bootloader 1803 can perform authentication of second copy 1838 generated by certificate authority 141.

At operation 2025, first partial bootloader 1803 can perform operations to lock third bootloader storage area 1837, which can be a flash storage area. Accordingly, first partial bootloader 1803 can enable third bootloader storage area 1837 to be write protected in response to selected copy 1841 of the second partial bootloader being second copy 1838 of the second partial bootloader stored in third bootloader storage area 1837.

At operation 2027, first partial bootloader 1803 can transfer control to second copy 1838 of the second partial bootloader. In some embodiments, the control can be transferred to an entry point of second copy 1838 of the second partial bootloader.

At operation 2028, second copy 1838 of the second partial bootloader can boot itself from the entry point. In addition, second copy 1838 can boot firmware 1813 for application 1811 operated by controller 1801 in response to second copy 1838 of the second partial bootloader being in operation.

At operation 2029, second copy 1838 of the second partial bootloader can communicate the operational status of firmware 1813 for application 1811 to BMC 135.

FIG. 20D illustrates a process 2030 that can be performed by bootloader 1802 for booting a firmware for an application by controller 1801, where bootloader 1802 can include first partial bootloader 1803 and a second partial bootloader. First copy 1836 of the second partial bootloader is stored in second bootloader storage area 1835, while second copy 1838 of the second partial bootloader is stored in third bootloader storage area 1837. Both first copy 1836 of the second partial bootloader and second copy 1838 of the second partial bootloader can be selected from set of second partial bootloaders 1804. Process 2030 can be an example of process 2000 shown in FIG. 20A.

At operation 2031, first partial bootloader 1803 stored in first bootloader storage area 1833 can be started or reset. First partial bootloader 1803 can further determine selected copy 1841 of the second partial bootloader for booting.

At operation 2032, authentication and validation can be performed on selected copy 1841 of the second partial bootloader, which can either be first copy 1836 of the second partial bootloader stored in second bootloader storage area 1835 or second copy 1838 of the second partial bootloader stored in third bootloader storage area 1837. In some embodiments, the authentication or validation can be performed based on secure data 1832, such as device identifier 1824.

At operation 2033, first partial bootloader 1803 can transfer control to selected copy 1841 of the second partial bootloader that is either first copy 1836 of the second partial bootloader stored in second bootloader storage area 1835 or second copy 1838 of the second partial bootloader stored in third bootloader storage area 1837. In addition, selected copy 1841 can continue to boot itself in second bootloader storage area 1835 or third bootloader storage area 1837.

At operation 2034, selected copy 1841 of the second partial bootloader can validate application 1811.

At operation 2035, selected copy 1841 of the second partial bootloader can further determine the device identification and configure the device, based on security information such as device identifier, slot identifier for board. In addition, selected copy 1841 of the second partial bootloader can further perform network configuration.

At operation 2036, selected copy 1841 of the second partial bootloader can further boot firmware 1813 for providing application services.

At operation 2037, BMC 135 can issue an instruction to start application 1811, which can be saved into an instruction queue at operation 2038.

At operation 2039, application 1811 can be initialized and hardware components can be configured. At operation 2041, application 1811 can initialize and configure all services. At operation 2042, BMC 135 can talk to application 1811 to access any service provided by application 1811.

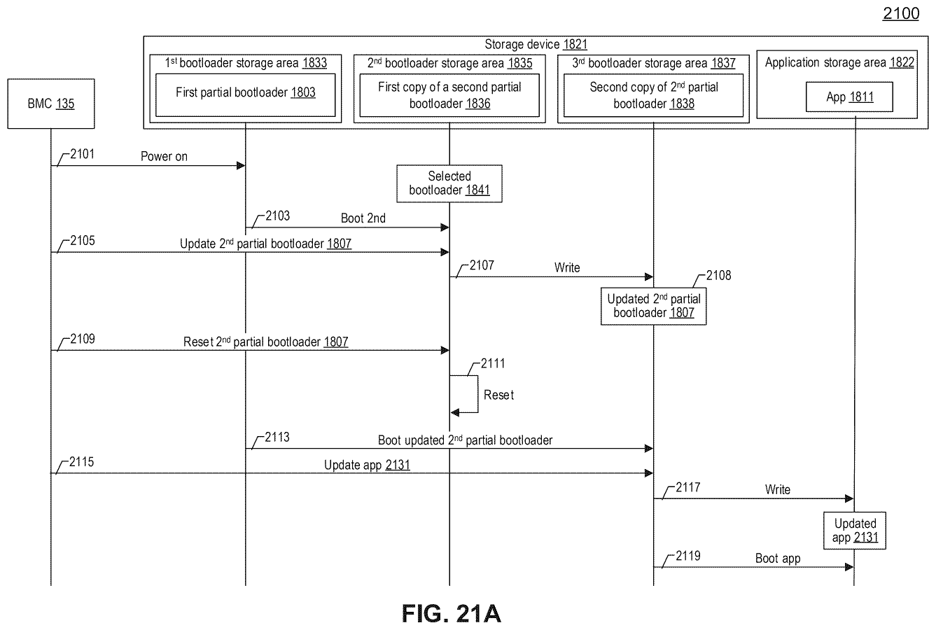

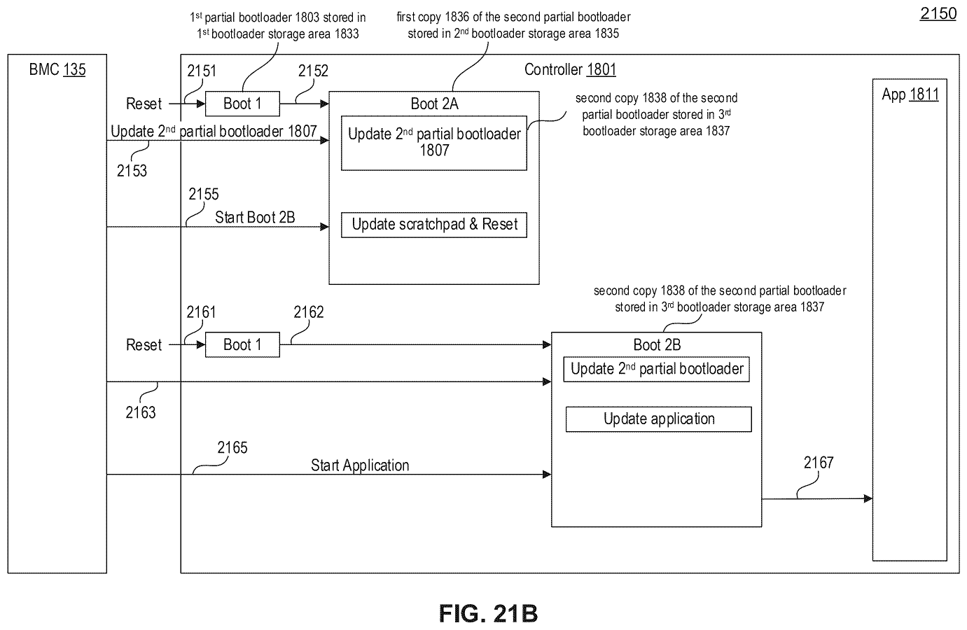

FIGS. 21A-21B illustrate processes for updating a partial bootloader of a bootloader with multiple partial bootloaders operated by a controller, according to some embodiments. It is to be appreciated that not all operations of the processes shown may be needed to perform the disclosure provided herein. Further, some of the operations may be performed simultaneously, or in a different order than shown in FIGS. 21A-21B.

FIG. 21A illustrates a process 2100 for updating a partial bootloader of bootloader 1802 with multiple partial bootloaders operated by controller 1801, where bootloader 1802 can include first partial bootloader 1803 and a second partial bootloader. First copy 1836 of the second partial bootloader is stored in second bootloader storage area 1835, while second copy 1838 of the second partial bootloader is stored in third bootloader storage area 1837. Both first copy 1836 of the second partial bootloader and second copy 1838 of the second partial bootloader can be members of second partial bootloaders 1804.

At operation 2101, first partial bootloader 1803 stored in first bootloader storage area 1833 can be started, reset, or powered on by BMC 135. First partial bootloader 1803 can further determine selected copy 1841 of the second partial bootloader for booting. In some embodiments, first partial bootloader 1803 can determine first copy 1836 of the second partial bootloader is selected as selected copy 1841 of the second partial bootloader. In some embodiments, first partial bootloader 1803 can determine second copy 1838 of the second partial bootloader is selected as selected copy 1841 of the second partial bootloader, which is not shown in FIG. 21A.

At operation 2103, first partial bootloader 1803 can boot selected copy 1841 of the second partial bootloader, which is first copy 1836 of the second partial bootloader. In some embodiments, first partial bootloader 1803 can boot selected copy 1841 of the second partial bootloader, which can be second copy 1838 of the second partial bootloader (not shown).

At operation 2105, BMC 135 can transmit updated second partial bootloader 1807 to be received by first copy 1836 of the second partial bootloader that is in operation.

At operation 2107, first copy 1836 of the second partial bootloader can write received updated second partial bootloader 1807 into third bootloader storage area 1837. At operation 2108, updated second partial bootloader 1807 can replace the previously-stored second partial bootloader, which is second copy 1838 of the second partial bootloader. Accordingly, updated second partial bootloader 1807 can be stored in storage device 1821 without interrupting the operation of bootloader 1802 with multiple partial bootloaders operated by controller 1801.

At operation 2109, BMC 135 can reset first copy 1836 of the second partial bootloader. In some embodiments, BMC 135 can issue a reset instruction to reset first copy 1836 of the second partial bootloader after updated second partial bootloader 1807 has been stored in storage device 1821. At operation 2111, first copy 1836 of the second partial bootloader can perform the reset operation to stop its own operations.

At operation 2113, first partial bootloader 1803 can boot updated second partial bootloader 1807, which is the newly-selected copy 1841 of the second partial bootloader.

At operation 2115, BMC 135 can transmit updated application 2131 to application storage area 1822 when updated second partial bootloader 1807 is in operation.

At operation 2117, updated second partial bootloader 1807 can write received updated application 2131 in application storage area 1822 of storage device 1821 to replace existing application 1811.

At operation 2119, updated second partial bootloader 1807 can perform operations to boot updated application 2131 or the firmware for updated application 2131.

FIG. 21B illustrates a process 2150 for updating a partial bootloader of bootloader 1802 with multiple partial bootloaders operated by controller 1801, where bootloader 1802 can include first partial bootloader 1803 and a second partial bootloader. First copy 1836 of the second partial bootloader is stored in second bootloader storage area 1835, while second copy 1838 of the second partial bootloader is stored in third bootloader storage area 1837. Both first copy 1836 of the second partial bootloader and second copy 1838 of the second partial bootloader can be members of a set of second partial bootloaders 1804.

At operation 2151, first partial bootloader 1803 stored in first bootloader storage area 1833 can be started, reset, or powered on by BMC 135. First partial bootloader 1803 can further determine selected copy 1841 of the second partial bootloader for booting. In some embodiments, first partial bootloader 1803 can determine first copy 1836 of the second partial bootloader stored in second bootloader storage area 1835 is selected as selected copy 1841 of the second partial bootloader.

At operation 2152, first partial bootloader 1803 can boot selected copy 1841 of the second partial bootloader, which is first copy 1836 of the second partial bootloader stored in second bootloader storage area 1835.

At operation 2153, BMC 135 can transmit updated second partial bootloader 1807 to be received by first copy 1836 of the second partial bootloader that is in operation.

In some embodiments, first copy 1836 of the second partial bootloader can write received updated second partial bootloader 1807 into third bootloader storage area 1837. In some embodiments, updated second partial bootloader 1807 can replace the previously-stored second partial bootloader, which is second copy 1838 of the second partial bootloader. Accordingly, updated second partial bootloader 1807 can be stored in storage device 1821 without interrupting the operation of bootloader 1802 with multiple partial bootloaders operated by controller 1801.

At operation 2155, BMC 135 can boot updated second partial bootloader 1807 stored in third bootloader storage area 1837. In some embodiments, BMC 135 can reset first copy 1836 of the second partial bootloader before booting updated second partial bootloader 1807. In some embodiments, BMC 135 can issue a reset instruction to reset first copy 1836 of the second partial bootloader after updated second partial bootloader 1807 is stored in storage device 1821. In some embodiments, updated second partial bootloader 1807 stored in third bootloader storage area 1837 can perform operations related to updating scratchpad and reset so that updated second partial bootloader 1807 can perform the intended functions. The updating the scratchpad and reset function can lead to operation 2161.

At operation 2161, first partial bootloader 1803 stored in first bootloader storage area 1833 can be started, reset, or powered on by BMC 135. First partial bootloader 1803 can further determine selected copy 1841 of the second partial bootloader for booting. In some embodiments, first partial bootloader 1803 can determine second copy 1838 of the second partial bootloader stored in third bootloader storage area 1837 is selected as selected copy 1841 of the second partial bootloader.

At operation 2162, first partial bootloader 1803 can boot selected copy 1841 of the second partial bootloader, which is second copy 1838 of the second partial bootloader stored in third bootloader storage area 1837.

At operation 2163, BMC 135 can transmit updated second partial bootloader 1807 to be received by second copy 1838 of the second partial bootloader that is in operation.

In some embodiments, second copy 1838 of the second partial bootloader can write received updated second partial bootloader 1807 into second bootloader storage area 1835. In some embodiments, updated second partial bootloader 1807 can replace the previously-stored second partial bootloader, which is first copy 1836 of the second partial bootloader. Accordingly, updated second partial bootloader 1807 can be stored in storage device 1821 without interrupting the operation of bootloader 1802 with multiple partial bootloaders operated by controller 1801. In some embodiments, updated second partial bootloader 1807 stored in second bootloader storage area 1835 can perform operations related to updating scratchpad and reset so that updated second partial bootloader 1807 can perform the intended function.

At operation 2165, BMC 135 can boot updated second partial bootloader 1807 stored in second bootloader storage area 1835. In some embodiments, BMC 135 can reset second copy 1838 of the second partial bootloader before booting updated second partial bootloader 1807. In some embodiments, BMC 135 can issue a reset instruction to reset second copy 1838 of the second partial bootloader after updated second partial bootloader 1807 is stored in storage device 1821. In some embodiments, at operation 2165, BMC 135 can provide an updated application to be saved into application storage area 1822.

At operation 2167, updated second partial bootloader 1807 can boot application 1811. In some embodiments, application 1811 being booted can be the updated application received at operation 2165.

FIG. 22 is an illustration of various phases of operations performed by a data center computing system including a fleet 2201, according to some embodiments. Fleet 2201 can be an example of fleet 101 as shown in FIG. 1. Fleet 2201 can include one or more racks, where rack 2211 is shown as an example. Rack 2211 can include multiple chassis, such as chassis C0, C1, C2, and C3. In some embodiments, a fully-populated rack 2211 can include n chassis, such as 20 chassis. Different operations of the multiple chassis of rack 2211 at different phases are shown in FIG. 22.

In some embodiments, at phase 0, as an initial deployment, no workload task is provisioned on a computing device on a chassis. The chassis can enter the lowest power state that allows for provisioning of any future workloads on the chassis. Accordingly, the BMC of a chassis (e.g., BMC 135 of chassis 121) or chassis status of a chassis (e.g., chassis status 181 of chassis 121) can enter a low power state (e.g., standby state).

In some embodiments, at phase 1, after the chassis is powered on, the BMC of the chassis can receive an update message from a job scheduler (not shown). If the received update message indicates that no SoCs or computing nodes on the chassis are provisioned for a workload task, the chassis can enter the standby state. On the other hand, if the received update message indicates that a SoC or a computing node on the chassis is provisioned for a workload task, the chassis can enter an active state. In some embodiments, not all chassis are active. Workload tasks can be assigned to some of the chassis, but not all. As shown in phase 1, 18 of the 20 chassis have actively provisioned workload tasks. The remaining 2 chassis are not provisioned with workload tasks. Accordingly, chassis C0 and C1 remain in a standby state. In the standby mode, none of the SoCs in the chassis have a provisioned workload. Chassis C2 and beyond are in the active state.

In some embodiments, at phase 2, an unrecoverable fault is detected on chassis C2, either by a job scheduler or by software running on the BMC of chassis C2. This fault can be detected on one or more computing nodes or on chassis hardware by software running on the BMC. Accordingly, chassis C2 can be marked in a faulty state having an unrecoverable fault and can be safely powered off for repair or physical replacement.

In some embodiments, at phase 3, the BMC software of chassis C2 can decide to transition the chassis to a standby state. In some embodiments, no additional work should be allocated to chassis C2. In addition, a sequence of recovery operations can be performed: a job scheduler can deallocate all jobs or workload tasks running on chassis C2; and an updated configuration can be provided to the BMC of chassis C2 to cause the BMC software of chassis C2 to transition chassis C2 to a standby state.

In some embodiments, after faulty chassis C2 enters a standby state, a spare chassis (e.g., chassis C1) can enter an active state to perform workload tasks previously assigned to computing nodes of chassis C2.

In some embodiments, when chassis C2 is repaired to remove the fault, chassis C2 can be ready to be back online to perform workload tasks. Accordingly, chassis C2 can receive an updated configuration from a job scheduler, which can allocate workload tasks to chassis C2. The BMC software of chassis C2 can transition C2 back to an active state, and the job scheduler can further allocate additional workload tasks to computing nodes of chassis C2.

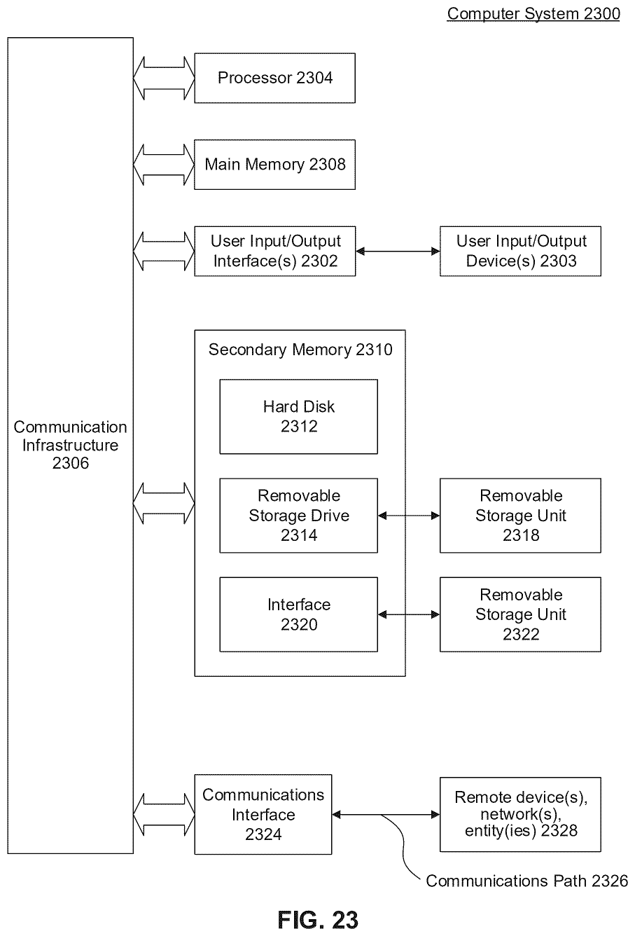

Various embodiments can be implemented, for example, using one or more computer systems, such as computer system 2300 shown in FIG. 23. Computer system 2300 can be any computer capable of performing the functions described herein for data center computing system 100 including BMC 135, NIC 137, controller 153, computing node 155, fleet management server 103, host processor 105, AP 211, controller 253a, controller 253b, controller 253c, DMA engine 213, processor 231, processor 233, processor 232, processor 234, computing nodes, controllers, computing devices, processing devices, various PMUs, as shown in FIGS. 1-22. Computer system 2300 includes one or more processors (also called central processing units, or CPUs), such as a processor 2304. Processor 2304 is connected to a communication infrastructure 2306 (e.g., a bus). Computer system 2300 also includes user input/output device(s) 2303, such as monitors, keyboards, and pointing devices, that communicate with communication infrastructure 2306 through user input/output interface(s) 2302. Computer system 2300 also includes a main or primary memory 2308, such as random access memory (RAM). Main memory 2308 can include one or more levels of cache. Main memory 2308 has stored therein control logic (e.g., computer software) and/or data.

Computer system 2300 can also include one or more secondary storage devices or memory 2310. Secondary memory 2310 can include, for example, a hard disk drive 2312 and/or a removable storage device or drive 2314. Removable storage drive 2314 can be a floppy disk drive, a magnetic tape drive, a compact disk drive, an optical storage device, tape backup device, and/or any other storage device/drive.

Removable storage drive 2314 can interact with a removable storage unit 2318. Removable storage unit 2318 includes a computer usable or readable storage device having stored thereon computer software (e.g., control logic) and/or data. Removable storage unit 2318 can be a floppy disk, magnetic tape, compact disk, DVD, optical storage disk, and/any other computer data storage device. Removable storage drive 2314 reads from and/or writes to removable storage unit 2318 in a well-known manner.

According to some embodiments, secondary memory 2310 can include other means, instrumentalities or other approaches for allowing computer programs and/or other instructions and/or data to be accessed by computer system 2300. Such means, instrumentalities or other approaches can include, for example, a removable storage unit 2322 and an interface 2320. Examples of the removable storage unit 2322 and the interface 2320 can include a program cartridge and cartridge interface (such as that found in video game devices), a removable memory chip (e.g., an EPROM or PROM) and associated socket, a memory stick and USB port, a memory card and associated memory card slot, and/or any other removable storage unit and associated interface.

In some examples, main memory 2308, the removable storage unit 2318, the removable storage unit 2322 can store instructions that, when executed by processor 2304, cause processor 2304 to perform operations for data center computing system 100 including components, such as BMC 135, devices on a card or a board, such as NIC 137, controller 153, computing node 155, fleet management server 103, host processor 105, AP 211, controller 253a, controller 253b, controller 253c, DMA engine 213, processor 272, processor 274, processor 276, processor 278, controllers, computing devices, and processing devices as shown in FIGS. 1-22.

Computer system 2300 can further include a communication or network interface 2324. Communication interface 2324 enables computer system 2300 to communicate and interact with any combination of remote devices, remote networks, remote entities, and other suitable devices (individually and collectively referenced by reference number 2328). For example, communication interface 2324 can allow computer system 2300 to communicate with remote devices 2328 over communications path 2326, which can be wired and/or wireless, and which can include any combination of LANs, WANs, the Internet, and any other suitable networks. Control logic and/or data can be transmitted to and from computer system 2300 via communication path 2326.

The operations in the preceding embodiments can be implemented in a wide variety of configurations and architectures. Therefore, one or more operations in the preceding embodiments can be performed in hardware, in software, or both. In some embodiments, a tangible, non-transitory apparatus or article of manufacture includes a tangible, non-transitory computer useable or readable medium having control logic (e,g., software) stored thereon is also referred to herein as a computer program product or program storage device. This includes, but is not limited to, computer system 2300, main memory 2308, secondary memory 2310 and removable storage units 2318 and 2322, as well as tangible articles of manufacture embodying any combination of the foregoing. Such control logic, when executed by one or more data processing devices (e.g., computer system 2300), causes such data processing devices to operate as described herein.

Based on the teachings in this disclosure, it will be apparent to persons skilled in the relevant art(s) how to make and use embodiments of the disclosure using data processing devices, computer systems and/or computer architectures other than that shown in FIG. 23. In particular, embodiments can operate with software, hardware, and/or operating system implementations other than those described herein.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure can discuss potential advantages that can arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages can depend on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure. For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (e.g., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (e.g., having the potential to, being able to) and not in a mandatory sense (e.g., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers (1) x but not y, (2) y but not x, and (3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” and “given circuit”) refer to different instances of the feature. Additionally, the labels “first,” “second,” and “third” when applied to a feature do not imply any type of ordering (e.g., spatial, temporal, and logical), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

In this disclosure, different entities (which may variously be referred to as “units,” “circuits,” and “other components”) may be described or claimed as “configured” to perform one or more tasks or operations. This formulation-[entity] configured to [perform one or more tasks]—is used herein to refer to structure (e.g., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, and latches), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, and memory management unit (MMU)). Such units also refer to circuits or circuitry.

The disclosed circuits/units/components and other elements illustrated in the drawings and described herein thus include hardware elements such as those described in the preceding paragraph. In many instances, the internal arrangement of hardware elements in a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description can be expressed in a fashion that may appear to be functional. But to those of skill in the art in this field, this HDL description is the manner that is used to transform the structure of a circuit, unit, or component to the next level of implementational detail. Such an HDL description may take the form of behavioral code (which may not be synthesizable), register transfer language (RTL) code (which, in contrast to behavioral code, may be synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, and inductors) and interconnect between the transistors and circuit elements. Some embodiments may implement multiple integrated circuits coupled to one another to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

What is claimed is:

1. A controller, comprising:
a bootloader comprising a first partial bootloader and a second partial bootloader;
a storage device comprising a first bootloader storage area, a second bootloader storage area, a third bootloader storage area, and a data storage area, wherein:
the first bootloader storage area is configured to store the first partial bootloader at a manufacturing time before the controller is deployed,
the data storage area is configured to store security data provided at the manufacturing time, wherein the security data is provided for security operations performed by the first partial bootloader,
the second bootloader storage area is configured to store a first copy of the second partial bootloader,
the third bootloader storage area is configured to store a second copy of the second partial bootloader,
and wherein the first partial bootloader is configured to boot a selected copy of the second partial bootloader, wherein the selected copy of the second partial bootloader is selected from the first copy of the second partial bootloader and the second copy of the second partial bootloader, and the selected copy of the second partial bootloader is configured to boot a firmware for an application operated by the controller in response to the selected copy of the second partial bootloader being in operation.

2. The controller of claim 1, wherein the first bootloader storage area is locked at the manufacturing time to be in an immutable state after the controller is deployed, and the data storage area is locked at the manufacturing time to be in the immutable state.

3. The controller of claim 1, wherein the first copy of the second partial bootloader and the second copy of the second partial bootloader comprise a same content of the second partial bootloader, the first copy of the second partial bootloader is stored in the second bootloader storage area at the manufacturing time, and the second copy of the second partial bootloader is stored in the third bootloader storage area at the manufacturing time.

4. The controller of claim 1, wherein the storage device comprises a volatile memory storage device.

5. The controller of claim 1, wherein the second bootloader storage area is write protected in response to the selected copy of the second partial bootloader being the first copy of the second partial bootloader stored in the second bootloader storage area, and the third bootloader storage area is write protected in response to the selected copy of the second partial bootloader being the second copy of the second partial bootloader stored in the third bootloader storage area.

6. The controller of claim 1, wherein the first partial bootloader is locked in the first bootloader storage area by the selected copy of the second partial bootloader, and the security data is locked in the data storage area by the selected copy of the second partial bootloader.

7. The controller of claim 1, wherein the first partial bootloader comprises a security flag indicating whether a secure boot of the selected copy of the second partial bootloader is implemented.

8. The controller of claim 7, wherein to implement the secure boot of the selected copy of the second partial bootloader, the first partial bootloader is configured to authenticate the selected copy of the second partial bootloader before booting the selected copy of the second partial bootloader, and wherein the selected copy of the second partial bootloader is configured to authenticate the firmware for the application before booting the firmware for the application.

9. The controller of claim 1, wherein the storage device is a first storage device, and the controller further comprises a second storage device configured to store a device identifier, and wherein the first copy of the second partial bootloader stored in the second bootloader storage area is a device-specific version of the second partial bootloader generated by a certificate authority based on the device identifier.

10. The controller of claim 9, wherein the device-specific version of the second partial bootloader is stored in the second bootloader storage area at the manufacturing time.

11. The controller of claim 10, wherein the second copy of the second partial bootloader stored in the third bootloader storage area is the device-specific version of the second partial bootloader.

12. The controller of claim 10, wherein the device-specific version of the second partial bootloader is received from the certificate authority through an instruction processing device configured to manage operations of a set of computing devices of a chassis comprising one or more boards, wherein at least one board of the one or more boards comprises a set of cards, and wherein at least one card of the set of cards comprises the controller and a processing device.

13. The controller of claim 1, wherein the selected copy of the second partial bootloader comprises the first copy of the second partial bootloader stored in the second bootloader storage area.

14. The controller of claim 1, wherein the selected copy of the second partial bootloader comprises the second copy of the second partial bootloader stored in the third bootloader storage area in response to a failure to authenticate the first copy of the second partial bootloader.

15. A method, comprising:
storing, in a first bootloader storage area of a storage device of a controller, a first partial bootloader of a bootloader at a manufacturing time before the controller is deployed, wherein the bootloader comprises the first partial bootloader and a second partial bootloader, and wherein the storage device comprises the first bootloader storage area, a second bootloader storage area, a third bootloader storage area, and a data storage area;
storing, in the data storage area, security data provided at the manufacturing time for security operations performed by the first partial bootloader;
storing, in the second bootloader storage area, a first copy of the second partial bootloader;
storing, in the third bootloader storage area, a second copy of the second partial bootloader;
booting a selected copy of the second partial bootloader, wherein the selected copy of the second partial bootloader is selected from the first copy of the second partial bootloader and the second copy of the second partial bootloader; and
booting, by the selected copy of the second partial bootloader, a firmware for an application operated by a controller in response to the selected copy of the second partial bootloader being in operation.

16. The method of claim 15, wherein the second partial bootloader is an initial second partial bootloader, and wherein the bootloader comprises a set of second partial bootloaders comprising the initial second partial bootloader and a set of updated second partial bootloaders, the first copy of the second partial bootloader and the second copy of the second partial bootloader being selected from the set of updated second partial bootloaders, each second partial bootloader of the set of updated second partial bootloaders having an associated version identifier.

17. The method of claim 15, wherein the first copy of the second partial bootloader has a first version identifier and the second copy of the second partial bootloader has a second version identifier, and wherein the selected copy of the second partial bootloader comprises the first copy of the second partial bootloader in response to the first version identifier representing the first copy of the second partial bootloader being an updated version of the second copy of the second partial bootloader having the second version identifier.

18. The method of claim 17, further comprising:
determining, by the first partial bootloader, the first version identifier of the first copy of the second partial bootloader;
determining, by the first partial bootloader, the second version identifier of the second copy of the second partial bootloader;
determining, by the first partial bootloader, the selected copy of the second partial bootloader based on a comparison of the first version identifier and the second version identifier; and
booting the selected copy of the second partial bootloader after determining the selected copy of the second partial bootloader.

19. The method of claim 18, further comprising:
receiving, by the selected copy of the second partial bootloader, an updated version of the second partial bootloader; and
writing the updated version of the second partial bootloader into the third bootloader storage area in response to the selected copy of the second partial bootloader being stored in the second bootloader storage area.

20. A controller, comprising:
a processor configured to operate a bootloader comprising a first partial bootloader and a second partial bootloader;
a storage device comprising a first bootloader storage area, a second bootloader storage area, a third bootloader storage area, and a data storage area, wherein:
the first bootloader storage area is configured to store the first partial bootloader at a manufacturing time before the controller is deployed, wherein the first bootloader storage area is locked at the manufacturing time to be in an immutable state after the controller is deployed,
the data storage area is configured to store security data provided at the manufacturing time, wherein the security data is provided for security operations performed by the first partial bootloader, wherein the data storage area is locked at the manufacturing time to be in the immutable state,
the second bootloader storage area is configured to store a first copy of the second partial bootloader, and
the third bootloader storage area is configured to store a second copy of the second partial bootloader,
wherein the first partial bootloader is configured to boot a selected copy of the second partial bootloader, wherein the selected copy of the second partial bootloader is selected from the first copy of the second partial bootloader and the second copy of the second partial bootloader, and wherein the selected copy of the second partial bootloader is configured to boot a firmware for an application operated by the controller in response to the selected copy of the second partial bootloader being in operation.
